(19) United States
(12) Patent Application Publication
(10) Pub. No.: US 2019/0265976 A1
(43) Pub. Date: Aug. 29, 2019

(54) Additional Channel for Exchanging Useful Information

(71) Applicants: Yuly Goryavskiy, Antibes (FR); Svetlana Goryavskiy, Antibes (FR)

(72) Inventors: Yuly Goryavskiy, Antibes (FR); Svetlana Goryavskiy, Antibes (FR)

(21) Appl. No.: 16/283,753

(22) Filed: Feb. 23, 2019

Related U.S. Application Data
(60) Provisional application No. 62/634,210, filed on Feb. 23, 2018.

(51) Int. Cl. G06F 9/32; G06F 12/10

(52) U.S. Cl. CPC G06F 9/322; G06F 2212/657; G06F 12/10

(57) ABSTRACT

This patent application describes a device (for example, a microprocessor) in which an additional channel for exchanging useful information is implemented.

Such device may extract additional useful information (for example, information that serves to access other address spaces, control caching, prefetching, synchronization, or speculative execution) from logical addresses that are called by executable operations, and also obtains additional useful information using prefixes, suffixes, or the context of the executable operation.

In other words, this invention describes the use of logical addresses, prefixes and/or suffixes of executable operations, including in aggregate with the context, as an additional channel for exchanging useful information with a computer device. As well as the set of solutions, that use this information.

In addition, this method allows the simultaneous addressing of different address spaces without reloading supplementary or system registers and/or allows the use of additional useful information to control the address translation process or the memory accessing (control transfer) process.

This invention also describes devices that support access to other address spaces using ordinary pointers (without switching context), that use parameterized prefixes or suffixes to transmit additional information during the execution of operations, and conversely, that automatically modify the code executed by them, and that use a different number of bits in a logical address to represent different identifiers of address spaces (contexts) and a new scheme for coding immediate values (for example, offsets).

These are distinct ideas, but they are inspired by the idea of an additional channel and are used in the implementations described in this patent application, therefore they are included in this application.

In particular, such device may simultaneously (that is, without needing to regularly switch its mode of operation) use both logical (for example, those that are linear, or address virtual memory), and lower level (for example, physical) addresses in general purpose commands.

The device in which in which an additional channel for exchanging useful information is implemented, may also use several different rules to translate high level addresses into lower level addresses, thereby dispensing with switching the device's mode of operation in order to use different rules to translate addresses in neighboring commands or in compact fragments of the program code.

### CROSS-REFERENCE TO RELATED APPLICATIONS

The present invention claims the benefit of U.S. provisional patent application Ser. No. 62/634,210, entitled “An additional channel for the exchange of useful information” and filed on Feb. 23, 2018, disclosure of which is included herein at least by reference.

### COPYRIGHT NOTICE

A portion of the disclosure of this patent document contains material, which is subject to copyright and trademark protection. The copyright owner has no objection to the facsimile reproduction by anyone of the patent document or the patent disclosure as it appears in the U.S. Patent and Trademark Office patent file or records, but otherwise reserves all copyright and trademark rights whatsoever.

### FIELD OF INVENTION

The invention relates to the field of address translation units, cache and memory management units and methods, particularly in the microprocessors or in other computing systems, data processing systems, software and virtual machines.

### BACKGROUND OF INVENTION

One of the problems this invention solves is the fact that an operating system typically cannot access memory located in another address space without mapping such memory into the current address space and without switching contexts.

The fact is that many modern processors read the address of the table that controls virtual memory address translation from a fixed system register (such as the CR3 register in x86 family processors).

Furthermore, although the elements of their internal data structures, such as the Table Lookaside Buffer (TLB), are already provided address space identifiers (sometimes designated in some other way, such as PCID for x86 family processors, for example), these processors cannot access another address space without reloading the system register that contains the base address of page tables.

Other processors support registers of address space identifiers that work alongside general purpose registers, which allows them to access memory outside the current address space. However, it is very difficult to add such a connection to existing architecture.

This invention offers more simple and flexible solutions that use parameterized prefixes or the transfer of additional information through the logical address. Both of these solutions do not require adding a second parallel register file with address space identifiers to the processor.

This invention, which is based on a new method of interpreting a logical address, allows the accessing of data in any address space using ordinary operations and pointers contained in general purpose 64-bit registers.

In this invention, accessing another space does not require switching contexts, mapping addresses into another space, or changing the values of system registers.

In this regard, the direct addressing of physical memory is supported in order to access it with zero latency, bypassing MMU and TLB blocks, and therefore not competing for them.

At the same time, this solution allows the use of a different number of levels in page tables of different address spaces or different virtual memory address translation algorithms.

Existing processors use a single algorithm and set of virtual memory address translation parameters for all address spaces in a given mode of operation of the device. For example, if the processor switches into a mode where it supports 5-level virtual memory address translation, then all processes will use 5-level page tables. However, for the overwhelming majority of processes these are redundant and even slow performance.

This invention eliminates this restriction, allowing the simultaneous use of different virtual memory address translation algorithms or parameters for different address spaces.

Similar solutions may also be used to work with address spaces of different virtual machines.

This invention also includes a set of solutions that are based on the idea of transferring additional information.

Practically all modern processors include in their instruction sets special instructions that serve to control caching and prefetching, since the flexible control of caching and prefetching substantially increases software performance.

However, such instructions must be included in the software at each point where it accesses some variable or data structure that requires a special caching regime.

Adding instructions increases the size of the software's code and lowers the processor's efficiency due to the cost of fetching, decoding, and executing these additional instructions, which pass information on caching or prefetching to the processor.

Performance would be improved if, using some additional channel, information on caching and prefetching could be transferred directly in commands that access memory.

Modern processors support assigning attributes that affect the caching regime through page tables. However, in many cases controlling such attributes is ineffective, since they are assigned immediately for the entire RAM page. In a typical modern processor, a memory page has a size of 4 kilobytes or more, while the cache line, operation with which is affected by these attributes, only has a total size of 32, 64, or 128 bytes.

Again, if there were some additional channel, then the caching attributes could be transferred in separate commands, in order to control caching at the level of individual lines, and in some cases (when there is no conflict between different caching regimes)—even at the level of individual variables.

Also, almost all modern processors support speculative execution. Some of these are special bits in machine representation of conditional control transfer operations, which help the processor to guess along which branch the program will execute.

However, other processors were not initially configured with this functionality, and the machine representation of the conditional jump instruction lacked a free bit. Such processors use fixed rules to predict jumps.

For example, if the target of the conditional jump is not present in the branch prediction buffer and the jump address is greater than the current value of the Instruction Pointer, then the processor believes that the jump will take place. However, for a specific program, this prediction may be erroneous, and the compiler is not capable of informing the processor of this fact.

If there were an additional channel, by which it were possible to send the processor information on the probability of a conditional jump triggering, then this would improve performance by avoiding prefetching from an incorrect branch and eliminating speculative execution from superfluous branches.

This invention describes some methods of organizing this additional channel, through which programs can effectively exchange information with the processor, often without even adding instructions to the program, and even without modifying the existing system of commands.

In particular, this channel can be used to exchange information on caching, prefetching, speculative execution, and synchronization in a multiprocessor or multi-core system.

Regarding speculative execution, no matter how much developers of processors may improve branch prediction algorithms, errors will sometimes occur, and memory such as the Branch Target Buffer (BTB) will be used to compensate for such errors. However, this memory is limited in size and therefore important information that is saved in it is lost by the execution of new code after switching tasks, etc.

If a processor could reflect its accumulated statistics in the program itself, then it would avoid losses due to unreliable predicting of jumps during a repeat execution of them, even if the information about them was discarded from the BTB (since these jumps were not recently executed and information about them has already been replaced by other entries, or has been lost after switching tasks, etc.).

This invention describes a computer device that can change program code executed by it in order to solve this problem, and in order to achieve other similar improvements.

This invention also describes effective methods to control caching through an additional channel, including methods that lower the rate of conflicts while working with cache memory, in order to improve the operating speed of programs that process large quantities of data.

At present, the speed of central processors is so great, that RAM is a slow device in comparison. The typical PC or mobile device processor can expect data to be accessible within several hundred cycles after accessing memory.

Although developers of processors and compilers, as well as experienced programmers, strive to parallelize the execution of operations, the majority of the time the processor will stand idle when expecting data requested from RAM.

Therefore, developers of processors and compilers, as well as experienced programmers, strive to smooth out the negative effect from a dramatic lag in RAM speed on processor speed.

This is primarily attained by including in the processor or memory subsystem the complete cache memory hierarchy—this is ultrafast, but limited by the size of memory within which frequently used data is saved.

As a rule, cache memory built into the processor core (L1 cache) is available almost immediately, while subsequent levels of cache memory (L2 and L3 caches) return data after several or dozens of cycles.

Therefore, if the program accesses data that is located on the cache, then it avoids major delays in the central processor.

Thus, the key variable for the speed of modern software is the effective organization of cache memory.

Usually developers of processors provide special instructions in command systems, with which programs can control caching, in order to improve the efficiency of working with memory.

However, in order to use these instructions, the compiler must perform an extremely non-trivial analysis of the program's source code, which cannot always be successfully automated. Therefore, experienced programmers often manually add instructions for controlling caching to the program. This is very labor-intensive work, which requires extremely high qualifications and attention to detail.

Furthermore, the inclusion of special instructions directly in the main part of the program's code, as well as the allocation of memory while taking into account the particularities of caching, make the program's code non-universal and difficult to port to run on processors with different architecture.

Consider one of the traps programmers have encountered when writing complicated computer programs, such as computer vision systems, machine learning systems, artificial intelligence systems, etc.—lowering performance due to elements of different arrays sharing the same associative sets.

Developers of processors are limited by the quantity of logical gates available to them, and so, as a rule, they develop cache memory for the set of independent associative sets by splitting the cache into many associative sets. The processor can only simultaneously perform a single data reading or writing operation for each of the sets.

The selection of sets into which data falls depends on the value of the memory cell address. However, the function implementing this dependence must work quickly, for this reason, on many actual devices it reflects addresses that differ from one another by some value, multiplied by a power of two, in the same set number.

As an example, this invention proposes a program that works with two large data arrays. If these arrays are sufficiently large, then each of them will be located on separate RAM pages, and there is a high probability that the ith elements of these arrays will be located at addresses that are multiples of each other, accurate up to the value that gives individual numbers of sets.

It is proposed that a programmer write a cycle as an expression in the following form:

sum+=a[i]*b[i];

If the ith elements of arrays “a” and “b” have such multiplicative addresses, then they will be located in the same associated set within the cache. Therefore, operations of reading from arrays “a” and “b” cannot be performed in parallel (since the cache cannot simultaneously perform two different reading operations from the same set).

As a result, a delay occurs when running such a program while the processor is waiting for the element “a[i]” to be read, although it could read the element “b[i]” at the same time, but only if this element were located in another associative set.

Another negative effect, which is based on the same principle, arises when the elements of two different arrays crowd each other out of the cache because they fall in the same sets due to the brevity of the initial addresses of these arrays for some value.

In order to avoid processor latency due to competition for the same set within the cache or program latency due to unreasonable crowding out of some data by other data, the programmer must artificially shift the beginning of one of the arrays so that their ith elements are no longer located at addresses that are multiples of one another.

However, this requires the programmer to have a deep understanding of the field of cache memory architecture, making code written by him complicated and essentially unreadable to other developers without detailed comments. Often a programmer encounters additional problems recovering the source address of an allocated memory block before it is deallocated.

This invention describes a technology to transmit additional information that helps avoid such collisions without adding special offsets to the addresses of the beginnings of arrays and without interfering in the main program code.

Another of the main objectives of this invention is to eliminate competition for the Table Lookaside Buffer (TLB, or similar structures) between application and system software and reduce the number of accesses to page tables, especially when the operating system and system software are running.

In a multitasking environment, many programs simultaneously compete for a TLB cache with limited volume. For example, on a typical modern microprocessor, such as the Intel Core i7, TLB for data consists of only 64 elements (at the level of the processor core), while the computer can run dozens and even hundreds of programs at the same time.

Demand for processing large amounts of information is growing. When a program accesses a large amount of data scattered across different pages of RAM, it needs to read more elements of the page tables than fit into the TLB. In this case, the processor has to regularly forget the old elements that are in the TLB in order to put new elements in their place.

At the same time, the number of service accesses to memory (for reading the elements of the page tables into the TLB) is growing rapidly, and the efficiency of the program's work is reduced dramatically.

In addition, modern processors modify TLB elements to help the operating system effectively manage virtual memory. For example, they mark pages of memory as changed after writing data and mark every instance of accessing any page.

But when such a modified element is pushed out of the TLB by a new element, the processor must transfer these changes to the page table; otherwise, this information will be lost. In this case, the processor must also perform a hidden operation of writing data to RAM. This leads to a further decrease in performance and increased energy consumption.

In addition to application programs, there is also an operating system that serves them, which also accesses memory using page tables. Therefore, the operating system and its components also use TLB. It turns out that the operating system competes with application programs for the common TLB cache and each access to the operating system slows down the application program, since the elements of the page tables needed for the operating system displace the application program's elements.

Furthermore, when the operating system returns control to the user program, this program again accesses its data and loses hundreds or even thousands of processor time ticks to refill the TLB with its user elements. Conversely, it slows down the operating system, since in the intervals between calls it usually displaces from the TLB all the elements of the page tables that the operating system needs.

Therefore, reducing competition for TLB elements and reducing the number of accesses to page tables is one of the most important factors ensuring the high performance of modern software.

### SUMMARY OF INVENTION

This patent application describes a device (for example, a microprocessor) in which an additional channel for exchanging useful information is implemented.

Such device may extract additional useful information (for example, information that serves to access other address spaces, control caching, prefetching, synchronization, or speculative execution) from logical addresses that are called by executable operations, and also obtains additional useful information using prefixes, suffixes, or the context of the executable operation.

In other words, this invention describes the use of logical addresses, prefixes and/or suffixes of executable operations, including in aggregate with the context, as an additional channel for exchanging useful information with a computer device. As well as the set of solutions, that use this information.

In addition, this method allows the simultaneous addressing of different address spaces without reloading supplementary or system registers and/or allows the use of additional useful information to control the address translation process or the memory accessing (control transfer) process, in particular, in order to optimize the operation of software.

This invention also describes devices that support access to other address spaces using ordinary pointers (without switching context), that use parameterized prefixes or suffixes to transmit additional information during the execution of operations, and conversely, that automatically modify the code executed by them, and that use a different number of bits in a logical address to represent different identifiers of address spaces (contexts) and a new scheme for coding immediate values (for example, offsets).

These are distinct ideas, but they are inspired by the idea of an additional channel and are used in the implementations described in this patent application, therefore they are included in this application.

In particular, such device may simultaneously (that is, without needing to regularly switch its mode of operation) use both logical (for example, those that are linear, or address virtual memory), and lower level (for example, physical) addresses in general purpose commands.

More generally, the device in which in which an additional channel for exchanging useful information is implemented, as described in this patent application, may use several different rules to translate high level addresses into lower level addresses, thereby dispensing with switching the device's mode of operation in order to use different rules to translate addresses in neighboring commands or in compact fragments of the program code.

In particular, this method of accessing memory allows system software, in many cases, to dispense with accessing the Table Lookaside Buffer (TLB) during its own operation, and almost completely avoids competition with applications programs for access to this critical resource, which improves performance and saves energy (improves battery life for mobile devices).

Furthermore, this invention helps avoid superfluous expenditures of time and energy that arise due to writing to memory marks that indicate access to the resident memory pages (that are used by the operating system core and system components) or changes to its contents.

This invention allows a substantial speed increase for many application and system programs.

In particular, it facilitates accessing other address spaces without switching contexts, as well as flexibly controlling attributes (for example, caching and prefetching) at the level of individual commands and/or individual variables, arrays, and data structures, and not clumsily at the level of entire pages.

In this regard, this invention can be implemented with minimal changes at the hardware level, does not require substantial changes in the processor, operating system, software, and also allows adding new functionality to them to improve performance and save energy stepwise by preserving compliance with existing code.

This functionality directly writes, reads, or copies data located at another address space, ultimately accelerating a number of operating system algorithms, as well as many algorithms that help applications to rapidly exchange data.

The capability to simultaneously access different address spaces without reloading system registers substantially improves performance and helps save energy by substantially reducing the quantity of service operations associated with so-called context switching, especially during the operation of system software. This includes the operation of interrupt handlers, which are often needed to access the data of another process, distinct from the current process, which was active during the interruption. In this regard, the solutions described in this patent application do not require mapping the pages of another address space into the space of the current process, or even into the system part of the address space.

This functionality can be provided not only for system software, but also for application software.

This patent application describes a solution for simultaneous operation of all address spaces that uses the transmission of an address space identifier (or context) through high-order bits of the logical address (or as part of the logical address).

This patent application describes access to data and transfer of control to other address spaces using such addresses.

This invention, which is based on a new method of interpreting a logical address, allows the accessing of data in any address space using ordinary operations and pointers contained in general-purpose 64-bit registers.

In this invention, accessing another space does not require switching contexts, mapping addresses into another space, or changing the values of system registers.

In this regard, the direct addressing of physical memory is supported in order to access it with zero latency, bypassing MMU and TLB blocks, and therefore not competing for them.

At the same time, this solution allows the use of a different number of levels in page tables of different address spaces or different virtual memory address translation algorithms.

In this regard, the capability is preserved to use a logical address to transmit additional information in the main part of the software code (where no other address spaces are accessed).

A device is also described that analyzes the values of address space identifiers or control information from its descriptors in order to use different virtual memory address translation algorithms or parameters, for example, a different number of levels in page tables for different address spaces.

Similar solutions may also be used to work with address spaces of different virtual machines.

This invention also includes a set of solutions that are based on the idea of transferring additional information.

In particular, a number of them are based on including additional information in the logical address.

If a solution from this invention is implemented using the transfer of additional useful information through a logical address, then the relevant attributes may be included once in the pointer for which the program accesses data, and then they will be sent to the computer device during every access to memory using this pointer as a base address.

The use of logical addresses to transmit additional information, proposed herein, helps to avoid multiple inclusions in the program of the same additional instructions for controlling caching, prefetching, or synchronization associated with the same object because the address of such an object, containing control attributes or commands, can be calculated once, but then used many times in different operations to access memory or transfer control.

In particular, if the logical address includes information that controls caching or prefetching, then it is not necessary to include special instructions for controlling caching multiple times in the program, nor is it necessary to change the parameters of the entire memory page on which a few hundred lines are located, each of which may require their own individual attributes of caching or prefetching.

However, if the computer device supports adding additional offsets to the base address, then it is possible to change the manner of caching or prefetching in each individual access to memory even without modifying the base address—by adding necessary information to the offset.

Information that affects speculative execution may be transmitted in a similar way. For example, even if it is difficult to change the processor command system so that conditional control transmission commands include an additional bit indicating a higher probability of a branch, then the missing information can be transmitted through high-order bits of the logical address for which the transmission is performed. Or through high-order bits of the offset in the control transmission command.

In this regard, the inclusion of additional information in the logical address may be done by the compiler itself (if it has enough information) hidden from the programmer, or it may be done explicitly by specifying additional attributes when declaring pointers or when translating pointer types.

Furthermore, new memory control functions may be added to the standard library. For example, the memory allocation function, which will return “marked” pointers for the newly allocated memory. In this regard, in the future, the programmer can use these pointers normally in normal memory access operations, but each time they are used additional information will be transmitted to the computer device, which uses it to control caching, prefetching, etc.

Also, when using this invention, memory allocation functions may be added to the standard library that return these pointers, use of which does not cause collisions due to sharing the same associative sets within cache memory between different arrays or other data structures in a program that works with large volumes of information.

These pointers will contain additional information that affects the selection of the associative set within cache memory, which will be used to work with the array or data structure addressed by it.

Knowing precisely which arrays or data structures are read or written “in parallel” with one another and can therefore compete for the same associative sets, the programmer can assign them different tags, the numerical values of which will be included in the logical address and affect the selection of associative sets, which eliminates competition.

In a number of cases, this analysis may be performed by a high-level language compiler without human participation.

Many of the improvements described above can be added pointwise to critical fragments of existing applications without interfering in the remainder of their code—to begin using these improvements, all that is necessary is a minimal reworking of memory control functions in the standard C library or the library of another programming language.

The transmission of data within logical addresses unlocks other possibilities, including when working with external devices (for example, those connected to a processor's memory bus).

An additional channel to transmit useful information to a computer device may be organized through not only logical addresses, but also using prefixes or suffixes of executable operations. Furthermore, information transmitted in it may be supplemented or modified by analyzing the context within which these operations were encountered or are executed.

Some existing processors (for example, x86 family processors) already use prefixes or suffixes that precede or follow operation code.

However, their prefixes and suffixes (in aggregate with other bits in machine representation of commands) indicate which components should be used to calculate the effective address (not defining, in this regard, how this calculated effective address will be translated into a physical address), indicate the name of the segment register (in the segmented model of memory addressing), serve to organize the cycle, allow boundaries to be checked, change the direction of prefetching in the conditional jump instructions or control synchronization during memory accessing (prefixes LOCK and extension HLE).

New types of prefixes and suffixes are described which, as far as we know, have no analogs either in the x86 family or in any other devices.

These prefixes or suffixes are designed to transmit information, which affects address translation (in particular affects translating high level addresses into lower level addresses, including into physical memory addresses), which identifies the address space, context, virtual machine, or another object, which controls data caching during the execution of the current operation, which represents memory protection keys, which instructs this device to read or write other additional information and/or which will be included in a transaction with another device as additional data.

This patent application also describes a device that implements a new class of prefixes or suffixes that can carry full parameters, similar to the parameters of executable operations themselves.

However, distinct from an ordinary machine command used independently or traditional prefixes and suffixes of x86 (such as REX, SIB, ModRM) that add missing bits to extend the coding of machine command operands, these proposed new prefixes (or suffixes) add additional information during the execution phase of the base operation associated with them.

In other words, proposed new prefixes or suffixes deliver information to the steps following the calculation of the effective address.

This information will be used after decoding commands, possibly, after its being broken down into micro-operations and even after calculating the effective address encoded by its operands.

In particular, these prefixes or suffixes can be used to replace, supplement, or modify information that otherwise would have been read from control registers, descriptors, segments, page tables, or other control data structures.

These prefixes allow the addition of any other additional useful information during the execution of the operation.

In particular, it becomes possible to transmit to the computer device an address space identifier (or context), which it uses during the execution of operations that address memory, or to pass an alternative value of the pointer for page tables (or for an analogous data structure for another virtual memory architecture).

This unlocks the possibility of accessing other address spaces without mapping their pages in the current address space, without switching contexts, without changing the values of system registers and with practically no overhead.

This invention also describes a computer device that can independently change the code of a program executed by it in order to include useful information in it, which helps improve the performance of said program during repeat executions of the changed code by the same device.

In particular, this mechanism can be used to save information that helps avoid errors when predicting jumps in the event that information on the jump was already discarded from the BTB (or another memory device designed for dynamic branch prediction).

The additional channel may also be used in the reverse direction—to transmit data from a computer device or from external devices to a program (for example, if in the processor's instruction set there are instructions that return address information).

Information may be returned to the program not only using ordinary executable operations, but also using prefixes or suffixes of executable operations.

Another of the goals of this invention is to ensure maximum performance and to avoid unnecessary waste of energy by the near complete elimination of competition for the TLB (or another similar structure built into the computer device) between application programs and all system software, as well as by almost completely eliminating context switching in order to access another address space.

In order to do this, it is proposed to use an additional channel for exchanging useful information.

The operation of this method is based on using the additional channel to transmit useful information described in this patent application. Using this channel, the computer device can obtain information that helps it to switch dynamically to using another address translation method, in particular, to switch to using physical memory addressing, or to obtain access to another address space, and/or to obtain other data that helps optimize the address translation process or the memory accessing (control transfer) process.

For example, physical (low level) memory addressing is suitable for addressing the code, stack, and internal data of the operating system itself and system components, it is also often suitable for accessing user data (by the operating system itself and system components). In this regard, a TLB is not necessary in order to access memory using low-level addresses; therefore, system software that uses this invention has a dramatically reduced level of competition for the TLB with application programs.

When using this invention, the operating system core and many system components obtain an additional speed increase even without taking into account the elimination of competition with application programs. The operating system core and system components stop competing with one another for the TLB, stop suffering due to limited TLB volumes during their own operation (while they work with resident memory) and almost completely stop competing with application programs for TLB.

In this regard, many of the benefits of using this invention may be obtained with minimal interference in the code of existing programs.

Additionally, system software avoids superfluous expenditures of time and energy that arise due to writing to memory marks that indicate access to the resident memory pages (that are used by the operating system core and system components) or changes to its contents, since resident pages do not need marks on access or changes (because these marks are not used by the operating system for resident pages, which is typical for popular operating systems such as Microsoft Windows and Linux).

The method of accessing memory described in this invention allows the implementation of new capabilities. For example, the capability to use several different algorithms to translate logical addresses into low-level addresses without regularly switching the processor's mode of operation using special machine commands that create large overhead.

In particular, this allows memory addressing in different address spaces and accessing them without switching contexts, including by permitting the use of a different quantity of levels in page tables of different address spaces.

This invention allows accessing the operating system more “lightly” (with lower overhead), which stimulates the development of new technologies, for example, making data exchange between programs running in parallel lighter.

### BRIEF DESCRIPTION OF THE DRAWINGS

FIG. 1 This figure demonstrates the operation of a device that implements the transmission of additional useful information through a logical address.

FIG. 2 This figure demonstrates the operation of a device that implements the transmission of additional useful information through a logical address.

Distinct from the device displayed in FIG. 1, this device extracts useful information from a logical address using some function.

FIG. 3 This diagram demonstrates the operation of a device that implements the transmission of additional useful information through a parameterized prefix of the executable operation and uses this data to access another address space.

This unlocks the possibility of accessing other address spaces without mapping their pages in the current address space, without switching contexts, without changing the values of system registers and with practically no overhead.

FIG. 4 This figure demonstrates the operation of a device that implements the transmission of additional useful information through a logical address.

Distinct from the device displayed in FIG. 1, this device uses useful information located in the logical address only in the case that one of the bits of this logical address is equal to 1.

FIG. 5 This diagram demonstrates the operation of a device that uses the transmission of additional information in a high-order bit of the logical address to select the method of addressing memory.

This device dynamically selects the address translation method in order to provide the capability to access memory both directly using physical addresses, and using linear addressing by a page mechanism (and TLB cache).

FIG. 6 This figure displays an example of implementing a computer device that supports the transmission of additional information through a logical address. Here this information is used in this device for two different purposes—to select the method of addressing memory (to choose whether the addressing process involves an MMU module for translating a linear address into a physical address using page tables or the physical address will be directly extracted from the bits of the logical address) and to transmit additional attributes that control caching.

FIG. 7 This diagram demonstrates the operation of a device that uses the transmission of additional information to reduce the number of collisions that occur due to competition for the same sets within associative cache memory (when working with large volumes of data).

The device displayed in this diagram uses two different sources of additional information to improve the performance of the associative set selection algorithm: bits of a tag in a logical address or bits of a tag read from a descriptor of the virtual memory page.

FIG. 8 This diagram demonstrates the operation of a device that uses the transmission of additional information to control speculative execution and prefetching so as to reduce the probability of inaccurately predicting the direction of a conditional jump.

FIG. 9 This diagram demonstrates the operation of a computer device that uses an extended offset algorithm that allows the changing of high-order bits of an effective address using a short offset. In particular, this algorithm can be used to add or change additional useful information if it is located in high-order bits of the effective address.

FIG. 10 This design demonstrates an example of an improvement on a program that initializes some data structure consisting of 10 machine words, which allows the eliminations of 5 commands that write zeros to memory by transmitting additional information through a logical address.

FIG. 11 This design demonstrates the structure of a logical address of a proposed 64-bit device that is similar to an x86 family processor that has been upgraded for immediately addressing all address spaces simultaneously without switching contexts, it supports direct addressing of physical memory (accesses memory with no latency, bypassing MMU and TLB blocks), and also simultaneously uses 5-level and 4-level translation of addresses without switching operating modes (for different address spaces).

In this regard, this device has not lost the capability to transmit additional information through a logical address and can still implement other improvements from this patent application.

FIG. 12 This figure demonstrates an example of implementing an address translation executable operation for a computer device with registers.

FIG. 13 This scheme demonstrates the operation of a computer device that dynamically switches between two different address translation methods during the execution of an executable operation.

FIG. 14 This scheme demonstrates the operation of a device that dynamically selects the address translation method in order to provide the capability to access memory both directly using physical addresses, and using linear addressing by a page mechanism (and TLB cache).

This device selects an address translation method by checking some flag or status field value, if such a value occurs only in a specific context that can be established and closed using specific executable operations that create or close such a local context, and that do not lead to switching the device's mode of operation, and also do not cause a reset of the internal data structures of this device.

FIG. 15 This scheme demonstrates the operation of a device that dynamically selects the address translation method in order to provide the capability to access memory both directly using physical addresses, and using linear addressing by a page mechanism (and TLB cache).

This device selects an address translation method by checking some bit in the machine representation of an executable operation.

FIG. 16 This scheme demonstrates the operation of a device that dynamically selects the address translation method in order to provide the capability to access memory both directly using physical addresses, and using linear addressing by a page mechanism (and TLB cache).

This device selects an address translation method by checking for the presence of a specific prefix preceding an executable operation's code.

FIG. 17 This scheme demonstrates the operation of a device that dynamically selects the address translation method in order to provide the capability to access memory both directly using physical addresses, and using linear addressing by a page mechanism (and TLB cache).

This device selects an address translation method by checking some bit in the segment descriptor of a computer device that supports segment addressing (or similar technology).

### DETAILED DESCRIPTION

Definitions

In order to make the description of the invention more clear and to avoid excessive repetition, a series of terms are defined, which in the future should be interpreted as they are described in this section, with the exception of those cases where the text of this patent application specifies another interpretation of their meaning.

A person skilled in the art can apply the terms “logical address” and “physical address” described below to their arbitrarily selected classes of addresses in their system and then implement this invention in an application for their selected address types.

For this invention, it is not important precisely which addresses are selected as “logical” in a given system, but which are “physical”, if such selection is useful from the point of view of the person implementing this invention.

These terms are used in this text as abstract concepts—their names are selected so as to facilitate understanding the essence of this invention and the methods of implementing it.

Computer device—this is any device, able to execute operations and/or process data (in particular a real, virtual, emulated, or modeled processor (Central Processing Unit, Graphics Processing Unit, Floating Point Processing Unit, Digital Signal Processor, special processor or coprocessor, logically separated part of a more complex processor, such as a processor core), controller or microcontroller, computer, on which there operates a virtual or abstract machine program, a real, virtual, emulated, or modeled specialized ASIC microcircuit or programmable logical array (FPGA)). It should be emphasized that this definition, in addition to classical general-purpose processors, virtual machines, and emulators, includes also specialized devices, as well as real, virtual, abstract, and simulated devices that are intended to process data, both those programmed using imperative instructions, and those that operate on other principles (such as functional programming, control by data flow, etc.), including those that operate according to a previously defined scheme (such as programmable logical matrices, specialized microcircuits such as ASIC, etc.).

Logical address—this is a high level address, with which an executable operation operates, regardless of whether this address is an explicit or implicit operand of the executable operation, or if it is calculated during its execution or preliminary analysis.

In other words, logical addresses are the addresses with which executable operations operate, for example, operations that access memory or transmit commands. These addresses are their operands (explicit or implicit) or are calculated during their execution or preliminary analysis, if the computer device supports complex addressing methods, in which an address consists of several components (including such components as offset relative to some base address, including relative to an Instruction Pointer) or is collateral (specified indirectly).

Logical, effective, linear, virtual, and segmented addresses, in vocabulary widely used in the computer device market, are examples of logical addresses to which this invention might apply.

If not otherwise noted in the description of a specific aspect of this invention, its principles may be applied both to logical addresses and to their components that are directly featured in executable operations or data processing operations, and to effective addresses that are calculated during preliminary analysis or execution of these operations.

Physical address—in the description of this invention, this is a lower level address than the logical address and, as a rule, is a result of translating the logical address.

The translation may be trivial—in some implementations, the physical address may be equal to the logical address or specific bits extracted from the logical address.

For a general-purpose classical processor, the physical address is the address of a physical RAM cell, or more strictly, it is the address transmitted to the memory controller.

However, this invention may also be applied to systems where a multi-level translation of addresses or a complex RAM hierarchy is used.

In particular, if this invention is used in the implementation of a virtual machine, then the “physical addresses” in its description may match the logical addresses of RAM at the level of the interpreter of this virtual machine.

Therefore, in the text of this patent application, physical addresses should be understood to mean any addresses (generally lower level) selected by a person skilled in the art into which logical addresses are translated, even if they are not the final result of address translation (do not coincide with physical addresses of RAM cells in a complex system where this invention is used at one of its higher levels).

Real address—developers of some processors use the term “real address” in a manner similar to “physical address,” but in the description of this invention, these terms are conditionally considered synonyms.

Usually this term is introduced in order to emphasize the fact that the result of translating a logical address (an address with which the program operates) may not coincide with the physical address of a memory cell in the lowest level of implementation in a specific engineering solution (for example, when using multi-channel memory with interleaving and other complex technical organizations of RAM).

However, in order to simplify understanding this invention and methods to implement it, special attention will not be paid to this precise distinction, since it is not essential from the perspective of understanding the essence of this invention and methods to implement it in specific engineering solutions. If necessary and more suitable for a specific system, then a specialist skilled in the art can implicate the term real address wherever a physical address is mentioned (and vice versa).

Address translation method—the rules (scheme, circuit, algorithm) for translating a logical address (high-level address) by which an executable operation or data processing operation operates, into a physical address (lower level address, which is used to access memory during the operation of a given computer device).

The translation of a logical address into a physical address may be implemented in specific devices by very different methods—both directly in a processor's circuits, and in its microcode; it also may be implemented in a virtual machine interpreter program, etc.

In terms of the idea underlying this invention, the specific method of implementing the address translation process is not important and its selection is left to the person implementing this invention.

A special case of the address translation method may be the direct use of a logical address as a physical address, or the use of specific bits of a logical address as a physical address.

It is understood that a lower level address (physical address) for which memory is ultimately accessed or control is ultimately transferred may not even be generated explicitly in any part of the implementation of the computer device—it may be an abstract concept.

The meaning of this invention does not change if wherever the selection of an address translation method is mentioned, it is replaced with “selection of an address type currently used,” or “selection of circuits or methods by which the computer device accesses memory or transfers control.” To eliminate ambiguity, it is noted that this also relates to the claims of this patent application.

Executable operation—an instruction, command, order, operator, or function, from which a program for a computer device is composed, or which defines data transformations in a data processing device.

System software—operating system and other programs that operate on kernel privileges of the operating system or are closely integrated with it (for example, a network stack, in particular a TCP/IP stack, firewall software, device drivers, RAID software, cloud storage system components, parts of a multimedia stack).

Memory protection keys—in the context of this patent application this term means any information intended for checking privileges, authorizing access, authentication, data encryption, zero-knowledge proof, error correction when saving or transmitting data, error protection when programming, including to protect against erroneous actions from external devices, as well as other cryptographic data, error correction codes, or other data suitable for the listed purposes.

Memory protection keys may be used, in particular, when accessing memory, when transferring control, when accessing an external device, etc.

Memory protection keys may be presented in additional information both directly with its own values, and indirectly, in the form of an index, offset, address, or other information with which a computer device or other final addressee of additional information may independently obtain the value of the keys or identify already known keys.

Prefix or suffix—in the context of this patent application this is a modifier, additional instruction, auxiliary operation, or other addition that precedes an executable operation or follows it (or its code, name, identifier) and serves to modify the device's behavior when performing basic operations, to modify the values of its operands (or operand), and/or to perform initial or final actions (including modifying the result of the basic operation).

A prefix or suffix may have an operand (or operands). Some prefixes or suffixes may precede operations or follow them. The machine representation of a prefix or suffix may occupy more than one byte.

If the computer device's command system does not support prefixes or suffixes in the necessary format, but a person skilled in the art selected them to implement this invention, then it may implement the necessary prefix or suffix as a separate operation, which (from the perspective of the user) are only executed jointly with the basic operation.

Some function, arbitrary function—if the topic of discussion is implementation of a computer device, then these terms are understood to mean an arbitrary function, scheme, circuit, or algorithm, including those implemented in microcode, in hardware, and/or in software, including using additional information and/or data structures.

Basic address information—the value of the logical address or effective logical address, or the value of the component(s) of such address, from which all additional information has been cleared.

This invention may be implemented using the transmission of additional information via a logical address or its component(s). When additional information is extracted from the reference value of the logical address, from the value of the effective logical address, or from the value of their component(s), the remaining bits of this value or its remaining information capacity (for more complicated coding) may be used in the normal manner—as the value of a normal logical address or component(s) of an address of this computer device, as if there were no additional information.

This part of the information (leftover after extracting the additional information) is called “basic address information.” In the simplest case, this is simply the value of low-order bits of the logical address (if additional information is located in high-order bits). In this regard, the quantity of such low-order bits that carry the basic address information may depend on the content of the additional information. In the most general case, the basic address information may be extracted from the logical address by a computer device using some function.

In application programs, the basic address information is most often the value of the normal logical address of a given computer device that points to a certain memory cell or executable operation.

If a computer device is a classical processor that uses traditional paged virtual memory organization, then in the majority of cases the basic address information will be a linear (virtual) address of a memory cell, which is further translated into a physical address using a Memory Management Unit (MMU).

However, the extracted additional information may order the computer device to handle this information differently, for example, as a physical address of a memory cell or as a logical address, but belonging to a different address space, etc., as described in this patent application. Or by some other means, as decided by a person skilled in the art implementing this invention on her device.

Preamble

This section covers how to interpret the phrase “address translation method,” which is used in this patent application, clarifies what parameterized prefixes and suffixes are, describes how prefixes or suffixes may be implemented on devices that do not support them or have insufficient support to implement this invention, and also covers how prefixes or suffixes may be used to transmit information back to the program—in order not to repeat these definitions and explanation in each specific section that refers to one of these concepts.

In terms of the ideas underlying this invention, as well as when implementing it on specific computer devices, it does not matter whether addresses are translated in some material way, or if their translation is speculative, but the computer device on which this invention is implemented must provide memory access according to some scheme that is compatible with the selected conceptual address translation method (or compatible with the selected addressing type).

This is always what is meant in this patent application, even if not explicitly repeated. If this principle were to be explicitly discussed every time the phrase “address translation method” is used, then the text of the patent application would be made overly complicated for analysis and understanding.

Therefore, this is not written every time, but it is always to be understood that there are three alternative interpretations that are essentially equivalent for this invention:
1) A computer device selects the address translation method that should be used to access memory or transfer control;
2) A computer device selects which type of address (for example, a linear address in virtual memory or a physical address) should be used to access memory or transfer control;
3) A computer device selects by which method it accesses memory or transfers control and then acts according to the selection, using some addressing method, and not explicitly translating addresses.

In terms of the ideas underlying this invention, all three interpretations are equivalent—even if these interpretations help a person skilled in the art to select a different implementation of this invention on a specific computer device.

In addition, we emphasize that all solutions that are described below as address translation solutions can be used not only for the conversion of high-level addresses into lower-level addresses, but also generally for arbitrary transformations of a logical address (or basic address information), including translating such an address into another format, recalculating its value, and so on.

Some solutions described in this patent application are especially effectively implemented when using parameterized prefixes or suffixes of executable operations.

If the computer device's command system does not support prefixes or suffixes, or if they are not suitable (for example, they cannot have parameters), or if there is no room for new prefixes or suffixes in the operations' code space, or if their implementation is made too complicated by decoding commands, then a special executable operation(s) may be used as a prefix or suffix, which must be executed along with the basic operation(s) following (or preceding) it, and not by itself.

The purpose of this special prefix operation is to carry additional information (submitted by the user) in order to use it in a subsequent operation. Alternatively, in some implementation variants, it may modify the values of basic operations' operands.

If the operation is supplied with such a prefix and an exception occurs during its execution, then the pointer for the current operation (Instruction Pointer or its analog) must point to the operation prefix, and not to the basic operation following it.

Conversely, a special operation that plays the role of suffix can process the result of a basic operation or complete some process that the basic operation started.

In particular, at a lower level a parameterized prefix or suffix, or a special operation replacing them, may be implemented using a separate micro-operation, the result of running which (in the simplest implementation this is the value of its operand(s)) will then be collected by the basic operation (in this case it is not necessary to write this intermediate result in registers visible to the user). Or, conversely, this micro-operation may collect the intermediate result of the basic operation for additional processing, or to complete something begun by the basic operation.

Also, prefixes or suffixes may be used to return additional information to the program. Using them in this way is unusual, but technically possible (it may be implemented by a person skilled in the art).

In particular, at the lower level of implementation a prefix or suffix that returns data may be implemented by adding a micro-operation to the executive unit queue, which writes additional information in the place (for example, in a general purpose register) where the prefix's or suffix's parameter points, similar to a general purpose operation.

The presence of such a prefix or suffix may also cause a computer device to write additional information to a fixed register that is not a parameter of the prefix or suffix, or to replace the initial value of one of the operands of a basic operation with additional information.

If this is necessary, then a computer device may translate the information returned by it from an internal representation into another representation that is suitable for the software, or combine it with other information.

Additional Channel for Exchanging Useful Information

This section covers the implementation of a computer device that is characterized by the fact that it can:
(a) use the value of a specific bit or bits of a high level address or its component(s) (in particular a logical, linear, virtual, or other address at which an executable operation (in particular command, instruction, order, operator, or function, both imperative ones, and ones that control data processing) or data processing operation operates, the component(s) of such address, or offset relative to some base address (including relative to an Instruction Pointer), regardless of whether such an address, or an address component or offset, is used directly, or as part of information to calculate another (effective) logical address, or they themselves constitute an effective address or were extracted from a calculated effective address) as additional information;
(b) and/or extract additional information from the value of a high level address (logical address) or from its component(s) (as defined in the previous clause “a”) using some function (function, scheme, circuit, or algorithm, including those implemented in microcode, in hardware, and/or in software, including using additional information and/or data structures);
(c) and/or obtain additional information from an external source (in particular from another device) as part of or in the composition of address information;
(d) and/or use a prefix or suffix preceding or following an executable operation (in particular command, instruction, order, operator, or function, both imperative ones, and ones that control data processing) (or its code) to obtain such additional information that during the executable operation replaces, supplements, or modifies the information that otherwise (without such prefix or suffix) would have been read from control registers, descriptors, segments, page tables, or other control data structures;
(e) and/or use a prefix or suffix preceding or following an executable operation (or its code) to obtain such additional information that affects address translation (in particular affects translating high level addresses into lower level addresses, including into physical memory addresses), that identifies the address space, context, virtual machine, or another object, that controls data caching during the execution of the current operation, that represents memory protection keys, that instructs this device to read or write other additional information and/or that will be included in a transaction with another device as additional data;
(f) and/or use a prefix or suffix preceding or following an executable operation (or its code) in order to supplement or modify the information obtained in such a way as described in clauses (a . . . e) above;
(g) and/or to supplement or modify the information obtained in such a way as described in clauses (a . . . e) above using additional information extracted from the context in which the executable operation is encountered, or from the context that led to its execution or analysis;

and then uses this additional information unchanged or transformed in an arbitrary manner (including by combining it with other information) for any purposes or in any capacity, in particular:
(a) in order to control caching (in particular to prohibit caching or delayed writing, or as other information that controls caching);
(b) and/or as information about the access pattern for memory that is intended to improve caching or prefetching, in particular as information about the advisability of reading the next cache line (to organize prefetching) or about the necessity of clearing the tail of a cache memory line after writing in that line (in order to avoid reading from memory a line whose content will be replaced with new data);
(c) and/or as additional data that helps reduce the probability of collisions when working with associative cache memory (in particular due to this data's effect on the circuit or algorithm to select the data set that will be used to search or save information in an n-way associative cache);
(d) and/or to control speculative execution and command prefetching, in particular, information on the probability of triggering a conditional jump in the branch or cycle commands);
(e) and/or to instruct this device to use specific rules for translating high level addresses (logical addresses) into lower level addresses (for example, into physical addresses of memory cells), and/or to use specific address transformation, and/or to instruct this device to use specific parameters of such address translation or transformation (for example, those specifying the size of the page, quantity of levels in page tables, or the type of page tables used, but not only those);
(f) and/or for synchronization in a multi-processor or multi-core system;
(g) and/or to replace, supplement, and/or modify such information, which otherwise would have been read from control registers, descriptors, segments, page tables, or other control data structures;
(h) and/or as an identifier of an address space, context, virtual machine, or other object (in particular to access other address spaces or memory of other virtual machines without switching context), in which regard such identifier may be encoded using variable-length codes or (an)other method(s);
(i) and/or as memory protection keys;
(j) and/or to transmit this information to another device for any purpose (in particular, to transmit it to an external memory controller, a direct memory access controller, or another device, either within the address information, or by other means);
(k) and/or to transmit this information to a program or to a data transformation process (in particular to transmit to a program data that will subsequently help improve its performance);
(l) and/or to read or write other additional information (including using the address that the current executable operation accesses);

if such use of additional information does not contradict its purpose, explicitly indicated in the description of the method to obtain it.

In other words, this invention describes the use of logical addresses, prefixes and/or suffixes of executable operations, including in aggregate with the context, as an additional channel for exchanging useful information with a computer device. As well as the set of solutions, that use this information. Clause (c) in the first part of the brief description of the invention above also describes the receipt of additional useful information from external sources.

Previously created devices received similar information using special instructions, or extracted it from control registers, page tables, and/or segment descriptors, and with great limitation transmitted some individual signals using prefixes (only by the fact of the presence or absence of a specific prefix), but did not have an effective channel to transmit arbitrary additional information in executable operations themselves.

From the description given in the beginning of this section, it follows that the patented computer device may be implemented according to a scheme that may include four steps:
1) First the computer device extracts additional information from the higher level address (logical address), receives it from an external source (for example, from another device) as part of the address information, and/or receives some classes of additional information using a prefix or suffix of an executable operation—as discussed in paragraphs (a . . . e) in the first part of the description of the device given in the beginning of this section;
2) Optionally, the computer device supplements or modifies this information using additional information received using a prefix or suffix of an executable operation and/or from the current context—as described in paragraphs (f) and (g) in the first part of the description of the device given in the beginning of this section;
3) If it is necessary, then the computer device next transforms the additional information it has gathered in an arbitrary manner, combining it with any other information (possibly received from other sources) when necessary;
4) Then the computer device itself uses the received additional information and/or transmits it to another device and/or returns it to the program (or to the data transformation process), in particular as described in paragraph (a . . . l) in the second part of the description of the device given in the beginning of this section.

The implementation of the third step (the step of transforming the gathered information, if it is necessary) is completely determined by a person skilled in the art implementing this invention on his device and is completely outside the scope of this patent application.

Nevertheless, in some examples solutions are discussed that use a combination of information gathered during the first stage with information received from other sources, in particular with information extracted from page tables.

The most obvious options for implementing the fourth step, that is options for using additional information, are discussed below, in the following section “Using Additional Information.”

This section describes methods to implement the first two steps of this invention, corresponding to paragraphs (a . . . g) from the first part of the description of the device given in the beginning of this section.

These paragraphs are explained in detail:
(a) A computer device reads the value of a specific bit or bits in a higher-level address (in the logical address), in its component(s), and interprets this value as additional useful information.
   This embodiment is suitable for the majority of modern processors that have an effective length of logical address (higher-level address) values that is shorter than the bit length of registers.
   For example, the x86 family processors, widely available on the market, use only 48 or 57 low-order bits in a 64-bit register as the effective value of a logical address, leaving the remaining 16 or 7 high-order bits as reserved bits, respectively.
   This invention describes how these reserved bits may be effectively used to transmit useful information that identifies an address space, controls address translation, caching, prefetching, speculative execution, synchronization, etc.
   A person skilled in the art can select from exactly which address, the source address or effective address (that is, the one calculated during the execution of the operation or during its preliminary analysis), the useful information will be extracted.
   The source of additional useful information may also be, not the whole logical address, but a component(s) of it—in the case that the computer device supports complex addressing modes.
   For example, additional useful information may be extracted from specific offset bits included in the address information.
   In the majority of cases great flexibility is obtained if the useful information is extracted from a previously computed effective address (for example, one to which an offset and/or other components have already been added).
   However, a more flexible technology is described in the “Extended offsets” section that can combine the advantages of both normal offset use and the advantages of placing additional information in them.
(b) A computer device extracts additional useful information from a higher-level address (logical address) or from its component(s) using some function.
   In this case, it is not necessary to place additional information in the logical address's fixed bits. Instead, the whole value of the logical address or the value of its component(s) is (are) translated using some function that selects additional useful information from them.
   The same function (or a different one logically related to the first) also selects from the logical address basic address information that is specifically designed for addressing memory (removing additional information from it if necessary).
   Basic address information may be, for example, a linear address that will be transmitted to the MMU input. Alternatively, any other address information that is then used in the ordinary manner for this device.
   This embodiment is similar to the one described in paragraph (a) above, but it is better suited to devices with a complex, possibly non-linear logical address structure (in particular for devices where the length, format, or purpose of basic address information depends on additional information).
(c) A computer devices extracts additional useful information from address information obtained from an external source (in particular, from another device) and then uses it as described in other sections of this patent application.
   In particular, some computer devices received address information from other devices during operation. These devices may extract additional information from the address value they receive in the same manner as described in paragraphs (a) and (b) above.
   For example, if this device receives from another device an address for reading or writing data, then the specific bits of this address may be interpreted and used as described in other sections of this patent application.
   Alternatively, the values of these bits may contain any other useful information envisioned by a person skilled in the art who implements this invention on her device.
   The innovation of this invention lies in the proposition of using currently reserved address lines or bits for transmitting additional useful information without interfering in the format of the data transmitted between devices.
   By using reserved bits or lines (formally designed to transmit address information) in this manner, as described above, the devices can exchange additional information even without adding additional instructions to the program—if this additional information is included in the composition of the address data, which is transmitted between devices by instructions already present in the program.
   In particular, a number of standards for computer buses and interconnect architectures recommend a higher bit length for transmitted addresses than the bit length for addressing that is de facto supported by all devices connected to such bus or interconnect architecture.
   For example, the PCI Express bus in modern computer systems uses 64-bit addressing, although there are currently no memory subsystems of this size. Thus, a 64-bit address transmitted via the bus always contains zeros in the high-order bits.
   As described above, these reserved bits may be used to transmit additional useful information—which is useful in the case that the developers of the computer system do not want to change the format of data transmitted in bus transactions, but they require an additional channel to exchange a limited amount of additional data (for example, to transmit some control bits).
   In particular, this additional information may be transmitted as a collateral result of executing normal operations to read or write data, and not only generated using individual executable operations. For this reason, it will accompany a specific data exchange transaction via the computer bus (the transaction that the transmitted address information concerns).
   In particular, this paragraph describes the implementation of a device that is itself a receiver of data transmitted by another device implementing this invention.
(d) A computer device reads additional information directly from an operand(s) or from a source to which an operand(s) of an executable operation's prefix or suffix point(s); alternatively, it considers the presence of a certain prefix or suffix with a given executable operation to be additional information.
   In the simplest case, an operand may be a direct value placed in a specific bit or bits of the machine representation of a prefix or suffix. In this case, this value is additional information.
   However, in order to achieve maximal flexibility, it is recommended that a person skilled in the art implement prefixes or suffixes that are parameterized by general purpose registers (for register processors), or are designed to pull additional information from the top of the stack (for stack processors), or receive additional information as the first element of a list or tuple (for data-driven machines).
   This allows additional information calculated during the operation of the program, and not merely constants, to be transmitted to the computer device.
   The operands of such prefixes or suffixes may be coded by general principles for coding machine command operands for such device.
   In particular, if the prefix or suffix's operand is a general-purpose register, then in the machine representation of the prefix or suffix it will be coded as the register number.
   Having determined the presence of a prefix or suffix (by its code, for example), the computer device extracts the register number from its machine representation and then reads the additional information from the register corresponding to said number—similar to the process of reading the values of operand registers that is used when decoding and executing normal operations.
   Different versions of the same prefix or suffix may be provided, or different options for coding its operands that permit the transfer of both a direct value as well as, for example, a register or even a pointer to the memory area, including one aggregated using addressing methods supported by this computer device.
   In this case, the value of the effective address for the pointer that is used in the prefix or suffix may be calculated by the same method by which effective addresses are calculated in ordinary operations on this device.
   At the lower level of implementation, this parameterized prefix or suffix may be implemented as a separate micro-operation, the result of executing which will then be collected by the basic operation (in this case it is not necessary to write this intermediate result in registers visible to the user). Or, conversely, this micro-operation may collect the intermediate result of the basic operation for additional processing, or to complete something begun by the basic operation.
   Some existing processors (for example, x86 family processors) already use prefixes or suffixes that precede or follow operation code.
   However, their prefixes and suffixes (in aggregate with other bits in machine representation of commands) indicate which components should be used to calculate the effective address (not defining, in this regard, how this calculated effective address will be translated into a physical address), indicate the name of the segment register (in the segmented model of memory addressing), serve to organize the cycle, allow boundaries to be checked, change the direction of prefetching in the conditional jump instructions or control synchronization during memory accessing (prefixes LOCK and extension HLE).
   New types of prefixes and suffixes are described which, as far as we know, have no analogs either in the x86 family or in any other devices.
   These prefixes or suffixes are designed to transmit information, which affects address translation (in particular affects translating high level addresses into lower level addresses, including into physical memory addresses), which identifies the address space, context, virtual machine, or another object, which controls data caching during the execution of the current operation, which represents memory protection keys, which instructs this device to read or write other additional information and/or which will be included in a transaction with another device as additional data.
   This patent application also describes a device that implements a new class of prefixes or suffixes that can carry full parameters, similar to the parameters of executable operations themselves.
   However, distinct from an ordinary machine command used independently or traditional prefixes and suffixes of x86 (such as REX, SIB, ModRM) that add missing bits to extend the coding of machine command operands, these proposed new prefixes (or suffixes) add additional information during the execution phase of the base operation associated with them.
   In other words, proposed new prefixes or suffixes deliver information to the steps following the calculation of the effective address.
   This information will be used after decoding commands, possibly, after its being broken down into micro-operations and even after calculating the effective address encoded by its operands.
   In particular, these prefixes or suffixes can be used to replace, supplement, or modify information that otherwise would have been read from control registers, descriptors, segments, page tables, or other control data structures.
(e) This paragraph differs from paragraph (d) only in the purpose of the information—these differ in the description of the device only to facilitate expression.
(f) Having identified an executable operation's specific prefix or suffix, the computer device also acts as described in paragraph (d), but in this case it supplements or modifies the information it previously received using methods described in paragraphs (a . . . e) with the new information.
   The key distinction between this paragraph and paragraph (e) is the lack here of limitations on the class of additional information that can be transmitted to the computer device using this method.
   This paragraph discusses the addition of new data to information that was received using methods unique to this invention; it is therefore not necessary here to require a list of the specific classes of information for new prefixes or suffixes (as in paragraph (e), where this was necessary to eliminate possible interference with earlier developments).
(g) The computer device extracts additional useful information from the context in which the executable operation is encountered, or from the context that led to its execution or analysis. Then it supplements or modifies the information it previously received using methods described in paragraphs (a . . . e) with the new information.
   In particular, special operations that create a new context for subsequent operations may be implemented in the computer device. These operations may have a parameter(s) with which additional information is transmitted to the computer device, and such additional information is used as described in other sections of this patent application. Additional information can also be the fact itself that an operation has been executed (analyzed) in this context.
   This additional information is subsequently used by this computer device during preliminary analysis or the execution of subsequent operations that are considered to be nested in this new context until it is closed.
   In this regard, the closure of this context, for example using an operation to return to the previous context that has been implemented on this device, stops even the use of this additional information during the execution of subsequent operations.
   In another computer device, formal rules may be implemented covering nesting executable operations within one another or in blocks, such rules creating a new context that can also be supplied with a parameter(s) that carry additional information described in this patent application. Additional information can be the fact itself that an operation is nested in this context.
   In such an implementation, this additional information will be used by commands that are nested in this context.

Using Additional Information

This section covers a number of options for using additional information extracted using solutions that constitute the essence of this invention.

A new device that is an embodiment of this invention corresponds to each option for using additional information.

As a rule, additional information is used to improve performance, that is, it helps improve the efficiency of software and/or save energy.

In a number of cases, new capabilities are added to existing devices or problems are better solved than by existing devices.

For example, when using additional information to access other address spaces (especially using logical addresses that contain identifiers of address spaces or contexts), one obtains not only a substantial improvement in performance, but also a substantial simplification of many system software algorithms.

Transmitting information through an additional channel avoids overhead related to prefetching, decoding, analyzing dependencies, and executing additional control operations that would be necessary without this invention.

The effect is especially pronounced in the case that such additional information must be transmitted to a computer device many times, for example, during every, or almost every, access of some data structure.

Of course, each additional command requires prefetching, decoding, and analysis of dependencies, which takes up space in processor queues and requires separate access right checks, which take up time and energy. Reducing the number of operations also reduces the volume of code.

These options for using additional information correspond to paragraphs (a . . . l) in the second part of the brief description of the invention in the beginning of the previous section “Additional Channel for Exchanging Useful Information.”

The use of logical addresses to transmit additional information, proposed herein, helps to avoid multiple inclusions in the program of the same additional instructions for controlling caching, prefetching, or synchronization associated with the same object because the address of such an object, containing control attributes or commands, can be calculated once, but then used many times in different operations to access memory or transfer control.

Controlling Caching

In this embodiment additional information is used to control caching, which corresponds to paragraph (a) in the second part of the brief description of the invention in the section “Additional Channel for Exchanging Useful Information.”

In particular, a defined bit of additional information may be used to prohibit caching, similar to the PCD bit in a page descriptor in x86 family processors. For example, if this bit is equal to one, then the computer device does not use caching when executing this operation.

Similarly, another bit of additional information may be used to prohibit writing back, similar to the PWT bit in a page descriptor in x86 family processors. For example, if this bit is equal to one, then the computer device performs a direct write through to memory.

This data may not only be used directly, but it may also be combined using a logical function with similar data calculated from page tables. For example, if this data is combined with information from page tables using the “XOR” operation, then the caching control bits within the additional information will invert (and not replace) the settings that were made at the page table level.

Distinct from caching control bits that are implemented in existing processors at the page table level, the use of additional information according to the instructions presented in this patent application allows the control of caching at the level of individual lines of cache memory. This is an important distinction of this invention, since hundreds of cache lines correspond to each page, and different caching attributes may be useful for different lines.

In a number of cases where semantic conflicts do not arise between different caching regimes, it is possible to control caching attributes even at the level of individual variables that are smaller in size than the length of a single cache line.

Furthermore, it is possible to change the manner of working with cache memory at the level of individual executable operations. For example, it is possible to assign different offset values to them, which are summed with the base addresses (indicated in the operations that access memory) to transmit diverse information that controls caching.

Comparing this invention with caching control via Memory Type Range Registers (MTRR), Page Attribute Table (PAT), and similar structures, it allows to individually controlling caching at the level of individual variables or lines of cache memory, and not at the level of whole memory regions or pages. In this regard, it is possible to transmit to computer device different instructions to control caching in different operations without reprogramming the system registers (which are also inaccessible to an application program). Furthermore, this solution can be combined with the use of MTRR or PAT.

A person skilled in the art implementing this invention on his computer device can use the additional channel also to transmit different attributes that control caching.

The goal of this invention is only to provide the channel itself for transmitting such information, and not to install any single specific option for using this channel.

Transmitting Information on a Memory Access Pattern

In this embodiment, the additional information carries information on the access pattern for memory that is designed to improve caching or prefetching, which corresponds to paragraph (b) in the second part of the brief description of the invention in the section “Additional Channel for Exchanging Useful Information.”

In particular, the specific value (for example, equal to one) of some bit in the additional information may signal the advisability of reading the next line of cache memory in order to organize prefetching.

Many types of RAM operate more efficiently when they transmit data in large packets and do not read individual machine words or lines. However, in this regard programs usually consist of instructions that access individual memory cells.

If the programmer or compiler of the high-level language knows that after reading a given memory cell subsequent cells will be accessed with high probability or complete certainty, such cells falling into the next line of the cache, then it will be useful to convey this information to the computer device. This helps it to:
1) Place a request to read the next line earlier in the queue in order to execute it as early as possible in parallel with the execution of other operations;
2) And/or immediately read two lines (or more) of cache memory in order to use the advantages of data stream mode/burst mode transfer.

Therefore, many processors have a special command for prefetching data.

However, this invention allows the same effect to be achieved without including in the program additional instructions at each point where it reads such a structure of data that is suitable for prefetching.

This helps reduce the volume of software code, and relieves the processor of superfluous work that it would perform when reading, decoding, analyzing dependencies, and executing individual prefetching instructions.

In other words, by using signaling as to the necessity of prefetching through additional information, the efficiency of the code is increased and its size is decreased.

The second special case of transmitting information on the memory access pattern is transferring a signal on the necessity of resetting the tail of a cache memory line after executing the operation that writes data to this line.

In particular, the determined value (for example, equal to one) of some bit in the additional information can inform the computer device of the necessity of resetting data up to the end of the current cache memory line after writing new data in it.

Often the sequence of commands writes a greater quantity of data into memory. A typical example of such a sequence is the code to initialize typical data structure, especially one generated by a high-level language that supports object-oriented programming.

If the writing begins from an address that is a multiple of the length of the cache line, or if the volume of written data is greater than or equal to two line lengths, then using this invention saves cycles on a single memory access (to read data) for each fully overwritten line (if it is not in the cache).

This improvement does not always help, since the data may already be present in the cache, but if it is relevant for as little as a single line, then it saves a modern processor hundreds of cycles.

The fact is that when a processor encounters the first write command, it (generally) does not know whether other write commands follow it and whether they will completely overwrite the tail of the current line of cache memory with new data. Therefore, if data are not present in the cache, then the processor first reads the value of the entire cache line, and only afterward, it does change the value of the one cell affected by this write operation.

However, if the write begins from the start of the line and continues until its end, or if the length of the entry is greater than or equal to two lines, then there will always be a situation where the data erases the line completely. Then it will be unnecessary to read it from memory and only overhead will be created.

This invention allows the transmission to a computer device of a signal of the fact that data is guaranteed to be erased or overwritten before the current cache line ends.

It is possible to transmit such a signal without adding an additional line erasure command to the program, which would increase the size of the code, and would require time to read, decode, analyze dependencies, and execute.

Furthermore, if the subsequent commands include the most commonly used initialization of data structures with zeros, then the compiler may skip all or almost all zero entry commands if it knows that the data structure is aligned with the beginning of the cache memory line.

This improvement further reduces the volume of code and increases its running speed.

In a more complex implementation of this invention, the additional information may contain not only elementary instructions such as prefetching or deleting the tail of the current line as discussed above, but also more complicated instructions, including those parameterized by the length of read or erased data.

For example, some bits that control prefetching can code the length of the next read memory fragment, so that the computer device can decide whether it should read the next cache line(s) in stream mode/burst mode transfer.

Having checked this parameter, the computer device can more precisely evaluate whether it needs to read the next line of cache memory after this line, or if no prefetching is necessary (since the next access will be addressed to the same line as the current access).

Furthermore, the bits that control the cleaning of the line tail may contain information that allows all intermediate operations that write zeros into memory, as described in the next section, to be removed from the program.

Reducing the Number of Zero Entry Operations

In this embodiment, additional information is used to reduce the number of zero entry operations, which is a variant of the implementation in paragraph (b) in the second part of the brief description of the invention in the section “Additional Channel for Exchanging Useful Information.”

As discussed above, high-level language compilers, especially object-oriented ones, frequently generate long series of write operations, many of which enter zeros into memory, since null values are very often used to initialize the elementary objects that aggregate to make up more complex data structures.

In the general case, a programmer or compiler may not know in advance how the beginning of a data structure is aligned with the beginning of a line of cache memory. However, it is desirable to eliminate all the intermediate zero entry operations when initializing long data structures.

To do this, in addition to the signal on the necessity of clearing a cache memory line tail described in the preceding section, it is necessary to transmit to the computer device an additional parameter with information on how many preceding machine words (or other memory cells before the address that this write operation accesses) contain zeros.

If the distance from the beginning of the cache memory line to the address for the write operation is less than or equal to the indicated value, then the current line may be completely erased—its old content does not need to be read from RAM before this write operation is executed.

If the distance from the beginning of the cache memory line to the address for the write operation is greater than this value, then when this line is absent from the cache, it must be re-read from RAM in order not to lose values previously written into it. In this case, only the tail of the line, but not the beginning, needs to be deleted.

Thus, the first operation in a long series of write operation must be flagged as a line tail cleaner (which is equivalent to a null value of the parameter), but every subsequent write operation must include a parameter indicating how many null cells were omitted before it.

In this regard, all intermediate zero entry operations may be condensed into a single operation for each portion of data equal to a cache line length, and even this single zero entry operation is necessary only in the case that no other non-zero value is written into this portion of data (the length of which is equal to a cache line length).

This improvement is inapplicable to write operations for the very first cell of a series (it must be saved and flagged as a line tail cleaner, even if it writes a zero) and to write operations for the last portion of data. If the length of the last portion is less than the length of a cache line, then these last operations must also be saved.

When using the improvement described in this section, even in the case of displacing an already written line from the cache (for example, as a result of task switching or a call interrupt handler) the result of executing an entire sequence of write operations will always be correct.

Reducing the Probability of Collisions when Working with Associative Cache Memory

In this embodiment, additional information is used as additional data that helps reduce the probability of collisions when working with associative cache memory (in particular due to this data's effect on the circuit or algorithm to select the data set that will be used to search or save information in an n-way associative cache), which corresponds to paragraph (c) in the second part of the brief description of the invention in the section “Additional Channel for Exchanging Useful Information.”

In particular, some bits of additional information may be used to transmit a numerical value (tag), which is used as additional data for the selection algorithm of the associative set within cache memory.

A similar value may also be read from page tables (from the descriptor of the page that is accessed by this operation)—this solution is more suitable for application software (see section “Controlling Associative Sets for Application Programs”).

This digital tag may be equal to the number of the associative set that must be used for this data structure or array. Alternatively, it may be mixed by an arbitrary function with the address of the memory cell and/or other information that this computer device already uses to select an associative set.

In the last case, the tag is used to inject additional randomness into the standard associative set selection algorithm that is implemented on a given device—similar to the “nonce” value that contributes an additional element of randomness into cryptographic algorithms.

Which of these two embodiments to select (and in the second case—how precisely to mix the tag with other information) is determined by the person skilled in the art who implements this invention on her device.

If all the elements of some data structure or array use the same tag value (for example, one extracted from the pointer for this data structure or from the prefix of an operation into which the compiler placed the tag value extracted from the pointer declaration), then a connection arises between the pseudorandom values that are returned by the associative set selection function, with the data structure at the level of the program that is marked by this tag.

This reduces the probability of collisions related to the simplicity of the function that is normally used to select the associative set, which leads to the selection of the same set for two different addresses that are separated from one another by some defined value. If the data structures or arrays are marked with different tags, then even a simple function into which this additional information is passed will likely select different sets for them.

For a number of algorithms, a direct indication of the associative set or introduction of an additional randomness control element into the function to select it will either completely eliminate collisions related to the insufficient randomness of the set selected based on the address, or significantly reduce the probability of such collisions.

Reducing the number of collisions and competition between large data structures for the same associative sets may substantially accelerate the programs that process large volumes of data, for example, programs for machine learning, artificial intelligence, complex mathematics, physics, chemistry, and bioinformatics calculations, etc.

Additional practical aspects of using this improvement in software are discussed below, in the sections “Eliminating Competition for Associative Sets between Large Data Structures” and “Controlling Associative Sets for Application Programs.”

Controlling Speculative Execution

In this embodiment, additional information is used to control speculative execution and command prefetching, in particular, information on the probability of triggering a conditional jump in the branch or cycle commands, which corresponds to paragraph (d) in the second part of the brief description of the invention in the section “Additional Channel for Exchanging Useful Information.”

In particular, the determined value (for example, equal to one) of some bit in the additional information can inform the computer device of the necessity of making a decision contrary to that proposed by the standard branch prediction logic.

If the computer device uses relative, and not absolute, address values in the jump instructions, then in order to invert the standard logic it is necessary to check not whether a specific bit in the offset is equal to one, but whether it matches the offset's sign bit.

For example, if the dynamic branch prediction algorithm cannot determine the jump direction and the jump target is located above the current value of the Instruction Pointer, then this computer device's standard branch prediction logic may believe that the jump will take place, since the program organizes the cycle in this place.

However, if the code analysis conducted by the compiler shows that in this case the cycle is unlikely, of if the compiler knows precisely that this jump is not intended to organize the cycle and that the rule will not occur, then using this invention, it can include a signal in the additional information that notifies the computer device that in this case is it necessary to make the opposite decision—continue prefetching from the address following the jump instruction, and do not initiate speculative execution for branches associated with triggering the jump.

Conversely, by default this device believes that a jump down will not occur. However, if the compiler knows that the error handling code is located below, the speed of which not being important, then it can include a signal in the additional information that will cause the computer device to change its decision—do not start the speculative execution of the error handling code, but continue prefetching and execution at the jump address.

Theoretically, this improvement reduces the marginal distance accessible for control transfer operations, but the code of an actual program will never be so large that it requires all 32 offset bits that are available to many modern processors (nevertheless, this is not a problem for processors that have an offset with a large bit length).

Even a 32-bit processor with a naive implementation of this technology (on two higher order bits of the address, without using extended offsets described below) can transfer control up to a distance of positive/negative 1 GB from the current point, which is more than sufficient in all cases, except transferring control to dynamic libraries (but they are very rarely called using a conditional control transfer, and this capability itself is rarely supported).

A more complicated implementation using extended offsets barely limits the existing range, and allows this improvement to be applied to the vast majority of control transfer operations, thus preserving compatibility even with distant control transfers.

Thus, this invention allows adding direct control over speculative execution even for processors that do not provide the relevant bits for these purposes in the codes of operations (for instructions that transfer control, call functions, or return control).

In some cases, this improvement may be useful for devices that provide an additional prefix that affects jump prediction. The fact is that the prefix cannot be inserted into machine code in order to optimize the program “on the fly,” but a bit in the jump offset may be changed (if the bit length of the offset remains unchanged).

Several bits may be used instead of one, optionally such bits may coding the probability of triggering the control transfer for any algorithm, selected by a person skilled in the art implementing this invention on her device.

These improvements may also be useful for unconditional control transfer, function calls, or returns of control, for which it is precisely known that they transfer control to code intended for error handling, etc.

Another similar improvement may be implemented not only for conditional or unconditional control transfer, procedure call, and control return operations (if they are supported by this computer device), but also for indirect control transfer or indirect call operations.

Many high level languages have a multi-way branching operator, such as the “switch” operator in C and C++, for example. Often the compiler implements this operator through indirect addressing of the table that contains the branch addresses or that itself consists of the branch commands. In this regard to compiler may know (or the programmer may inform it) which branch in the “switch” operator is more likely.

However, when the computer device, during speculative or pipeline calculations, encounters an indirect jump or table-driven call operation, then it may not know in advance what the value of the index will be when accessing such table. Then it does not know which table element to read in order to obtain the jump address.

A person implementing this invention on their computer device may provide for the transmission of a “hint” in the additional information for such indirect control transfer or call operations. For example, some bits of additional information in an extended offset may contain the number of the most likely branch in the branching operator. Extended offsets (described below) allow the “concealment” of a sufficiently large value in a normal offset.

When such a hint is present, the computer device may begin reading the necessary array element (with the control transfer address) in cache memory early, but if this element is already in cache memory, then it may continue prefetching and speculative execution from this more likely jump or call address.

This improvement is not useful for all indirect branch or table-driven call operators, but if one of the branches is substantially more likely, then this improvement may significantly increase speed.

Selecting an Address Translation or Transformation Method and/or its Parameters

In this embodiment, additional information is used to instruct this device to use specific rules to translate addresses or a specific method of memory addressing, or to instruct this device to use specific address transformation, and/or to instruct this device to use specific parameters of such address translation or transformation which corresponds to paragraph (e) in the second part of the brief description of the invention in the section “Additional Channel for Exchanging Useful Information.”

In particular, the specific value (for example, equal to one) of some bit in the additional information may instruct this device to use specific rules for translating high level addresses (logical addresses) into lower level addresses (for example, into physical addresses of memory cells), and/or to use specific address transformation, and/or to instruct this device to use specific parameters of such address translation or transformation (for example, those specifying the size of the page, quantity of levels in page tables, or the type of page tables used, but not only those).

Many aspects of such use of this invention are also discussed in detail in sections “Device Capable of Simultaneously Using Several Address Translation Methods During its Operation”, “Extended Offsets (Optional Extension)”, and in other sections of this patent application.

For example, if high-order bits of the logical address are used as an additional channel to exchange information, then setting the highest bit of the logical address to one may signify that the remaining bits of this address should not be translated into a physical address using pages tables in the MMU, but show be interpreted as an already prepared physical address, and used directly.

Such use of a high-order bit to select physical addressing of memory may be combined with using it to activate any other functionality described in this patent application.

For example, this bit may activate the use of other bits of a logical address in order to transmit more important attributes in them, which otherwise would have been read from page tables.

In another embodiment, a separate bit may be used to activate additional functionality.

Alternatively, the values of additional attributes (for example, those that control caching) may always be taken from the logical address and modify the values taken from page tables when ordinary memory addressing has been selected (with the linear address translated in the MMU through page tables).

It is possible to use the additional channel for transmitting information, organized using this invention, for several different purposes. This includes selecting an address translation method (memory addressing method), and transmitting additional attributes.

We emphasize that these solutions can be used not only for the conversion of high-level addresses into lower-level addresses, but also generally for arbitrary transformations of a logical address (or basic address information), including translating such an address into another format, recalculating its value, and so on.

This invention allows the use of different bits of the additional channel for different purposes, or conversely, the use of the same bits for activating several different functions—if this decision is made by the person skilled in the art implementing this invention on her device.

Transmitting Useful Information for Synchronization

In this embodiment, additional information is used for synchronization in a multiprocessor and/or multi-core system, which corresponds to paragraph (f) in the second part of the brief description of the invention in the section “Additional Channel for Exchanging Useful Information.”

In particular, some bits of additional information with values equal to one may signify that when executing this operation, it is necessary to wait for the completion of all reading and/or writing operations that were encountered during the previous command. Similarly, other bits may instruct the computer device to prohibit the speculative execution of subsequent reading and/or writing operations (until this executable operation is executed).

There are many different protocols for synchronizing access to memory and many conflict description models. A person skilled in the art who implements this invention on her device may select any suitable interpretation of additional information that controls synchronization.

The objective of this invention is merely to provide an additional channel to exchange such information, and not to impose a specific variant of using it.

Nevertheless, it is recommended to implement the capabilities described below to synchronize memory access in a multiprocessor or multi-core computer system.

In particular, a specific value (for example, equal to one) of some bit in the additional information may inform the computer device of the necessity of acquiring a barrier with acquire/release semantics, but a similar value of another bit may inform of the necessity of releasing a barrier with acquire/release semantics.

Alternatively, depending on whether some bit in the additional information is equal to a specific value (for example, one), the barrier is either acquired or released: read operations (such as load, load linked, load with reservation, load-then-modify, compare and swap) activate an acquire, while write operations (such as store, store conditional)—a release.

In the last case, it is possible to use only a single controlling synchronization bit, but it is necessary to check the type of operation when such a bit has been encountered during its execution and the freedom of programming is reduced.

It is proposed to use acquire/release semantics as the simplest semantics suitable for the majority of practical applications, such as acquire/release of mutual exclusion semaphores (mutexes), critical sections, rwlocks, and other classical algorithms.

As an alternative, a more complicated model may be implemented with individual control of four conflict types (load-load, load-store, store-load, and store-store) or any other formalization selected by a person skilled in the art implementing this invention on her device.

Similarly, additional information bits may also be used for other types of synchronization, such as the complete stop of speculative execution for self-modifying code (similar to the “isync” instruction of PowerPC family processors), simple read or write barriers (load/store fence), etc.

Replacing, Supplementing, or Modifying Controlling Information

In this embodiment, additional information is used for replacing, supplementing, or modifying controlling information, which corresponds to paragraph (g) in the second part of the brief description of the invention in the section “Additional Channel for Exchanging Useful Information.”

A modern computer device (for example, processor) has a set of control registers, segment descriptors, pointers for controlling data structures (such as page tables), etc.

Typically special commands designed to read, write, or modify such information are provided in its command system.

The question is, what can be done if the operating system (and in some cases even an application program) needs a local change in controlling information within a short time, for example, to execute a single operation?

A local change in controlling information using special commands is ineffective, in particular, for the following reasons:
1) This requires adding separate commands to the program, for example, to change the values of controlling registers;
2) Typically the old values of controlling registers must first be saved by separate commands and then returned, which further lengthens and slows the program;
3) Changing the value of a control register may be a dangerous operation, which requires a special design of the operating system. For example, reloading the register with the address of page tables may make the values of pointers to the current operation (instruction pointer) and the pointer to the top of the stack incorrect—if system developers do not place such system code and stack on “global” pages that are visible at the same addresses in all address spaces.

The additional channel for exchanging useful information allows the instant avoidance of the above-listed (and other) problems by transmitting local control information changes or amendments during the execution of an individual operation without changing the values of control registers.

In order to change a series of control values, it is sufficient to add a trivial circuit to the computer device that, when additional information is present, combines it with the values of basic control data that is already provided for in the processor.

For example, if the additional information transmitted using a prefix contains bits that affect the rounding mode in a Floating-point Processing Unit (FPU), then they may be combined with similar bits taken from the FPU control register using the “XOR” operation. They may also simply replace them. As a result, the programmer and compiler have the ability to use an arbitrary rounding mode in each separate operation—without reloading the control register.

In this regard, a person skilled in the art can implement a universal parameterized prefix or suffix for similar interferences in some types of control information. Alternatively, they can provide for local interventions in individual operations with control through high-order bits of the logical address or through specific prefixes or suffixes.

In any case, the implementation of such interferences is trivial for a person skilled in the art after she implements the additional channel described in this patent application itself (through logical addresses, through an additional prefix or suffix of the operation, or through a combination of them, possibly taking context into consideration).

Certainly, such a channel is not necessary and justified for all control information, but a person skilled in the art implementing this invention on her device obtains a universal mechanism for influencing the computer device without substantially altering its command system and internal circuits.

For example, after adding a universal prefix to transfer universal information, it is not necessary to add new special variants of instructions (with anything overlapping). Neither is it necessary to add new operands to old instructions (typically there is not a sufficient quantity of free bits in their machine representation).

Replacing, Supplementing, or Modifying Data from Page Tables

In this embodiment, additional information is used for replacing, supplementing, or modifying data from page tables, which is a special case of the implementation of paragraph (g) in the second part of the brief description of the invention in the section “Additional Channel for Exchanging Useful Information.”

Yet another possible use of additional information is replacing, supplementing, or modifying data that is read or otherwise would have been read from a page descriptor. Of course, this use is intended only for system software.

For example, when using physical addressing of memory through a logical address, as described in this patent application, additional information may be used to transmit to the computer device such bits (absent elsewhere in this case) that prohibit writing or prohibit the execution of operations (which in the traditional implementation are read from page tables).

A person skilled in the art may proceed more flexibly, placing in additional information an index of the type of memory that refers to the system register or a control table element, where the set of control bits is matched with this type of memory, when such bits would otherwise have been read from page tables.

Accessing another Address Space by Replacing Page Table Addresses

In this embodiment, additional information is used for accessing another address spaces by replacing the addresses of page tables, which is a special case of the implementation of paragraph (g) in the second part of the brief description of the invention in the section “Additional Channel for Exchanging Useful Information.”

If the capability to transmit an alternative value of the root page table (or directory) address is added to the computer device, then it becomes possible to access data located, not in the current address space, but in other address spaces, without mapping their pages in the current address space, without switching contexts, without changing the values of system registers and with practically no overhead.

This functionality directly writes, reads, or copies data located at another address space, ultimately accelerating a number of operating system algorithms, as well as many algorithms that help applications to rapidly exchange data.

The capability to simultaneously access different address spaces without reloading system registers substantially improves performance and helps save energy by substantially reducing the quantity of service operations associated with so-called context switching, especially during the operation of system software. This includes the operation of interrupt handlers, which are often needed to access the data of another process, distinct from the current process, which was active during the interruption. In this regard, the solutions described in this patent application do not require mapping the pages of another address space into the space of the current process, or even into the system part of the address space.

This functionality can be provided not only for system software, but also for application software.

Modern processors already supply Table Lookaside Buffer (TLB) elements and some other internal data structures with an identifier of the current address space or context (such as the PCID identifier in x86 family processors). They already try to facilitate the operation of reloading the register that points to page tables.

In this case no trouble occurs if, at the level of an individual executable operation, the processor uses another value as the root page table (or directory) address, distinct from the value to which the control register containing the current address of page tables points (such as the CR3 register in x86 family processors).

If the computer device receives additional information that constitutes an alternative value of the pointer for the root page table (or the analog thereof for another virtual memory architecture), then instead of reading this value from the system control register (or the analog thereof) the computer device uses the value transmitted by the user during the execution of the current memory access operation.

This alternative value may be transmitted using a parameterized prefix or suffix of the executable operation (possibly using several prefixes or suffixes, if this operation addresses more than one object in memory, as a data copying operation, or using several parameters of a single prefix or suffix).

The sole “pitfall” when implementing such a method to access another address space in modern processors that still lack built-in support for multiple address space may be the transfer of a page fault address (an address of an absent page or an address that causes another exception when accessing memory) without an address space identifier (or context identifier).

Such processors may be refined by a person skilled in the art, to supplement them with a separate register or interruption parameter that supplements the page fault address with a context identifier (such as PCID). Modern devices already collect this information, since it is already used to tag TLB elements.

The computer device may also supplement the page fault address with the direct value of the root page table (or directory) address, which is used during memory accessing (it is not important whether it was read from additional information or taken from a standard control register).

The mechanism described above to access other address spaces is simple and effective, but oriented toward system software that knows page table addresses. The next section and the section “Simultaneous Access to all Address Spaces” describe more elegant and flexible solutions.

Accessing another Address Space by its Identifier

In this embodiment, additional information is used for accessing another address space by its identifier, which is a variant of the implementation of paragraph (h) in the second part of the brief description of the invention in the section “Additional Channel for Exchanging Useful Information.”

An address space (or context) identifier may be used to access another address space when the computer device uses it to find pointer to the root page table of this space (or pointer to the analogous data structure for another virtual memory architecture) in the system table containing descriptors of address spaces.

The implementation of accessing other address spaces using their identifiers (including the procedure for verifying access rights, if this capability is also granted to application programs) is discussed in detail below, in the section “Simultaneous Access to All Address Spaces.”

Similar solutions may also be used to work with address spaces of different virtual machines.

Transmitting Different Identifiers

In this embodiment, additional information is used for transmitting to the computer device an identifier for the address space, context, virtual machine, or another object, which corresponds to paragraph (h) in the second part of the brief description of the invention in the section “Additional Channel for Exchanging Useful Information.”

If the computer device supports working with objects such as, for example, address spaces, contexts, processes, threads, virtual processors, virtual machines, or implements some other objects with identifiers, then the additional information may be used to transmit to the device (or to receive from the device) identifiers of such objects in operations where the exchange of this information through separate registers or other normal operands is difficult, clumsy, lowers performance, breaks compatibility with early versions of the device, etc.

A person skilled in the art implementing this invention on her device will determine with which operations and for what purpose these identifiers will be used.

The identifier does not need to be a fixed length integer. This may be any information that can be transmitting using the solutions that constitute the essence of this invention.

In particular, variable-length codes may be used to code identifiers, which allows variation in the number of bits leftover for the basic address information in logical addresses.

The use of parameterized prefixes or suffixes (as described, in particular, in the preamble of this patent application) or indirect access to additional information (described in the section “Indirect Access to Additional Information”) eliminate any limitations on the length and structure of identifiers.

Limited range identifiers may also be “hidden” in extended offsets, as described in the section “Extended Offsets.”

Transmitting Memory Protection Keys

In this embodiment, additional information is used as memory protection keys, which corresponds to paragraph (i) in the second part of the brief description of the invention in the section “Additional Channel for Exchanging Useful Information.”

In particular, specific bits of additional information may contain memory protection keys that will be used by the computer device itself. Alternatively, these keys will be transmitted to the Direct Memory Access (DMA) controller, or to another device, for example, by wires that are designed to transmit data or address information, or in several bus transaction fields.

Memory protection keys may be checked or used by the computer device itself, the DMA controller, or some other device.

Such keys may be used, for example, for checking privileges, authorizing access, authentication, data encryption, zero-knowledge proof, error correction when saving or transmitting data, error protection when programming, including to protect against erroneous actions from external devices.

A short key transmitted in the additional information may be an index or offset for another memory region that contains the full key value. In such an implementation, the computer device or another end addressee of this information may independently read the value of the key from memory and thereby translate the short key into a full key value before using it or transmitting it to another device.

If the key address is transmitted to the computer device in additional information using a parameterized prefix, then the restriction on the key length is removed and it is not necessary to make it with an index or an offset in a special memory space (for example, in the case that there is a large volume of cryptographic information).

In yet another implementation, the additional information indicates only the fact that memory protection keys are present (and possibly to the format or size of the keys). The keys themselves or the pointer to them is located near the memory space to which the logical address points. For example, in the preceding or following machine word.

In such implementations the computer device (or another device that has received additional information with the key address or indication of a key's presence), before actually using the key value, must execute an additional operation(s) to read this data from memory (for example, to read data located at the address transmitted in additional information, or at the address that is identified using additional information).

Transmitting Additional Information to another Device

In this embodiment, additional information is transmitted to another device for any purpose, which corresponds to paragraph (j) in the second part of the brief description of the invention in the section “Additional Channel for Exchanging Useful Information.”

In this case, additional information is transmitted to another device, which may use it in any way determined by a person skilled in the art who implements this invention on their computer system. The purpose of this information and its format is outside the scope of this patent application.

In particular, additional information may be transmitted to an external memory controller, a direct memory access controller, or an external device, either within the address information, or by other means. Data may be exchanged, for example, by wires that are designed to transmit data or address information, or in several bus transaction fields.

The variants of another device receiving this information are generally outside the scope of this patent application, but are partially discussed in the description of the implementation of paragraph (c) in the section “Additional Channel for Exchanging Useful Information.”

Transmitting Additional Information Back to the Program

In this embodiment, a computer device transmits additional information to a program or data processor, which corresponds to paragraph (k) in the second part of the brief description of the invention in the section “Additional Channel for Exchanging Useful Information.”

The computer device may provide executable operations, prefixes, or suffixes, which return addresses to the program. Addresses may also be received from external sources, for example, from other devices. These addresses may contain additional information organized as described in this patent application.

Also, the computer device may provide executable operations, prefixes, or suffixes that return information read by this device from the additional channel, which is organized as described in this patent application.

The purpose of such operations, prefixes, or suffixes and the specific methods by which they return additional information to the program (or data processor) are outside the scope of this patent application, but are determined by the person skilled in the art who implements this invention on her device.

The objective of this invention is to describe by what methods the additional information transmission channel itself is organized, and not all possible variants of its use.

In particular, additional information receive in such a way may be used to transmit to the program data that will help improve its performance in the future.

Indirect Access to Other Additional Information

In this embodiment, additional information is used for reading or writing other additional information, which corresponds to paragraph (I) in the second part of the brief description of the invention in the section “Additional Channel for Exchanging Useful Information.”

Additional information may serve as a signal that instructs the computer device to read or write any additional information (including using an address that the current executable operation accesses, but not only in this way).

In turn, this new additional information may then be used as described in this patent application.

In particular, the specific value (for example, equal to one) of some bit in the additional information may instruct the computer device to read other additional information located in a machine word that precedes or follows the address that this operation accesses.

In another embodiment, the specific value (for example, equal to one) of some bit in the additional information may instruct the computer device to read other additional information located in a register(s), the number(s) or index (indices) of which are contained in other bits of additional information. Alternatively, additional information (of the first level) can directly be such a number(s) or index (indices).

In this case, the restriction on bit length of such additional information is removed, and furthermore, such information may be a variable as well as a constant. When using this solution, its bit length is limited only by the bit length of the register or registers in which it is located.

The quantity of levels of indirectness, method of determining the address of written or read information, and its length are determined by the person skilled in the art who implements this invention on her device.

If this mechanism is used to indicate that additional useful information (at the next level) is located in memory, then in general, with proper implementation, practically all limitations on its length are removed.

In particular, this solution is suitable for transmitting to a computer device (or to another addressee) additional information, the length of which exceeds the volume of a basic additional channel described in this patent application—for example, to transmit cryptographic information.

Also, the writing of additional information in such a manner may be used to return large volumes of additional data to the program.

Information that serves as a trigger for reading or writing other information may not merely be a signal, but may also indicate the type, format, or length of other information that must be read or written—as determined by a person skilled in the art who implements this invention on her device.

The information may be read or written not only to or from memory, but also using control registers or other data structures in the computer device implementing this invention using its registers, stacks, etc.

Transmission of Commands within Additional Information

The control of caching, prefetching, or, for example, synchronization when accessing memory may be organized by methods other than transmitting bits of attributes, similar to those bits that are provided in page tables of many processors.

Another possible implementation of controlling a computer device using an additional channel described in this patent application is the transmission in additional information of coded commands that are interpreted by this computer device (or other devices for which this information is intended).

If there are many control attributes, then in aggregate they may require more bits than are available in the additional information transmission channel organized using this invention. Furthermore, the number of unacceptable, contradictory, or meaningless combinations of these bits' values grows quickly.

In these cases, it is recommended to the person implementing this invention on her device to switch to using commands instead of attribute bits.

Under such an organization, some fixed or variable (for example, when using a prefix encoding) number of bits in the additional information will contain an encoded command that controls caching, prefetching, synchronization, or something else.

Command coding may provide for additional parameters in some of them, and allow (or prohibit) the combination of some commands into a single packet of additional information.

It is also possible to combine the two approaches when certain signals are transmitted using control bits, while others are coded as commands.

The specific methods of coding commands and control bits, their semantics, rules for coding command operands (if provided), rules for combining commands (if allowed) are determined by the person skilled in the art who implements this invention on her device.

The objective of this invention is to provide a channel for transmitting this information from the program to the computer device (or to other devices) itself.

The organization of the channel has already been described above. The section below proposes a set of commands that is balanced from the perspective of satisfying the practical requirements of typical applications.

However, it is emphasized that the person implementing this invention may use her own system of commands (or not use this approach in general).

It is recommended to implement the following commands or some subset thereof:
1) Disable Caching;
2) Write Back;
3) Write Back and Flush;
4) Pre-Fetch;
5) Zeroing Tail;
6) Set Associative Tag (for use at the system level of privileges);
7) Acquire Barrier;
8) Release Barrier;
9) Set Access Key.

The Disable Caching command prohibits the use of cache memory while reading or writing data. To simplify semantics and avoid unnecessary programming errors, it is recommended to prohibit its joint use with the Write Back, Write Back and Flush, Pre-Fetch, Zeroing Tail, and Set Associative Tag commands.

The Write Back command initiates the writing back into RAM of a changed cache memory line that has been accessed. If the line is not changed, then nothing happens.

The Write Back and Flush command initiates the writing back into RAM of a changed cache memory line (similar to the Write Back command) and subsequently releases the line, so that new data can take its place. If the line was not changed (if the command was transmitted by a memory read operation, but the target cache line does not contain changes), then it is simply released.

The Pre-Fetch command launches prefetching in order to read the next line of cache memory after the current line. This command may provide for a parameter that encodes the length of the read fragment, for example, by containing the quantity of machine words that will be read after the word the current operations is accessing.

The Zeroing Tail command zeros the tail of the current cache memory line after executing the current operation. This helps avoid reading data from basic memory in the event that the current write operation is addressed to the first cell of a line that will be completely overwritten with new data. It is recommended to supply this command with a parameter that informs the computer device how many previous cells (for example, of machine words) contain zeros. The purpose of this parameter and the improvements for which it is designed are discussed in detail in the Section “Reducing Zero Entry Operations.”

The Set Associative Tag command transmits the value of a tag that affects the selection of an associative set within cache memory. These tags are described in detail in the section “Reducing the Probability of Collisions when Working with Associative Cache Memory.” It is not recommended to allow this command to be used for application software (application programs may use another method described in the section “Controlling Associative Sets for Application Programs”).

The Acquire Barrier and Release Barrier commands acquire or release, respectively, the barrier designed to synchronize access to memory. These barriers are described in detail in the section “Transmitting Useful Information for Synchronization.” They may be replaced by a single command that either acquires or releases a barrier depending on whether the operation currently being performed is related to reading or writing data.

The Set Access Key command transmits memory protection keys or indicates that they are present (keys are discussed in detail in the section “Transmitting Memory Protection Keys”).

It is emphasized that all the above-listed commands may be represented by separate control bits.

Determining the Necessity of Using an Additional Channel

This section describes the implementation of a computer device that is characterized by the fact that a specific result of:
(a) analysis of a logical address that an executable operation received as an operand or effective logical address that was calculated during its execution or preliminary analysis;
(b) and/or analysis of the constituent components of such logical address, in particular analysis of the additional offset relative to the base address, which is specified in an executable or analyzable operation;
(c) and/or analysis of information (in particular specific bits, flags, options, fields, or additional operands) contained in the description or in the machine representation of an executable operation;
(d) and/or analysis of the code of an executable operation, prefix, or suffix that precedes or follows it (the operation itself or the operation's code);
(e) and/or analysis of information obtained from the context in which the executable operation is encountered, or from the context that lead to its execution or analysis;
(f) and/or analysis of the field(s) or flag(s) of the control structures of this device, or the field(s) or flag(s) reflecting its state (if applied to address translation, such state of a flag(s) or fields(s) of a given device must occurs only in a specific context that can be established and closed using specific executable operation(s) that create or close such a local context, and that do not lead to switching the device's mode of operation);
(g) and/or analysis of a specific field or fields in the page table (or directory) element on such a level in the page table hierarchy that the size of the region corresponding to it in the logical address (high level address) space is greater than or equal to the size of the lower level address space (in particular physical addresses space) that are supported by this computer device in its current mode of operation;
(h) and/or analysis of a specific field or fields in the segment descriptor, if this computer device supports the segment addressing model;
(i) and/or analysis of a specific field or fields in the descriptor of the address space, context, virtual machine, or in the descriptor of another object supported by this device;

instructs this device to use the additional channel for exchanging useful information, that is, to act as described in the section “Additional Channel for Exchanging Useful Information.”

This section of the patent application describes a flexible method for activating an additional channel that is designed to exchange useful information, which allows the computer device to work in the normal manner if such channel is not activated.

The device described in this section first decides whether it will use other methods described in other sections of this patent application. The principles underlying this decision are briefly described in paragraphs (a . . . i) in the first part of the description of the device at the beginning of this section and will be discussed in more detail below (in this section).

All the actions performed by the above-described device after deciding to use the additional channel are identical to the corresponding actions that are described in detail in other sections in this patent application, in particular in the section “Additional Channel for Exchanging Useful Information.”

That is, during the stages of extracting, translating, and using additional information, this device acts as described in other sections of this patent application.

Therefore, this section will not repeat a description of the implementation of other stages of the operation of the patented device, except the new decision-making stage.

Here this new preliminary stage is described, during which the computer device decides whether or not it needs to activate an additional channel for exchanging useful information and then acts as described in the section “Additional Channel for Exchanging Useful Information” and other sections of this patent application.

The following are details of implementation of paragraphs (a . . . i), which are listed in the first part of the description of the device that is briefly described at the beginning of this section:
a) The computer device analyzes a high level address (logical address) that an executable operation received as an operand or effective logical address that was calculated during the preliminary analysis or execution of the operation, and depending on the value of this address, it decides whether to use the additional channel, or whether the device will continue to work normally, without using this invention.
   In one embodiment, the computer device analyzes a specific bit(s) of the logical address, and if this bit(s) contain(s) specific values, then it considers it necessary to act as described in other sections of this patent application.
   If this bit(s) contain(s) another value, for example, if it is equal to zero (for compatibility with previously created devices), then this device continues to work normally, and will not use the solution from this patent application.
   In another implementation of this decision-making method, the computer device checks whether the logical address falls within a defined range or set of ranges, clearly specified, that is assigned through system control registers or other means selected by this device's developers.
   In this embodiment, depending on whether the value of the logical address falls within the selected range, or depending on into which set of ranges the logical address falls, the computer device decides whether to use the additional channel, and if so, in what manner.
   For example, an address falling into the defined range may signify that the computer device acts according to the schemes described in other sections of this patent application. In the remainder of cases, the device works normally, as it would if this invention were not implemented.
   There exist devices that use the check as to whether the logical address falls within the defined range to access memory with several additional attributes, for example, with caching disabled.
   A critical distinction of a computer device on which this invention is implemented and previously created devices is the use of technology to compare addresses to activate the additional channel to transmit useful information, for example, information affecting caching, instead of the use of previously defined caching rules for when the address falls within the assigned range.
   In particular, if the additional channel is activated, then next the device using this invention extracts caching control bits from the logical address or acts in another manner in accordance with the methods described in this patent application. In contrast, when the address falls within some range, previously invented devices use some predefined (fixed) caching attributes, or these attributes should be read from some separate control register of the processor, or from a system table.
   In another possible embodiment, the computer device applies some function to the received logical address, and depending on the value returned by this function, it decides whether to use the additional channel, or whether the device will continue to work normally, without using this invention.
   In other words, the computer device checks whether the logical address belongs to one of the classes of addresses using some function (the implementation of which is selected by the device's developers), and depending on the results of this function, either switches or does not switch to using the methods described in corresponding sections of this patent application.
   In this regard, different function outputs may activate different variants for using the additional channel.
   This method of checking the activation of the additional channel is best suited to devices with a complex, possibly non-linear logical address structure.
b) The computer device analyzes the components or one of the components of the high-level address (logical address) in the same way as described in the previous paragraph (a).
   For example, the computer device decides to activate the additional channel by analyzing the additional offset relative to the base address that is specified or used in this executable operation.
   In this embodiment, the analysis is performed as described for a logical address in paragraph (a), only the object of the analysis is not the entire logical address, but one or several of its components.
c) The computer device analyzes additional information (for example, specific bits, flags, options, fields, or additional operands) contained in the description of in the machine representation of the executable operation, and depending on this additional information (for example on the value of flags), it decides whether to use the additional channel, or whether the device will continue to work normally, without using this invention.
d) The computer device analyzes the executable operation code, prefix, or suffix preceding or following it (the operation itself or the operation code), and depending on the operation code, prefix, or suffix, or depending on the value of parameters (including operands, fields) of the prefix or suffix, it decides whether to use the additional channel, or whether the device will continue to work normally, without using this invention.
   In particular, this embodiment implies that the computer device command system may include special executable operations, or may provide special prefixes or suffixes that modify the behavior of existing operations that instruct this device to use an additional channel.
e) The computer device analyzes the additional information received from the context in which this executable information was encountered or which led to its execution or analysis, and depending on this additional information, it decides whether to use the additional channel, or whether the device will continue to work normally, without using this invention.
   In particular, such context information may be the fact that some function was executed in the context of a special (service) function (in a functional programming system), or the fact that an executable operation is embedded in a specific service section.
   The selection of any address translation method may be determined by any other context determined by the developers of this device that depends on the manner of sequencing, embedding, or executing operations.
f) The computer device analyzes a specific flag(s) or field(s) of the control structures of this device, or analyzes the current state of this device, and depending on the value(s) of these flag(s), field(s), or depending on the device state, it decides whether to use the additional channel, or whether the device will continue to work normally, without using this invention.
   For example, the computer device checks the value of a specific flag in the flag register, or a specific bit in the control register, or in the status register, and if this flag or bit is equal to one, then it interprets the high-order bits of the logical address (which is used in the current memory access command) as additional information, but if not, then it ignores them or uses them in the normal manner.
   As applied to the selection of address translation methods, this method may be used both as an auxiliary, for example, to enable or disable the special interpretation of high-order bits of a logical address, which in turn include the physical addressing of memory, but this method does not need to be reduced to a global switching mode of operation of the device, otherwise the essence of this invention would be lost, since the solution would be reduced to the trivial enabling or disabling of virtual memory addressing for the entire device.
g) The computer device analyzes a specific field or fields in the page table (or directory) element, and depending on the value of this field or fields, it decides whether to use the additional channel, or whether the device will continue to work normally, without using this invention.
   If this solution is used to select the address translation method, then the page table element (or page directory element) must be located on such a level in the page table hierarchy that the size of the region corresponding to it in the logical address space (high level address space) is greater than or equal to the size of the lower level address space (in particular space of physical addresses) that are supported by this computer device in the current mode of operation—otherwise it is impossible to ensure access to the entire lower level address space.
h) The computer device analyzes a specific field or fields in the segment descriptor, if this computer device supports the segment-addressing model, and depending on the value of this field or fields, it decides whether to use the additional channel, or whether the device will continue to work normally, without using this invention.)
i) The computer device analyzes a specific field or fields in the descriptor of the address space, context, virtual machine, or another object supported by the device, and then, depending on the value of this field or fields, it decides whether to use the additional channel, or whether the device will continue to work normally, without using this invention.

Device Capable of Simultaneously Using Several Address Translation Methods During its Operation

This section describes the implementation of a computer device that is characterized by the fact that:
(a) specific values of some bit(s) in a high level address (in particular in a logical, linear, virtual, or other address at which an executable operation (in particular command, instruction, order, operator, or function, both imperative ones, and ones that control data processing) or data processing operation operates, the component(s) of such address, or offset relative to some base address (including relative to an Instruction Pointer), regardless of whether such an address, or an address component or offset, is used directly, or as part of information to calculate another (effective) logical address, or they themselves constitute an effective address or were extracted from a calculated effective address), or the result of checking whether a high level address (logical address) belongs to one of the address (or offset) classes for which there is some function (function, scheme, circuit, or algorithm, including those implemented in microcode, in hardware, and/or in software, including using additional information and/or data structures) capable of determining whether a checked valued belongs to that class;
(b) and/or such analysis (as defined in the previous clause “a”) of the constituent components of such logical address, in particular analysis of the additional offset relative to the base address, which is specified in an executable or analyzable operation;
(c) and/or specific values of bits, flags, options, fields, or additional operands in the description of an executable operation or in its machine representation;
(d) and/or usage of special code of an executable operation, presence of specific prefixes or suffixes that precede or follow it (the operation itself or the operation's code), or specific values of the parameters (including operands, fields) of a prefix or suffix;
(e) and/or the presence of a specific static context (in particular a specific nesting of operations within one another) or a dynamic context (in particular a specific prehistory of executing operations or transferring control between them), or specific values of parameters (or state) of such a context;
(f) and/or specific value(s) of the field(s) or flag(s) of the control structures of this device, or specific values of the field(s) or flag(s) reflecting its state (if applied to address translation, such state of a flag(s) or fields(s) of a given device must occurs only in a specific context that can be established and closed using specific executable operation(s) that create or close such a local context, and that do not lead to switching the device's mode of operation);
(g) and/or specific values of the field or fields in the page table (or directory) element on such a level in the page table hierarchy that the size of the region corresponding to it in the logical address (high level address) space is greater than or equal to the size of the lower level address space (in particular physical addresses space) that are supported by this computer device in its current mode of operation;
(h) and/or specific values of the field or fields in the segment descriptor, if this computer device supports the segment addressing model;

(i) and/or specific values of the field or fields in the descriptor of the address space, context, virtual machine, or in the descriptor of another object supported by this device;

instruct this device to treat:
(a) the source or resultant (effective) address of a high level (logical) address or its component(s), including the offset(s), or part of the bits in such address, component, or offset;
(b) and/or the distance between such an address or its component (offset) and some base address;
(c) and/or the result of some transformation or some function (possibly using additional information and/or data structures) applied to the value of the source or resultant (effective) address, to its component(s), or offset(s), to certain bits of these values, or to the distance between such value and some base value;

as:
(a) the address or component of a lower-level address (in particular, as a physical address);
(b) or as an offset relative to some lower-level base address (in particular, as an offset relative to some physical address);
(c) either as an address, a component of an address, or a lower level offset, which requires additional transformation using a certain function;
(d) or as a new address, address component, or offset belonging to a certain class of high-level addresses (to be further converted to lower-level addresses using a certain function, if necessary).

The methods for implementing the checks corresponding to clauses (a . . . i) in the first part of the brief description of the invention above have already been considered in the section “Determining the Necessity of Using an Additional Channel”, however some features of the implementation of this device are discussed in more detail in this section.

The key feature that distinguishes the device that is the subject of this patent application from previously invented devices is its capability to use several (two or more) address translation methods, or to use different parameters of this translation during the execution or preliminary analysis of individual executable operations, for which such device uses additional useful information obtained using one or more methods described in this patent application.

Such a device does not need regular switching of its modes of operation (or regular reloading of system registers) to use several address translation methods or to use other values of the parameters of such translation.

By analyzing additional useful information (in particular, by analyzing information extracted from addresses used in this operation, or their components, from the current context, or extracted by other methods described in this patent application), the device implementing this invention determines exactly which address translation method (or which sequence of methods) should be used during the execution of each specific operation.

Additional useful information may also be used to control the translation process, for example, it may be used as additional parameters for an algorithm, method, functions, circuit, or scheme that performs such translation.

As applied to this section (and as a whole) it is once again noted that, as stated in the preamble to this patent application, the selection of an address translation method may also be interpreted as the selection of a method by which a computer device accesses memory or transfers control, or as the selection of a type (method of interpretation) of address to execute such operation.

It is also noted that a computer device may use additional useful information extracted using the methods described in this patent application not only directly, but also after some transformation, for example, using some function (function, scheme, circuit, or algorithm, including those implemented in microcode, in hardware, and/or in software, including using additional information and/or data structures), including in conjunction with other information obtained by other means.

Other devices, in which this invention is not implemented, use only a single address translation method for all general-purpose operations (which access memory or transfer control), that is changed only after switching the mode of operation of such device or after reloading some system registers. Alternatively, they may select another method, but without using the solutions described in this patent application, which we consider more effective.

The capability to dynamically, depending on the content of additional useful information, switch from one address type to another, or more generally, to use different address translation methods (different access and control transfer methods), helps to reduce competition for the Table Lookaside Buffer (TLB, or other similar structure), and when switching to physical memory addressing, it generally allows the circumvention of accessing the TLB (or other similar data structure), which dramatically lowers the level of competition for a given resource, which is the “bottleneck” for many modern devices.

In particular, the device described in this patent application, even without regular switching between its modes of operation, may use both linear addresses (described using page tables) in the same executable operations and physical addresses in other executable operations, or even in the same operations, but for addressing another memory area.

For example, a device may be in such a way that it can address the code and stack of the operating system with physical addresses, and at the same time address data that this code accesses with logical addresses that use page translation.

Alternatively, it may use several different address translation methods (address types, memory access and control transfer methods) simultaneously, in particular, may use different algorithms to translate different addresses without switching the mode of operation of this device and/or different parameters of such translation (for example, a different pointer to a root page table), depending on the content of additional useful information extracted from the address itself (or by other methods described in this patent application).

When additional useful information is obtained by a computer device using any method described in this patent application, it may analyze it and select one of the address translation methods supported by this device. Alternatively and equivalently (as described in the preamble of this patent application), it can access memory (or transfer control) by interpreting the address (or basic address information, which remains after extracting additional useful information from the address, as described in the preamble of this patent) using one of the methods supported by this device. In particular, by interpreting the address or basic address information as a physical address.

In the simplest case, the computer device analyzes a specific bit of a logical address (for example, its highest order bit) and if this bit, for example, is equal to one, then it interprets the remaining bits of the logical address as a physical address of the memory cell that this executable operation accesses (or as the address of the next operation to which control is transferred). If the highest order bit is equal to zero, then this computer device interprets the remaining bits of the logical address normally, for example, by translating them into a physical address using the (MMU).

In a similar way, the device can analyze, for example, two high order bits (the sign bit and subsequent bit) and switch to using this invention if their values differ.

In yet another possible implementation, the computer device analyzes a specific field or fields in the page table (or directory) element on such a level in the page table hierarchy that the size of the region corresponding to it in the logical address (high level address) space is greater than or equal to the size of the lower level address space (in particular physical addresses space) that are supported by this computer device in its current mode of operation, and depending on the value of this field or fields, the device selects which address translation method will be used (possibly in combination with other methods described in other clauses).

The subject of analysis may also be the value of a base address that is contained in the page table element (page descriptor, where the base address is one of the page descriptor fields). In particular, the device may analyze a specific bit or bits of such address or select another address translation method, or it may choose another address translation method if the value of such address falls within a specified range.

This way of selecting an address translation method is a hybrid between the normal page-based organization of virtual memory and other means to implement this invention. When it is used, one TLB element may be required (or an element of another similar cache memory designed to store page table elements), therefore we recommend selecting another method to implement this invention, in order to completely avoid using a TLB.

The key distinction of a computer device that implements this invention from previously invented devices is the capability to organize address translations in them in such a way that the specific range of logical addresses (high level addresses) may be transformed directly into an entire set of lower level addresses supported by the current mode of operation of such device.

In yet another possible implementation, the computer device analyzes a specific field or fields in the segment descriptor, if this computer device supports the segment addressing model, and depending on the value of this field or fields, the device selects which address translation method will be used (possibly in combination with other methods described in other clauses).

In particular, a specific bit in the segment descriptor may order a computer device to interpret a segment's base address as a physical address in memory that must be added to the logical address that is accessed by an executable operation—transforming it into an effective physical address without using a page mechanism.

The subject of analysis may also be the value of a base address contained in the segment descriptor (this address is also one of the descriptor's fields), or even the result of adding the logical address used in an executable operation to a base address taken from the segment descriptor. In particular, the device may analyze specific bit(s) of such address to select another address translation method, or it may choose another address translation method if the value of such address falls within a specified range.

In the more general case, the computer device that is the subject of this patent application may use any of the methods described in the section “Additional Channel for Exchanging Useful Information” to extract additional useful information and/or any of the methods described in the section “Determining the Necessity of Using an Additional Channel” to select a translation method, or to make a decision on the necessity of a special interpretation of an address or on the necessity of selecting another addressing method, or to determine the parameters of such translation (access, control transfer) as described in this patent application.

When the address translation method (addressing method) is selected, the computer device may pass the logical address to different blocks, each of which implements its own function to translate high-level addresses (logical addresses) into lower level addresses (physical addresses), possibly using additional data structures (for example, caches, such as TLB).

A person skilled in the art may, at her discretion, implement any suitable algorithm, circuit, scheme, functions, or method to analyze additional useful information; both in order to select, as a result of this analysis, an address translation method (memory access or control transfer method), and in order to extract additional parameters of such translation (parameters of memory access or control transfer method), if they are necessary. The specific implementation of this process as a whole is outside the scope of this patent application.

Nevertheless, different sections of this patent application describe several important special cases of the implementation of devices that use additional useful information to select an address translation method (access or control transfer method) and to control this process.

The implementation of this invention allows a substantial speed up in the operation of software, in particular, it allows system software to avoid all operations to access page table elements (or other similar data structures) when working with resident memory.

As a rule, system software is completely located in resident memory. Many system data structures are also stored in resident memory. Input/output device buffers, network protocol stack buffers (for example, TCP/IP stack), software RAID buffers, and many other data system structures are also frequently located in resident memory.

In addition, many application programs (such as database servers) know how to use buffers or big data structures located in resident memory.

In the majority of cases, when working with resident memory, the translation of logical addresses into physical addresses using a virtual memory page mechanism does not offer any advantages for developers. To the contrary, because modern processors operate with memory paging enabled, on most devices, operating systems must always use logical addresses, and therefore they must generate dummy page tables, which support emulated logical addressing for resident data structures.

If system software is able to directly access memory using physical addresses, while preserving the capability to access via logical addresses (to interact with a user program), then system programs will be able to do away with a large quantity of page table accesses.

When using this invention, the operation of accessing resident memory may be performed generally without accessing associative cache memory designed to accelerate address translation (such as TLB—Table Lookaside Buffer), which reduces competition for such cache memory between application and system software.

This also increases a processor's capability to execute operations in parallel—by avoiding the accessing of a critical shared resource (“bottleneck”), which is the TLB, and/or the part of the processor's circuits, and/or its microcode responsible for translating addresses.

By avoiding accessing the TLB and bypassing this “bottleneck”, system software experiences improved performance and reduces energy expenditures. It avoids a performance penalty due to the absence of page table elements in the TLB, as well as due to the need to write changed elements of the TLB back into page tables (when replacing the same elements of the TLB with others), and also increases the degree of parallelism when performing speculative executions, pipelining, and hardware threads support technologies (such as the hyper-threading technology in Intel processors).

Note also, that if the computer device does not support the direct use of physical addresses, then the operating system must insert dummy elements into page tables, which thereby ensures the mapping of resident memory into the logical address space. However, such elements compete with user elements for the TLB cache (or other similar caches), which is limited in size, and need to be read from memory themselves (which is a slow operation), generating them takes time and complicates the development of operating systems.

This invention makes this obsolete technology, which creates substantial overhead, unnecessary.

It should also be emphasized that the result of translation may not be the physical address of a memory cell—this may be another type of address, including one subject to further translation by another method selected by the developers of such device.

In addition, we emphasize that these solutions can be used not only for the conversion of high-level addresses into lower-level addresses, but also generally for arbitrary transformations of a logical address (or basic address information), including translating such an address into another format, recalculating its value, and so on.

Device that Analyzes Additional Useful Information to Change Interpretation of a Logical Address

This section describes a computer device that analyzes additional useful information it has extracted using one of the methods described in this patent application in order to change this device's interpretation of a logical address (or the basic address information that remains after extracting additional useful information from the logical address), and/or uses this additional useful information during the translation or transformation of such logical address (or basic address information), in particular to determine the type of such address (in particular, but not only, in order to choose another method to translate the logical address or basic address information into a lower level address, including, but not limited to, into a physical address).

In other words, this section describes a computer device, that changes its subsequent interpretation of a logical address (or basic address information it has extracted from a logical address) as a result of analyzing some additional information extracted by this device from such logical address or using other methods, described in this patent application.

Possible methods to implement such a device are discussed in detail in sections “Additional Channel for Exchanging Useful Information” and “Device Capable of Simultaneously Using Several Address Translation Methods During its Operation”, and may also be combined with use of the technologies described in the sections “Determining the Necessity of Using an Additional Channel”, “Simultaneous Access to All Address Spaces”, “Extended Offsets (Optional Extension)” and in other sections of this patent application (including the sections dedicated to parameterized prefixes).

A person skilled in the art can easily expand and complement these solutions.

We emphasize that these solutions can be used not only for the conversion of high-level addresses into lower-level addresses, but also generally for arbitrary transformations of a logical address (or basic address information), including translating such an address into another format, recalculating its value, and so on.

Simultaneous Access to All Address Spaces

This section primarily discusses the implementation of access to other address spaces using the identifiers of address spaces located in logical addresses. However, except for the method that is used to receive an address space identifier, the provisions of this section are also applicable to implementations where the address space identifier is transmitted by other methods, for example, using a prefix, suffix, or context, as was described in the section “Accessing Another Address Space by its Identifier.”

Placing an Address Space Identifier in a Logical Address

This section describes a computer device that is characterized by the fact that it uses logical addresses that contain address space (or context) identifiers, and therefore point not only to specific memory cells located within some address space (supported by this device in its current mode of operation), but also to these spaces themselves, where the bit length of these logical addresses is not greater than the bit length of a general purpose register on this device (or the nominal bit length of the device itself, if it does not use the register metaphor or an analog thereof); in this regard this computer device may:
(a) automatically extract an address space (or context) identifier from such logical address;
(b) and/or use such logical address in order to access data located at another address space (distinct from the current address space) or transfer control to a program code located in another address space, while not permitting, in this regard, unauthorized access to the data or code located in other address spaces by application programs.

This computer device extracts the address space (or context) identifier from the logical address using methods described in this patent application, for example, it reads it from high-order bits of the logical address, and then uses this identifier as a key or index to access the system table (or another data structure with analogous purpose) in which address space descriptors are stored.

If user programs are permitted to access other address spaces, the computer device must check whether the current program has the right to access code or data located at another address space. At the discretion of the person skilled in the art who implements this invention, some check may also be performed for system software.

This process is discussed in detail below, in the section “Checking Access Rights to Another Address Space.”

If access to another address space is permitted, or if this operation is performed by system software, which is permitted to access other spaces by this computer device's policy, then the device continues to execute the operation.

Having referred to the address space table, the computer device finds the descriptor of the necessary address space in it and reads from it the pointer to the root page table of this space (or pointer to the analogous data structure for another virtual memory architecture) and/or other parameters that are necessary to translate a high level address (for example, a linear or virtual address) included in the logical address (along with the address space identifier) into a lower level address (for example, into a physical address).

The computer device also extracts from the logical address basic address information that points to a specific memory cell within the address space. In the simplest case this may be low-order bits of the address, but more complicated methods may also be used, for example, those described in this patent application.

Next, the computer device translates the basic address information extracted from the logical address, using the root page table (or an alternative data structure) and/or other parameters read from the address space descriptor (it translates the logical address using these data instead of the values read from fixed system registers) when necessary.

Then the computer device, using the translated address, accesses memory to read or write data (or instructions). Thus, the computer device obtains access to data in another address space or transfers control there.

In this regard, the computer device may provide for cache memory, similar to a Table Lookaside Buffer, to save the most frequently used descriptors from the address space table (or the most important information extracted from such descriptors).

In some embodiments, for purposes of convenience or compliance with earlier groundwork, a special value of the address space identifier may be provided, for example, equal to zero, which is always interpreted as a reference to the current address space.

If the logical address contains such an identifier, then the computer device accesses memory or transfers control within the boundaries of the current address space and an additional access right check is not necessary (even for application programs).

This invention does not prohibit the use of some classes of logical addresses in a special way. For example, a specific value of the address space identifier or even a specific value of some bits in the logical address may be interpreted in a special way; in particular, it may instruct the computer device to handle low-order bits of such logical address as a physical address in memory.

A person skilled in the art may improve or change the steps of the process described above. The central ideas of this invention are extracting the address space identifier directly from the value of the logical address (and not from a separate register or separate machine word in memory), the use of this identifier to determine parameters for the address translation process, and controlling access rights while accessing with such address (that contains the address space identifier), if it is done on the initiative of the application program. In this regard, many details (outside of the main ideas described above) of the implementation of this process are standard practice and outside the scope of this patent application. Nevertheless, one of the possible methods of implementing this invention was described.

Thus, another level is added to the scheme of hierarchical address translation scheme.

This process is much like the normal address translation process using hierarchically organized page tables, to which the top level has been added in the form of address space table. Furthermore, several processors already implement similar translation using address space identifiers.

However, all known devices use address space identifiers located in separate registers, but do not extract them directly from the values of logical addresses that have normal bit length for the device. This substantially complicates programming for such devices and lowers their performance.

The program code for such devices (in which this invention is not implemented) cannot use normal pointers to access other address spaces, since normal pointers lack address space identifiers. The program must use special pointers represented by a pair of registers (or a similar pair of values in memory). Therefore, the code must be amended with additional commands to load, store, copy, or change additional registers with identifiers of the address spaces that accompany basic registers with pointers to memory cells within these spaces.

In this invention, the computer device automatically extracts the value of an address space identifier from a normal logical address, which, for example, may be located in a general-purpose register and used in normal memory access commands. In the simplest case, it reads the address space identifier from high-order bits of the address.

Therefore, a pointer that is suitable to access another address space remains compatible with normal pointers that are used by normal programs for that device. This preserves the same bit length and does not require an additional register. Furthermore, to load, store, copy, or change such pointers, it is not necessary to add special or additional machine commands to the code.

Also, the proposed solution is not an address translation using page table hierarchy. Among other reasons, this is because the opposite problem is solved.

An ordinary virtual memory address translation isolates the linear address within the current address space in order to prohibit accesses beyond its boundaries. This invention, on the contrary, provides the capability of accessing memory outside the boundaries of the current address space.

Although a similar implementation technology is used, this invention improves it substantially and for this reason solves the opposite problem. Here is a simple analogy: a nuclear power plant and a nuclear bomb use energy from the decay of an atomic nucleus, but for completely different purposes and with their own specific implementations.

The proposed method (scheme) will not only bring an address space identifier from another source (in comparison with existing technology that uses dedicated registers to store address space identifiers), and not only solves this problem (in comparison with ordinary virtual memory address translation), but also has a series of differences from the conventional process of hierarchical address translation, which should be taken into account when implementing it:
1) If the most obvious and effective implementation is selected—using high-order bits of the logical address as values of the address space (or context) identifier—then in order to be compatible with existing processors the null value of these high-order bits must be interpreted in a special way and signify the current address space, to the page tables of which the corresponding control register of this computer device points;
2) Application programs do not need to have access rights to use pointers with high-order bits different from zero (if they signify the current address space), from special values (discussed below), and/or from the value that contains high-order bits of their own pointer to the current operation (Instruction Pointer).
   Application programs should be prohibited from using other values (at a minimum, without additional authorization using memory protection keys), otherwise programs will be able to read or write data in each other's address space, violating the security of the system.
   In order to support this policy, before translating an address for an application program, the computer device should confirm that the high-order bits of the logical address this program is accessing match the high-order bits of its own Instruction Pointer, or contain zero, or contain special value(s) (discussed below).
   An application program may be permitted to access outside the boundaries of the current space only after checking the memory protection keys that it should transmit to the computer device, for example, using the additional channel described in this patent application.
   In this regard, the system software does not require such strict checking and therefore it can access data or code in any address space using normal pointers and general purpose operations, which allows it to avoid switching contexts and other overhead, and simplifies software development.
   If in this implementation all high-order bits of the logical address are occupied by the address space identifier, but the system software needs the additional channel to implement other solutions from this patent application, then it may use special offsets, and/or a special prefix or suffix (as described in this patent application).
3) It is possible to ultimately increase the performance of all system software, if a special interpretation is provided for one of the address space identifiers or for determined value(s) of several high-order bits of the logical address.
   For example, a unit value in some quantity of high-order bits of the address or a specific value of the address space identifier may instruct the device to interpret low-order bits of this logical address as a direct physical address in memory.
   Then, having found such address, the computer device will not only avoid accessing the address space table, but also will not even access the page tables.
   This may actually circumvent the entire MMU block, which is the ultimate improvement to reduce latency when accessing memory, and additionally, in this case no competition with other instructions arises for MMU access.
   Of course, this capability is designed for system software, and not for application programs—since it unlocks direct access to all physical memory.

Checking Access Rights to another Address Space

Application programs should not be able to obtain unauthorized access to the memory and code of other programs.

Therefore, if the operation to access another address space is conducted by the application program, and not by system software, then the computer device must check the right to access the address containing the address space identifier.

In some implementations the access rights check may also be provided for system software, but this is perhaps simpler than for application programs.

In the simplest implementation, the computer device first compares the extracted address space identifier with the current address space identifier. If they match, then this signifies access to the current address space. In this case, further access rights checks (except those already implemented in the device) are not necessary.

In particular, the current address space identifier may be saved in the control system register; alternatively, in another embodiment it may be extracted from the pointer to the current operation (from the Instruction Pointer, if application program code and not system code is executed).

Using the system register with the current address space identifier is preferable, since the Instruction Pointer may point to physical memory (when implementing a series of solutions that improve speed).

If the address space identifier that the program attempts to access does not match the identifier of the current address space, then in the event of access by an application program the computer device checks the memory protection keys, or performs another access rights check provided by the person skilled in the art who implements this invention on her device.

A similar (though perhaps much simpler) check may also be provided for system software.

An access rights check may also be provided both for access to the entire address space as a whole, as well as at the level of individual memory areas.

When performing a check at the level of individual memory areas, the computer device must confirm that the memory protection keys submitted by the program match (from the perspective of the access rights or authorization checking algorithms) the keys in the page table of another address space or in a separate special system data structure that is related to another address space (it is possible that part of the information for this check will be extracted from the structures of the current address space).

Since the process of checking access rights may be complex for application programs and require a greater quantity of cryptographic computations, it may be executed not only at the hardware level or in the computer device's microcode, but it may also be implemented partially or fully in the system software.

In particular, a computer device may transfer control to the system software using an interrupt (for example, in the event that it is necessary to authorize new keys). The results of the check may be stored in specialized cache memory to minimize access to the software.

The specific implementation of the described checking process is outside the scope of this patent application, as is the precise moment when it is executed, in particular up until reading the descriptor of another address space or after (if the content of the descriptor is used in the checking process).

If another address space is accessed from an application program, then to protect against “Meltdown” type attacks, it is recommended that computer device developers not speculatively execute such operation until the full and successful completion of the access rights check.

If this computer device's policy prohibits application programs from accessing other spaces, or if the privileges are insufficient, or if additional information is not provided for such a check, then the computer device signals an exception and does not execute the operation to access another address space.

Coding an Address Space Identifier Using Variable Length Codes

The solution described in the previous section may be refined to support large address spaces.

In particular, when using 5-level address translation in x86 family processors, there is a remainder of only 7 bits where developers could hypothetically place the address space or context identifier (PCID in the terminology of these processors), although they have not done this. It is obvious that 128 process identifiers, which is what could be placed in this 7 bits, are insufficient for modern operating systems.

However, in an actual system, 5-level address translation is needed only for super-large databases and unique applications for supercomputers, and for all other processes it merely results in large overhead.

Therefore a new solution is proposed, which is not yet implemented on any known device. In particular, it is proposed to use any variable-length codes that are preferred by the person skilled in the art who implements this invention for coding address space identifiers.

A computer device is described that is characterized by the fact that it uses logical addresses, the composition of which includes address space (or context) identifiers in such a way that these identifiers are encoded using any variable-length codes that have been approved by the developers of this device, which allows the use of different bit lengths for different address space identifiers in the current mode of operation of such device (without regularly switching modes of operation or reprogramming control registers to use different length identifiers).

In order to extract the address space identifier, the computer device first determines its length by checking specific bits of the logical address (the values of which uniquely define the identifier length).

Alternatively, the identifier length is determined from the value of the address using some function. When the identifier length is known, the computer device reads the logical address bits that correspond to it, or extracts the identifier using some function. The extraction of the identifier may be algorithmically combined with determining its length.

Alternatively, the computer device extracts the address space identifier from the logical address using some function that implements variable-length codes in such a way that it does not need to know in advance the length of encoded information in order to decode it (for example, prefix code algorithms, or a modification thereof, may be used for this purpose).

The extracted value of the address space identifier may be transformed in an arbitrary manner, selected by the person skilled in the art who implements this invention on her device.

If the length of one of the device's address space identifiers is less than the length of another identifier, then it may use the released bits or part of the code space to increase the bit length (information capacity) of the main part of the address information. For example, if the encoded identifier is short, then the released bits may be combined with low-order bits of the logical address containing it in order to place in them a linear (virtual) address with a greater bit length (that points to a specific memory cell within this space).

The computer device also extracts basic address information (for example, the linear [virtual] address that will be translated using page tables) from the logical address.

For example, when an address space identifier that uses variable length encoding is extracted from high-order bits of the logical address, the device already knows its bit length and can consider the remaining bits of the logical address as representing a linear (virtual) address. Alternatively, the basic address information may be extracted from the logical address using a more complex function that does not require knowledge of the identifier's length.

Then, this device acts similarly to the device described above in the section “Placing an Address Space Identifier in a Logical Address”—the only difference being in the methods of splitting the logical address into the address space identifier and the basic address information.

When using variable-length coding, different identifiers may be represented by different numbers of numerical digits. Therefore, it becomes possible to create several address spaces with short identifiers (for example, ones placed in high-order bits of the logical address), but with a long linear (virtual) address (for example, one placed in low-order bits of the logical address), as well as a large quantity of address spaces with long identifiers, but with a shorter linear address of the memory cell.

In this regard, it is recommended to a person skilled in the art to use any codes with a unique prefix and place the address space identifier in high-order bits of the logical address. Then, by analyzing only some of the high-order bits of the address, the computer device can effectively distinguish short and long identifiers from one another—thanks to the fact that their prefixes, being located in high-order bits, will be numerically different values.

In this implementation, the computer device checks several high-order bits of the address and, for example, if they are located within some range, then it considers this logical address to contain a short address space identifier, but its low-order bits contain a long linear address of a memory cell within this space. If the high-order bits of the identifier do not fall within the defined ranged, then the device believes that a long identifier and a narrower linear address are used in this case.

A person skilled in the art can implement a set of both trivial and very complex functions to encode and decode address space identifiers, can introduce more than two classes with identifiers of different length, can use code prefixes, can come up with a set of effective functions to check the prefix or rapidly determine an identifiers, its class, length, etc.—this is standard practice for a qualified software or hardware developer. The specific variant of implementing variable-length codes is outside the scope of this patent application.

What is patented is the idea of a device that uses variable-length codes to encode address space identifiers located within logical addresses.

To clarify, in this case the topic of discussion is not simply the capability to select the length of identifier coding using some control register (which does not contradict this invention and can be used as a part of it), but the capability to simultaneously use at least two sets of values of address space identifiers that have different length representations within the logical address on the same device in its current mode of operation (that is, the capability to use identifiers of different length, without regularly switching modes of operation or reprogramming control registers to use a different length of identifier).

Simultaneous Use of Several Virtual Memory Address Translation Algorithms

This patent application also describes a computer device that is characterized by the fact that it can simultaneously use different algorithms and parameters to translate addresses (in particular, a different length of the basic address information, for example, of a linear address, or a different maximum number of levels in the hierarchy of page tables and/or different methods for organizing page tables or similar data structures) for different address spaces in the current mode of operation of a given device (without regularly switching modes of operation or reprogramming control registers by using different algorithms or parameters to translate addresses for different spaces).

In this regard, this device can identify the algorithm and parameters of address translation for each of the spaces by two different methods—by analyzing the address space's (context's) identifier, and by reading some control values from the descriptor of such address space, by which the computer device understands just how the algorithm and/or parameters of address translation need to be used to address a given address space (to access a memory cell in a given address space).

This invention, in particular, helps improve performance when working with processes that use little memory, allowing some of them to use 3rd, 2nd, and even 1st level virtual memory address translation of addresses, while for other processes a 4th or 5th level virtual memory address translation scheme may be used.

Reducing the number of levels of address translation reduces the number of memory accesses in the event there is no page descriptor in the TLB and reduces the load on the TLB as a whole, which has a positive effect on performance and saves energy.

Transferring Control to Other Address Spaces

This patent application describes a device that is characterized by the fact that it implements the transfer of control to code located in another address space using a logical address, the bit length of which is not greater than the bit length of a general purpose register on this device (or the nominal bit length of the device itself, if it does not use the register metaphor or an analog thereof); this includes the possibility of returning back, implemented due to the presence of the caller's address space (or context) identifier in the logical address of a return point.

This computer device uses a logical address that contains the called address space's (or context's) identifier. Thus, the topic of discussion is a device that solves this problem without using a separate additional register or another separate component of the address in order to store the address space identifier. This means using ordinary logical addresses for this device (which, for example, could be loaded into a general-purpose register).

At a low level, the process of transferring control to another address space has already been described in the section “Placing an Address Space Identifier in a Logical Address,” the discussion here concerns only additional features that distinguish the transfer of control from reading or writing data.

The topic here is only the implementation of the transfer of control to another address space in the system software when, after transferring control, there are no changes to the privileges level. Alternatively, there is a unilateral transfer of control from the system code to the user code (without the possibility of returning back using a normal control return operation).

In such cases, no problems arise related to the security of call points and control return points, nor any question about the current stack (if the stack is provided on this device, then it remains the system one, or may be replaced by a user one when switching the context).

If the pointer to the current executable operation (Instruction Pointer) contains the identifier for the current address space (or context), then the computer device knows to which address space it needs to return control. In this case, it is possible to call a function in another address space, and not to merely unilaterally transfer control there (for example, to switch contexts).

A person skilled in the art can implement the automatic storing of the current address space's identifier to the address of the return point in the event that the value of the Instruction Pointer currently implicitly points to the current address space (for example, if the address space identifier in the Instruction Pointer is equal to zero).

On the other hand, the best policy will be to prohibit such values of the Instruction Pointer from occurring, always entering the current address space's identifier into it.

Special values of the Instruction Pointer are an exception. For example, when implementing some embodiments of this invention, the Instruction Pointer may contain a logical address that points to physical memory. In this case, the current address space's identifier may not automatically be written into the Instruction Pointer.

If the current value of Instruction Pointer points to physical memory, then the return point address will also be an address in physical memory.

Transferring control to another address space may automatically lead to switching contexts. However, it also might not—at the discretion of the person skilled in the art who implements this invention on her device.

Example of Improved Architecture for x86 Family Processors

This section gives an example of implementing a series of very simple solution for some 64-bit device, similar to an x86 family processor.

Assume that:
1) If a high-order bit of the logical address contains a zero, then this address relates to the current address space—for compatibility with existing applications;
2) If four high-order bits of the logical address contain the binary value “1000,” then the next 3 bits contain an identifier of the 57-bit address space, where 8 such spaces are possible (the low-order bits of their identifiers contain values from 0 to 7);
3) If the four high-order bits contain a value different from “1000,” then the address space identifier is represented by a 15-bit number (not counting the leading one in the high-order bit) ranging from 4096 to 32767, and it corresponds to a 48-bit address space;
4) Let all identifiers that begin with 10 leading ones signify a 48-bit physical address, then only 64 values are lost that would be permissible for long address space identifiers (with their upper bound being 32703 instead of 32767), but this makes available physical memory addressing that works without any computation costs or latency associated with TLB access or virtual memory address translation in the MMU.

In this case, there remain:
1) 6 free bits for additional information when working with the current address space: if the high-order bit of the address is equal to zero, then the next 6 bits are free for additional information described in this patent application;
2) 6 free bits for additional information when addressing 48-bit physical memory: if 10 high-order bits of the address contain ones, then there is a 48-bit physical address, but the bits from 48 to 53 in the 64-bit register are free to use as additional information. In particular, they can contain flags to control caching and other attributes that otherwise are unavailable without page tables, or can contain the identifier of the memory type for which missing attributes are read from registers that are similar to PAT or MTRR.

In this system, there are in total 8+(32767+1−4096)−64=28616 unique address space identifiers.

If sequential numbering is necessary then, for example, 57-bit address spaces may be associated with numbers from 1 to 8, while 48-bit address spaces may be associated with numbers from 9 to 28,616.

The eight “huge” spaces use the slower 5th level address translation, the remainder use fast 4th level translation. It is also possible to provide for switching to a 3rd level address translation scheme, increasing the speed even further. For example, for 32-bit applications, 3rd level address translation is always sufficient with a “9+9+9+12” address's partitioning scheme.

A limitation on the number of levels in virtual memory address translation may be implemented by reading translation parameters from the address space descriptor.

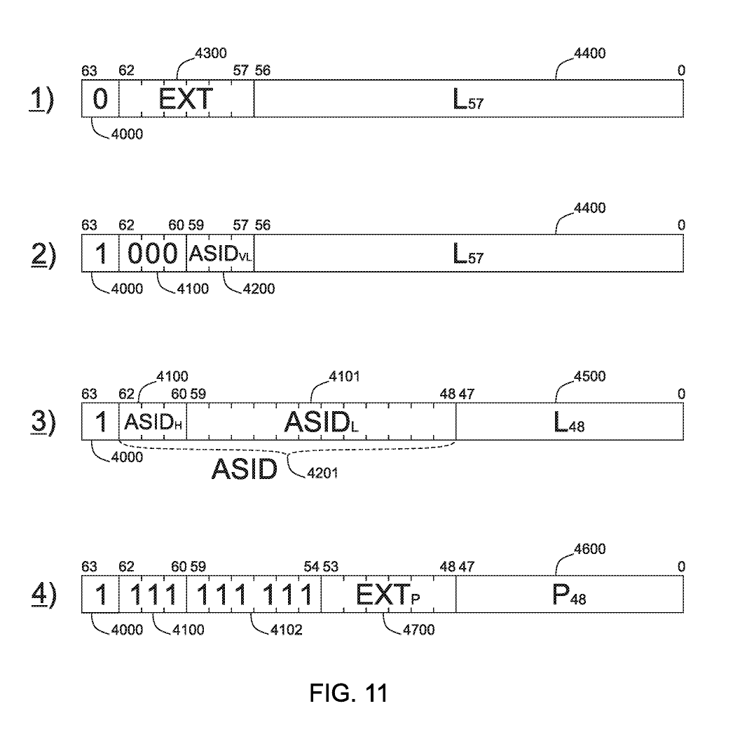

This new, flexible addressing method (scheme) is illustrated in detail in “FIG. 11.”

Using this Technology for Virtual Machines

All the solutions described in the section (“Simultaneous Access to All Address Spaces”) as solution for simultaneously addressing a set of address spaces may be adapted by a person skilled in the art to support simultaneous access to address spaces of different virtual machines.

Firstly, the described solutions are not bound by whether the address space belongs to a normal process (in terms of classical operating systems) or to a virtual machine. If this is necessary, then the address space descriptor may be supplemented with the fields necessary to support address spaces that belong to virtual machines and to support specific virtual memory address translations within their spaces. Thus, several address spaces may be the address spaces of virtual machines, while others are used as address spaces of traditional processes.

Secondly, nothing is changed if throughout the text of the section “Simultaneous Access to All Address Spaces” the term “address space identifier” is replaced with the term “virtual machine identifier” and the above-described solutions are considered to be solutions to access virtual machine memory.

Thirdly, using identifiers of complex structures, especially using variable length identifiers (including as described in this patent application), it is possible to combine virtual machine spaces with traditional process spaces.

Automatic Modification of Program Code

Device that Automatically Modifies the Code it Executes

This section covers the implementation of a computer device, that is characterized by the fact that during preliminary analysis of the executable operation (in particular command, instruction, order, operator, or function, both imperative ones, and ones that control data processing), during or after its execution, it may independently (acting according to its algorithm, rules, and/or internal program) change the memory space that contains the machine representation of this operation (in particular, change its prefix, operation code, suffix, operands, including immediate values, address, or offsets, register numbers, or any other parts of the operation's machine representation), in order to improve the program or data processing (in particular to improve the repeat execution of this fragment of the program in the future).

This capability may be implemented in a von Neumann architecture computer device because for such device a program is simultaneously data located in its addressed memory.

Accordingly, if this is beneficial from the point of view of any optimization (it is not important whether it is directed at improving performance, saving energy, or pursuing other goals), then a computer device may change the code of its executable programs using the same memory access methods that it provides to its own programs to change data during their operation.

In particular, a classical processor has an Instruction Pointer register that points to the current executable operation, and this operation itself is represented by a set of bytes, machine words, or other elementary memory cells.

If the computer device, during preliminary analysis of some executable operation, during speculative or actual execution of that operation, or later, when this operation has already been executed, determines using some algorithm implemented on it (including algorithms that collect statistics and/or use heuristic rules) that it is beneficial for some improvement:
(a) to replace this operation with another operation (or sequence of operations);
(b) to insert into the machine representation of this operation useful additional or missing information;
(c) to change its parts or operands (any parts of its machine representation);
(d) to combine this operation with a previous or subsequent operation;

and if this change does not increase the length of the code or create other contradictions (including from the perspective of the meaning of executable operations), then the computer device may execute one or more operations to write into memory (including cache memory), using which it replaces the machine representation of this operation with a new representation.

If this device will in the future repeat the execution of the same part of the program where it performed the replacement described above (or if it will execute its changed part of the instructions that control data processing in a data processing device), then it reads from memory the already changed representation of the operation and achieves the goals of its improvement (if this improvement was successful).

The changes may be made not only prior to or during the execution of an operation, and not only immediately after execution, but also some time, if this computer device remembered the address of the executable operation that can be optimized.

Deferring changes allows the device to collect statistics, on the basis of which it can decide on the advisability of a given change. In particular, a computer device can evaluate whether a proposed improvement would be effective from the point of view of the next use of this operation.

When using this technology to change executable operations together with the page organization of memory, depending on the particularities of a given computer device and the organization of its memory, it can either mark memory pages with changed operations as having been changed, or not mark them as changed, if this does not conflict with the architecture of the given device.

In particular, if the changes the device makes do not cross page boundaries (for example, if the device changes only one byte in the machine representation of the operation or if all operation on this device are aligned with boundaries that do not cross page boundaries, or if this device rejects this optimization in the event that the operation crosses page boundaries), then the computer device may lose the introduced changes without consequences (in the event that the changed content of the page is lost due to paging or swapping).

The fact is that a repeat execution of the code on such a page will lead to a repeat of the changes being made, and in the worst case, the losses will only be a reduction in the optimality of the program's execution, but not a change in its result.

Therefore, in such cases the person skilled in the art who implemented this invention on her device may select an implementation that does not mark pages as changed (or leave this choice to the programmers).

By precisely which method the computer device implements the making of changes (how precisely it writes into memory), which executable operations it optimized, by which method and with what purpose it can optimize them by making changes, how these executable operations are coded and how their changes are coded—these are all determined by the person skilled in the art who implements this invention on her device.

The changes, in particular, may be implemented using operations to write to memory in microprograms of a given computer device, if the implementation of such an algorithm in the form of hardware circuitry is difficult (for example, if the device performs a complicated analysis to make a decision on the advisability and possibility of making changes). If the changes are made late (after the operations have been executed), then they will not slow down the performance of the program, but help during a repeat execution of the changed code.

When implementing this technology, a person skilled in the art must bear in mind that operations may be saved in the code's cache memory, and must be changed there in the event of modification. On the other hand, since the changes are equivalent to the source operation, then in some cases a person skilled in the art may also opt not to make changes in the code's cache memory (if the change does not cross the boundary of the cache line, for example, if it is reduced to one byte, or if the code is aligned with boundaries that do not cross the lines). For some improvements, there is a high probability that the modification is not relevant when the operation has not succeeded in tossing the code's cache memory (but the modification will play its role in the future).

The objective of this patent application is to describe the operating mechanism itself of a computer device that changes executable or already executed operations while it is running (by writing changes or changed operations into memory). In this regard, it is left to a person skilled in the art to select specific implementations of this improvement method.

Nevertheless, in the section “Improving Branch Prediction”, an important special case is described (an important class of such improvements) that is closely related to other aspects of the invention described in this patent application.

Distinction from Existing Devices

Practically all modern processors support programs that can modify their own code. However, in distinction from other computer devices, the device that is the subject of this invention independently changes the operations that comprise its executable program. The program is changed by the device itself during its execution, and not because there is a specially implemented algorithm within the program that changes its code as envisioned by its creator.

Distinct from devices configured to replace microcode, the device that is the subject of this patent application modifies the user's program, but not its own internal program (which controls precisely how it executes the user's program). In this regard, the modified program is not prepared by developers in advance, but created from a source program automatically, with some goal to improve its performance.

If a device were to modify its own microcode independently during its execution, in order to automatically optimize the repeat execution of its microcode, beyond simply being able to load new microcode that was previously prepared by a person, then it would also be the subject of this patent application.

Distinct from improving a program by a compiler, linker, or loaded, the device that is the subject of this patent application modifies the program it executes dynamically during its execution, and not beforehand, wherein this modification is performed by the device itself, and not by system software.

Distinct from generating a program on the fly, which is done by just-in-time (JIT) compilers and virtual machine interpreters, this device optimizes the program it executes by replacing individual operations with other operations that are equivalent to them at the same level of abstraction, in the same format (coding rules), in the same language, and placed in the same location in memory. JIT compilers and virtual machine interpreters translate the program into another format, change the level of abstraction, language (command system), and/or reposition operations in memory.

For example, when they translate virtual machine code into real machine code, they simultaneously change the level of abstraction (they transform a fictional stack machine program into a program for a register processor with direct memory addressing), the language (for example, byte-code Java commands are transformed into x86 commands), and the format (each command system uses its own rules to encode them), and repositions the new operations in memory. Whereas, the device described in this patent application performs replacement at the same location, at the same level of abstraction, without changing the language or format (instruction encoding rules).

Improving Branch Prediction

A computer device that supports the transmission of additional information in a logical address may independently modify the logical address or offset in the machine representation of the control transfer operation or in its explicit or implicit operand's representation in memory or in the stack (in particular, it can modify the address or offset in the conditional control transfer operations, but not only that) during its preliminary analysis or execution, or after executing this operation, in this way, so that future changes help the branch prediction circuit or algorithm make the correct decision.

Alternatively, in another embodiment, the computer device can make similar changes to any other part of the machine representation of the control transfer operation, if this part has space provided for information that affects the operation of the branch prediction circuit or algorithm.

In particular, after executing the transfer operation, the computer device can automatically change the program code in such a way that, for example, its next execution is oriented towards the actual direction of the conditional jump that was identified by the device during the first iteration. Alternatively, it could be determined by jump statistics accumulated over several previous iterations.

In order to accumulate statistics, the computer device, in particular, can implement a sequential change of values in a field with information that affects branch prediction in the machine representation of the operation, including by coding in this field information on the probability of a jump with saturation. Alternatively, it can accumulate statistics in internal data structures while the operation is in the branch prediction buffer (in the BTB or an analog thereof), or combine both approaches.

Such changes may be made always, or only in the event that the actual direction of the jump (or target of the control transfer) did not match the prediction that was made by the branch prediction circuit or algorithm. Alternatively, such changes may be made only in the event that the performance loss due to inaccurate prediction is estimated to be high by the computer device (heuristically and/or statistically).

The change may be made at any stage: when analyzing the executable operation, when executing it, when the control transfer operation's target is clearly defined (during speculative execution), or even after execution, including when displacing information on a given jump from the branch prediction buffer, and also including on the basis of analyzing statistics accumulated by the computer device.

When to make the changes is decided by a person skilled in the art implementing this invention on her device.

In other words, this patent application describes a computer device that optimizes its program in such a way as to reduce branch prediction errors by making changes to the program code, in particular to bits of additional information that may be provided in offsets or in logical addresses that are featured in executable operations that transfer control, or in any other parts of the machine representation of control transfer operations, or even in the representation of its operand in memory or in the stack, if a place for the relevant information is provided there.

In this regard, specific means for coding information that affects the branch prediction algorithm or circuit (exactly which bits in the offset or logical address, in the prefix, suffix, operation code, in its operands or other parts of its machine representation contain this information and how it is represented in these bits or other codes) are determined by the person skilled in the art who implements this invention on her device.

This improvement may be used also for ordinary control transfer operations that do not use additional information as described in this patent application, but that use any other method to explicitly point to the preferred branch or target of the jump in the encoded representation of the control transfer operation or its operands.

For classical processors, this is possible in the event that the insertion of information that affects the branch prediction algorithm does not require increasing the length of the encoded control transfer operation.

A computer device may make such a change both after the first execution of an operation, as well as after some quantity of executions, which includes sequentially making new changes in different iterations. Alternatively, it may make changes when displacing information about a given operation from the memory of the branch prediction algorithm, for example, from the BTB or another similar data structure.

In the majority of implementations, it will be useful to make such changes only in the event that standard branch prediction circuits or algorithms failed to work properly, and possibly taking into account other statistics collected by the computer device to help it evaluate the losses caused by incorrect predictions.

In order to avoid intensive writing into memory, it is possible to make a modification only in the case when the preferred branch is not specified in conditional control transfer operation, or only in the case when this operator is explicitly marked as requiring the improvement (using some mark in the bits of additional information or otherwise).

The section “Device that Automatically Modifies the Code it Executes” describes conditions under which the device may not mark the pages it changes in memory as modified.

The improvements described above may also be used for indirect control transfer operations.

For example, the computer device itself may write into an offset that is an operand of an indirect control transfer operation (or into any other corresponding part of the machine representation of such operation, in another embodiment of this invention) a “hint” that codes the number of the branch by which the control transfer was de facto performed—in order to optimize subsequent calls of this code.

Extended Offsets (Optional Extension)

This section describes a computer device that reserves part of the possible values of an offset field or part of the possible values of an operand (including, but not limited to, part of the possible value of an immediate operand) of the executable operation (in particular command, instruction, order, operator, or function, both imperative ones, and ones that control data processing) in order to transmit additional useful information to such computer device using these reserved values.

In the section below, implementation methods (solutions) for such a device are discussed in detail. A person skilled in the art can easily expand and complement these solutions.

One of the Tasks Leading to This Device

When implementing this invention, it is desirable to immediately use all its strong sides and achieve ultimate performance on modern 64-bit processors.

This part of the patent application describes how to achieve maximum speed despite the limited bit length of the offset field on popular processors.

In this regard, this patent application does not recommend deeply changing the architecture of processors so as to lose compatibility with application programs or experience large interferences in compilers (at least the first time), or any interferences in application programs, for that matter.

First, note that even if nothing is changed in the processor and compilers besides the accurate addition to them of new solutions from this patent application, then almost all the possibilities for speeding up programs are still obtained.

However, by adding only a single operation, prefix, or suffix for manipulating addresses (described below, in the sections “Operation to Add Useful Information,” and “Prefix or Suffix for Modifying Additional Information”) complete access is obtained to all capabilities, and almost for free (in terms of time).

But what if you want to reach the absolute maximum speed?

Connection between Offsets and Additional Information

In the most attractive embodiment of this invention from the perspective of practice, the additional channel is implemented using logical addresses. Therefore, it is necessary to know how to manipulate the high-order bits of the address.

If nothing generally changes in the processors and compilers, then in order to use the new capabilities it is necessary to add to the program code commands to load 64-bit constants that occupy many bytes in machine code, as well as arithmetical and logical commands, on which the processor spends time executing. These costs will be made up, but it would be better if they did not have to be paid at all.

One may also add a trivial operation to manipulate high-order bits of the address, which a modern processor performs in a single cycle, because it only uses ALU. However, it is desirable to eliminate even this cycle—if the additional information is constant and known in advance.

Long constants or additional commands do not negate the advantages of this invention, but they will not allow one to reach the maximum speed and flexibility that are theoretically possible.

It would be desirable to have the opportunity to change additional information when accessing memory in each separate operation using the direct offset operand, which is provided by practically all processors, with no time costs.

Therefore, a description is given below of solutions that have a probability tending to zero of being incompatible with existing application, while at the same time they unlock the possibility of manipulating high-order bits of the address using offsets of a small bit length.

Current State of the Art for 64-Bit Processors

Almost all processors support addressing by summing the effective address with a short direct operand that is called “offset”. Actual methods may be more complicated, but at the last step it boils down to this.

In particular, popular x86 family processors support 32-bit offsets, which after sign extension are added to the 64-bit value of the effective address.

Obviously, using normal 32-bit offsets it is impossible to effectively change the high-order bits of 64-bit addresses.

On the other hand, in actual programs designed by people, all 32 bits of the offset are never used (ignore for now the individual command to load the address, which compilers often use for arithmetic). In order to obtain a very large value of the offset in the code, the program should access an array element with a very large constant index value. Alternatively, a very large constant may be added to the index.

The direct addressing of array elements with very large constant indices are hardly used by anyone anywhere in application software, especially in 64-bit programs.

Note that a 32-bit offset does not allow a 64-bit program to address all memory or even a pragmatically significant (for modern applications) part of memory.

Therefore, if the permissible range of offsets is trimmed slightly, in particular at the boundaries of permissible values, then not a single application program will notice any changes.

Preferred Solution for Processors with Long Bit Length

This patent application proposes a solution that narrows down the range of offsets to a very small amount, and in this way opens up access to high-order bits of a long, for example, 64-bit address.

In particular, when using 32-bit offsets, as in x86 family processors, this solution limits their range by less than 1% (using the recommended parameters).

As can be seen, this solution will not conflict with a single actual application. This solution is described in detail below.

Divide the value of the offset (reading it in binary) into three parts—the highest-order bit is the sign bit, a previously determined quantity of bits in the upper part of the offset, so-called “verification” bits, and all the remaining, low-order bits of the offset.

If at least one of the verification bits is equal to the sign bit, then the computer device behaves in the normal manner. It performs a sign extension of the offset up to the bit length of the effective address and adds it to the effective address.

In this way, if, for example, this device uses 32-bit offsets and 7 verification bits, then for any offsets that do not begin with “10000000” or “01111111” in the high-order bits, it will work as before. This means that all offsets that are less than (2 GB minus 16 MB) or that are greater than or equal to (−2 GB plus 16 MB) will work precisely as before. Their range has been limited by less than 1%.

If not all verification bits (taken individually) match the sign bit of the offset, then the computer device believes that it is working with a so-called extended offset.

In this case it separates low-order bits (which follow the verification bits in the binary representation of its value) of the original offset into two parts—the higher part (signified by an “H”) and the lower part (signified by an “L”).

Then the computer device performs a sign extension of the lower part “L” up to the bit length of the effective address, using in this case the value of the sign bit extracted from the source offset (and not from a high-order bit of “L”) and adds the obtained value to the effective address—just like a normal offset.

Thus, if, for example, this device uses 32-bit offsets, 7 verification bits, and 7 bits for the high order part of the extended offset, then it has 17 bits leftover for the lower part of the extended offset. As a result, taking into consideration the sign bit in extended offset mode, it possible to, as before, work with any offsets in the range from −131072 to +131071 as effectively as with normal offsets.

This range is more than sufficient for the vast majority of algorithms (when it is insufficient—the compiler can return to normal offsets).

Lastly, at the final stage, the computer device adds the value of the higher part of the extended offset “H” to the highest order bits of the calculated effective address.

Note that if the sum is an ordinary associative arithmetical operation, then this step may be executed even prior to the previous step without affecting the result. Alternatively, it is possible to add the higher part “H” to the high-order bits of the offset after the sign extension, and then to add their sum to the address.

Thus, when the effective address has already been calculated, the programmer or compiler are then able to include in its high-order bits additional information that they have previously prepared and placed in the higher part of the extended offset (designated as “H”).

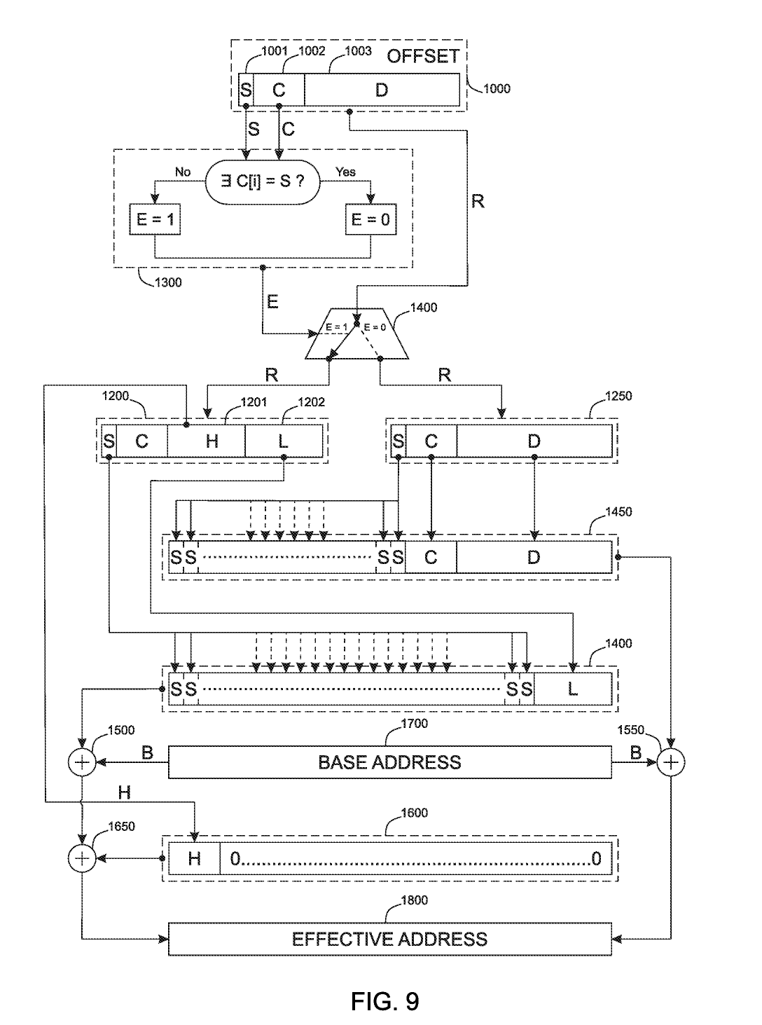

This algorithm is illustrated in detail in “FIG. 9” (see the description of drawings below).

In another possible embodiment, the computer device may not arithmetically add the higher part of the extended offset “H” and the high-order bits of the effective address, but impose the bits of the higher part on the high-order bits of the address using the “exclusive or” (XOR) operation.

Alternatively, the device may separate the higher part of the extended offset into two separate masks, one of which will be imposed on the high-or bits of the effective address using a logical “and,” and the second will be imposed using the “exclusive or” operation. In this case, the programmer can save, reset, set to one, and invert any bits in the higher part of the computed effective address at their discretion. However, in this implementation it is necessary to double the number of bits in the upper part of the extended offset.

In another possible embodiment, the computer device may simply replace the high-order bits of the effective address with bits taken from the higher part of the extended offset.

In yet another interesting embodiment, the computer device may immediately and directly use the extracted bits of the higher part “H” as additional information—not connecting it with the effective address.

It may also be agreed that if the highest bit of “H” is equal to zero, then the remaining bits of “H” are imposed, but if it is equal to one, then they are directly used as additional information, without imposing them on the effective address (or vice versa, as decided by a person skilled in the art).

The seven bits for the higher part of the extended offset in the example given above simply match the seven reserved bits in the logical address on popular x86 family processors. However, a person skilled in the art who implements this invention can select any other quantity of verification bits and any quantity of bits for the higher part of the extended offset.

It may also change the rules of transforming extended offset bits, may change the rules for calculating the effective address taking into account these bits, may swap the places of the higher and lower parts of the extended address, may extract these logical parts from the original offset using arbitrary functions, and may impose the “H” bits on bits other than the highest bits of the effective address.

This method (scheme) can also be trivially transformed for use with offsets that lack a sign—one need only assume that the hypothetical sign bit is equal to zero and not perform the sign extension before adding the offset to the effective address.

If the higher part “H” is arithmetically added to the highest bits of the effective address, then when using the binary two's complement representation it is not important whether it is considered to be the signed value itself. If it will be added to bits other than the highest bits, then it may be considered to be the signed value itself, or it may be considered to be unsigned, within the discretion of a person skilled in the art.

She may use another solution (including one described in this patent application) to detect the non-standard use of an offset, and then arbitrarily translate this offset—this does not violate the claims, nor the spirit of this patent application.

To ensure absolutely complete compliance, this mode of interpreting offsets may be disabled through some extended flag of the processor.

All the solutions described above are appropriate for any executable operations where there are offsets or arbitrary immediate values, including control transfer operations.

Thanks to the proposed technology, programs that require intensive use of the additional channel for exchanging useful information, especially those that frequently change this information, are able to do this with no time loss—if the additional information itself (or changes to it) are known in advance and may be placed in the offset.

To do this, it is sufficient to include in the extended offset additional information bits (or bits that code changes in it).

In this regard, it is important to note that these applications do not lose all the advantages of normal offset use when addressing memory.

Extended Offsets with Variable Length or Explicit Positioning

The method (scheme) for extended offsets may be improved by adding coding of “H” and “L” using arbitrary variable-length codes that are selected by the person skilled in the art who implements this invention on her device.

The structure of part “H” may be changed in such a way as to implement the capability to position it within the offset—in order to impose this information not only on the highest bits of the effective address.

Extended Offsets for Indirect Access to Additional Useful Information

An extended offset might not code additional useful information itself, but, for example, it might contain the number(s) (or index/indices) of register(s) that contain such useful information. That is, an extended offset may provide indirect access to it, as discussed in the section “Indirect Access to Other Additional Information”.

In this case, the restriction on bit length of such additional information is removed, and furthermore, such information may be a variable as well as a constant. When using this solution, its bit length is limited only by the bit length of the register or registers in which it is located.

If this mechanism is used to indicate that additional useful information (at the next level) is located in memory, then in general, with proper implementation, practically all limitations on its length are removed.

Extended Offsets and Address Loading Commands

It is recommended not to distribute the proposed method (scheme) on a standard address calculation command (such as the LEA command in x86 family processors), since similar commands are often used by compilers to optimize arithmetical calculations with immediate values and interference with them might substantially disable existing programs' code and destroy compatibility.

Nevertheless, additional variants of an address calculation executable operation may be implemented that allow the use of extended offsets.

Other Applications of the Method (Scheme) Proposed for Extended Offsets

The algorithm for extended offsets may be used even if other capabilities described in this patent application have not been implemented on the computer device. For example, if it is necessary to obtain access to the high-order bits of address to implement various new methods of addressing and controlling memory, or to implement other extensions that may be interested in high-order bits of long numbers or addresses.

The method (scheme) described above, which was initially proposed to encode offsets, may be used (both directly, and with minor modifications) to encode other immediate values (with or without a sign) in any executable operations wherein it would be desirable to obtain access to high-order bits of the numbers at the price of a moderate decrease in the acceptable range of immediate values.

Alternatively, it could be used in order to transmit an additional (especially optional) immediate value as an additional operand.

In particular, this method (scheme), being part of this invention, can be used with multiplication or division commands, as well as with any other operations that a person skilled in the art selects when implementing it on her device.

This same method (scheme) of encoding numbers and variations thereof may also be used for values that are not constant immediate values, that is, for values that are calculated during the operation of the device.

However, it is likely that during its introduction for operations on already existing devices that it will be reasonable to introduce separate operation codes, prefixes, suffixes, or other signs that would help to distinguish commands with the new encoding of immediate values or calculated operands from similar existing commands with an old coding method—in order to preserve compatibility with earlier developments.

Solutions for 32-Bit Processors

On the one hand, 32-bit processors are not affected by the above-described problem of short offsets if they have 32-bit offsets. However, they have their own, still large, issue—their small bit length does not allow data to be effectively transmitted through a logical address.

Even utilizing 3 bits in the logical address for additional information would narrow the effective address space to 512 megabytes of memory, which for many modern applications on general-purpose computers is unacceptable.

Therefore, if the topic is not specialized or embedded applications and computers, then it is not possible to implement by a general method an additional channel using logical addresses on a general-purpose 32-bit system.

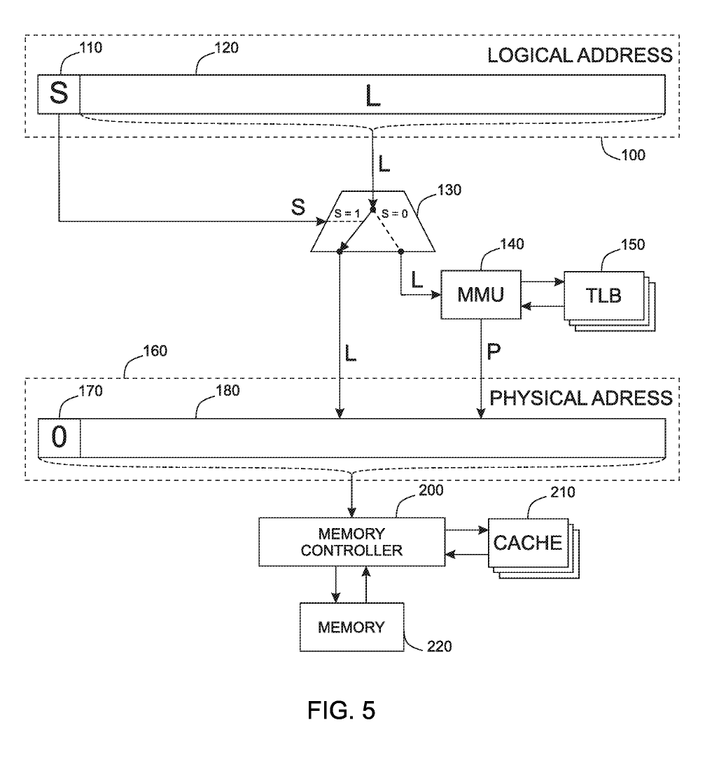

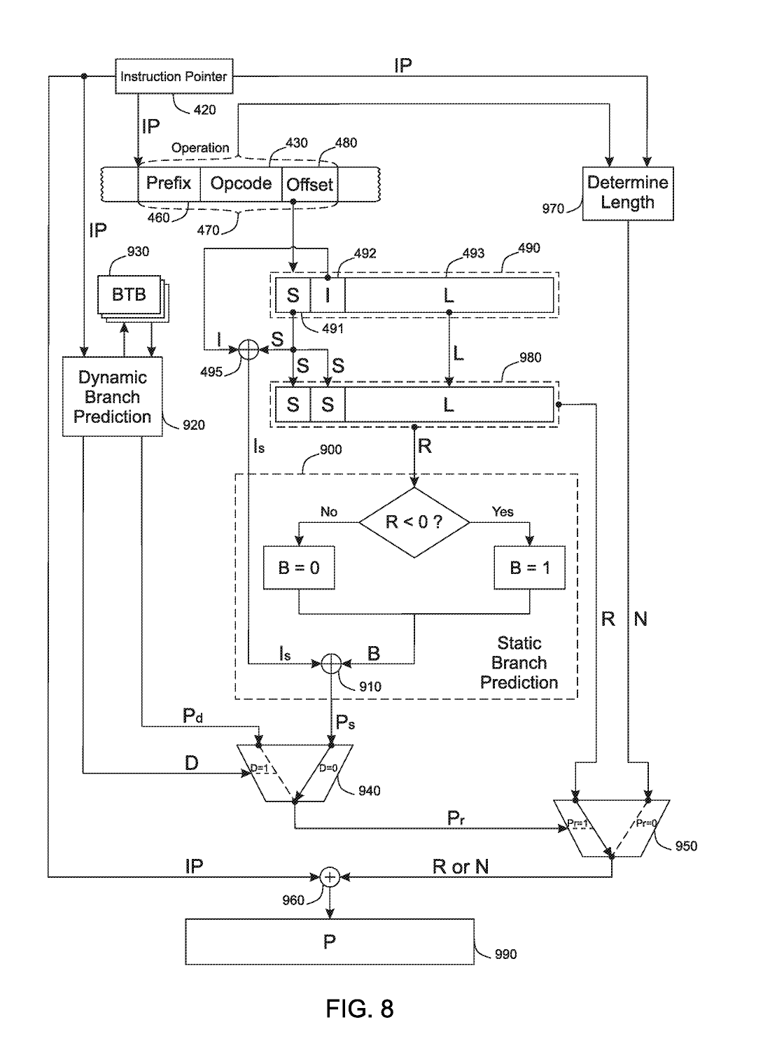

It is remarkable that a single bit, for example, for a physical memory address (see FIG. 5) and/or to control branch prediction (see FIG. 8) yields large advantages in productivity.

On the other hand, on modern computers it is possible to simply ignore this limitation by implementing this invention only in 64-bit mode. However, if the objective is nevertheless to give similar capabilities to 32-bit applications, then it is also possible to use the extended offsets described in previous sections in 32-bit mode.

Only the different in this case is that instead of adding with an address's high-order bits, bits of the higher part “H” read from the extended offset should be directly interpreted by the computer device as additional information—without using them in computing the effective address.

Actually, in this case the invention uses part of the offset bits as additional information, without supporting a similar function in effective addresses themselves (such use of offsets is described in the claims of this patent application, here is given only an example of its practical implementation).

This method (scheme) does not allow the implementation of all capabilities of this patent application, since the offsets are constants, but it allows unlocking almost all capabilities for 32-bit applications, especially when the type of extended pointer is known to the program in advance.

To transmit additional information that is not constant, parameterized prefixes or suffixes may be used.

It is also possible to use the solution described in the section “Extended Offsets for Indirect Access to Additional Useful Information”. In this case, the extended offset can code the number(s) (or index/indices) of the register(s) in which, in turn, additional useful information (for example, the identifier of another address space) is located.

Returning Intermediate Values to the Program (Optional Extension)

This section describes a computer device that is characterized by the fact that, using a prefix or suffix that precedes an executable operation (in particular command, instruction, order, operator, or function, both imperative ones, and ones that control data processing) or follows it (or its code), or using a similar special operation, it can return the results of intermediate calculations (including the value of an effective address) to the program; or can return to the program values read from control or internal registers and data structures; or can return to the program (or to the data processing process) any other intermediate and/or auxiliary results of executing operations or results of the address translation process (including the physical address of a memory cell)—if returning these values to the program is not provided in the command system of such device for such executable operation; in this regard such return values may be combined with any other information and/or transformed using some function before they are returned to the program.

In this case, the actual topic is a device that itself generates additional information containing intermediate and/or auxiliary results of executing a basic operation and then returns this information to the program.

Existing devices discard the parts of intermediate information and auxiliary results that are not included in the specifications of their instruction set architecture. This is typically done intentionally, since disclosing this information reduces device developers' flexibility in the future or even threatens security (if this information leaks to the application program).

However, there are a number of scenarios where flexibility will not be lost, there are not security threats, and information is not returned back according to only two principles:
1) In order not to clutter the command system with a bunch of rarely used parameters, and not to complicate decoding and dependency analysis;
2) This information is necessary only for system software, but is not necessary for application software—it is obvious that developers do not want to double commands and create second versions only for system programs.

Thus, there exist scenarios where intermediate and/or auxiliary results are lost due to compromises, but not for the principle reasons of flexibility and security.

A solution is proposed that uses prefixes or suffixes (or special operations that replace them) and allows the program to take such intermediate and/or auxiliary information only in the cases where it is truly necessary—not burdening the basic operations of this device with new parameters.

Of course, some types of information may be returned only to the system software, and in any case the topic is not providing access to the main mass of internal information—only to its individual types that are useful at the upper level (in software) and do not deprive device developers of flexibility in the future.

The computer device may analyze the proposed prefix or suffix and its parameters and, for example, signal an exception if the application program tries to obtain access to system information.

In particular, at the lower level of implementation a prefix or suffix that returns data may be implemented by adding a micro-operation to the executive unit queue, which writes additional information in the place (for example, in a general purpose register) where the prefix's or suffix's parameter points, similar to a general purpose operation.

The presence of such a prefix or suffix may also cause a computer device to write additional information to a fixed register that is not a parameter of the prefix or suffix, or to replace the initial value of one of the operands of a basic operation with additional information.

If this is necessary, then a computer device may translate the information returned by it from an internal representation into another representation that is suitable for the software, or combine it with other information.

In particular, at present it appears that the following data, which are useful for some application and system programs, may be obtained in the manner described above:
1) The majority of modern computer devices implement the division operation (if it is in their command system) through the preliminary calculation of a value that is the inverse of the divisor and then multiplying by this value. Such devices may return the calculated multiplicative inverse value (as an auxiliary result of division) through the proposed prefix or suffix. Then the program can use this multiplicative inverse value in subsequent calculations, which is particularly useful in the event that it is necessary to perform the division operation again using the same divisor (it may be immediately replaced with multiplication).
2) Practically all computer devices implement several mode of addressing, wherein the effective address is calculated by adding the base, index, and/or offset, sometimes with a scaled index. However, after executing the command, the computed effective address is lost. The program could take this data using the proposed prefixes or suffixes, in order to subsequently use simpler addressing methods;
3) If virtual memory address translation is enabled, then the computer device transforms the effective address from a linear (virtual) address into a physical address. In this regard, this information is lost after executing a memory access operation. The system software could take this address to use it in subsequent operations to directly access memory, bypassing MMU and TLB (for example, as described in this patent application) and for other improvements (if it knows that the addressed memory does not cross the page boundary);
4) The trigonometric functions of some Floating-point Processing Units (FPU) map an operand to the range “[0; π)” my or “[0; 2 π)”, losing much time in the process. The program could take the transformed operand for subsequent use in future calculations to boost performance and simplify a number of checks in the code.

Coupling of Executable Operations (Optional Extension)

This section describes a computer device that uses some executable operations as prefixes or suffixes for other executable operations, linking them using automatic register allocation (or automatic allocation of other temporary variables) for intermediate results, in order to eliminate the need for the user to explicitly specify registers (or some other variables) that store intermediate results of calculations.

One of the problems with low-level programming of computing devices that interferes with the parallelization of operations is the need to explicitly indicate the numbers of registers in which a sequence of commands stores intermediate results of calculations.

If we allow some machine instructions to act as prefixes or suffixes for other commands, then there is no need for explicit indication of register numbers (or similar variables) for intermediate results of calculations.

In this case, the fields that are reserved in the command system of this device for command operands can be used as parameters of prefixes or suffixes, which themselves are executable operations applied to the results or to the input parameters of the main operation.

If device developers do not want to create new machine commands for such prefixes or suffixes, they can only provide one special prefix, a suffix, or a replacement command that indicates that the subsequent sequence of commands of a certain length are prefixes or suffixes for one of them.

The operands of such prefixes or suffixes may be coded by general principles for coding machine command operands for such device.

In particular, if the prefix or suffix's operand is a general-purpose register, then in the machine representation of the prefix or suffix it will be coded as the register number.

Having determined the presence of a prefix or suffix (by its code, for example), the computer device extracts the register number from its machine representation and then reads the additional information from the register corresponding to said number—similar to the process of reading the values of operand registers that is used when decoding and executing normal operations.

Different versions of the same prefix or suffix may be provided, or different options for coding its operands that permit the transfer of both a direct value as well as, for example, a register or even a pointer to the memory area, including one aggregated using addressing methods supported by this computer device.

In this case, the value of the effective address for the pointer that is used in the prefix or suffix may be calculated by the same method by which effective addresses are calculated in ordinary operations on this device.

At the lower level of implementation, this parameterized prefix or suffix may be implemented as a separate micro-operation, the result of executing which will then be collected by the basic operation or by next prefix/suffix. Or, conversely, this micro-operation may collect the intermediate result of the basic operation (or result of the previous prefix/suffix) for additional processing, or to complete something begun by the basic operation.

In this case, it is not necessary to write this intermediate result in registers visible to the user. If the computing device needs additional registers, it can allocate them, for example, from the shadow register file, in an efficient way and without performing unnecessary dependency analysis.

Executable Operation for Address Translation

This section covers the implementation of a device, in which an executable operation (in particular command, instruction, order, operator, or function, both imperative ones, and ones that control data processing) is provided that for an assigned high level address or its component(s) (in particular for a logical, linear, virtual, or other address at which an executable operation or data processing operation operates, the component(s) of such address, or offset relative to some base address (including relative to an Instruction Pointer), regardless of whether such an address, or an address component or offset, is used directly, or as part of information to calculate another (effective) logical address, or they themselves constitute an effective address or were extracted from a calculated effective address) or for an assigned range of such addresses returns either a lower level address (in particular a physical address of a memory cell), or its component(s), that directly matches the this high level address, or returns the low level address of some memory space that contains the cell addressed by the this high level address (in particular the physical address of a memory page that contains the cell addressed by this high level address), or returns a set of lower level addresses that correspond to the assigned range of high level addresses.

Implementing an Address Translation Operation

The implementation of such an executable operation may also provide for notification (in particular by returning a special value, setting specific flags, by interrupting and/or by other means) that indicates that a given address may not be translated into a lower level address due to an error, and/or because its corresponding memory space (for example, a memory page) is temporarily inaccessible and/or because its corresponding memory space is inaccessible to programs or users with a certain privilege level.

As a whole, the implementation of this executable operation is obvious to a person skilled in the art.

In the simplest case, such an executable operation may receive as an input parameter a high level address (logical address) in the same format and generated according to the same rules as are customary for other executable operations to access memory and/or transfer control that are implemented on this device.

The computer device on which this invention is implemented translates the received high-level address (logical address) into a lower level address (for example, a physical address) according to those rules that are implemented on this device.

Addresses may be translated using both classical virtual memory address translation (for example, using page tables and a TLB buffer), and also a more complex method described in other sections of this patent application, which allows the use of several different address translation methods without switching the mode of operation of a given computer device.

The specific implementation of the translation of a high-level address into a lower level address is determined by the person skilled in the art who implements this invention. The details of this process are outside the scope of this patent application.

In terms of the idea underlying this invention, it is important that the computer device knows to return to the program (or to the data transformation process) the address obtained as a result of such translation, and does not merely know how to directly use it to access memory (or transfer control), as this is done by existing devices.

Having translated the addresses, the device described in this section of the patent application returns the obtained lower level address (for example, the physical address) back to the program (or to the data transformation process, if the subject is a data processing device).

How exactly the translated address is returned is determined by the person skilled in the art who implements this invention. For example, if the subject is a processor, then it may return the low level address in a register specified as an operand of a given executable operation, in a previously defined register, or on the top of the stack (for stack processors).

The computer device can also implement error (exception) notification for errors that occur during the execution of a given operation.

An operation may result in an error, for example, for the following reasons:
1) Addresses may not be translated because an unacceptable address is indicated;
2) Addresses may not be translated because an address on a page that is currently not in RAM is indicated;
3) Addresses may be translated, but in order to use a given address a higher level of privileges is necessary (a higher level than that possessed by the current program or user, or that is provided for a given operation, or specified in it).

In the event of detecting an exception or error in translation, the computer device may return a special value of the address (for example, a value equal to zero), set specific flag values, call an interrupt handler, or act according to other rules accepted by this device's developers.

For example, for an ordinary situation of a page missing in RAM, it may provide for returning a zero when an inaccessible address may lead to an interruption.

The specific implementation of handling exceptions is determined by the person skilled in the art who implements this invention.

The person implementing this invention may also supplement the semantics of the operation described in this section with other useful properties.

In particular, instead of checking the accessibility of a privilege level, the computer device may return the current privilege level that is required to access the indicated address—in order to check this privilege level in the program using this operation (without generating exceptions or interruptions).

A person skilled in the art can also implement a similar executable operation that accepts as input an array of high-level addresses and returns an array of lower level addresses that match the elements of the input array.

A person skilled in the art can also implement a similar executable operation that accepts as input a range of high level addresses (logical addresses), assigned by, for example:
1) Specifying the starting and ending addresses of the range;
2) Specifying the starting address and the first address after the end of that range;
3) Specifying the starting address of the range and the length of the memory area that corresponds to it.

and returning:
1) An array of lower level addresses (for example, physical addresses) that match the pages affected by this range of logical addresses;
2) Alternatively, two lower level addresses (for example, two physical addresses) that match two memory pages affect by this range—when its length is not greater than the length of a single page (according to the rules established for this implementation).

It is important to emphasize that for this section it does not matter whether the technology described in other section of this patent application is used in the operation of such a device, or whether such a device implements only a single address translation method (in a specific mode of operation). The address translation operation described in this section will be useful even for classical devices in which other aspects of this invention have not been implemented.

The executable operation described in this section is of major interest to developers of operating systems and may substantially improve performance.

When the necessary elements (of the page tables) are present in the TLB cache, modern processors translate addresses nearly instantaneously. However, they do not know how to return the result of such a translation (physical address) to the system program.

As a result, developers of system software are forced to actually reduplicate the work of the processor using a program code that is dozens of time less efficient from the perspective of performance, wastes electrical power in the processor, and also substantially complicates the process of software development.

In this regard, translating a logical address into a physical address is required practically by any input/output operation that uses Direct Memory Access (DMA) or other similar technologies that are used by high-speed devices such as storage devices, extended memory, network controllers, etc.

Furthermore, this operation may be used in order to determine nearly instantaneously whether a page is located in memory at a given moment, which simplifies the programming of virtual memory management modules in the operating system core.

Furthermore, many structures that control the work of virtual memory in the operating system core may be effectively organized if they are bound to physical memory pages.

Now an operating system is forced to first translate a logical address into a physical one, doubling at the program level the work of the page mechanism already implemented in the processor. In this regard, it makes this much slower and wastes much more electrical power.

Thus, adding a very simply additional executable operation (processor command) helps drastically simplify and speed up many operating system algorithms, external device drivers, and other system software, and therefore all application programs that use system calls or virtual memory.

### Schemes of Several Embodiments of this Invention

This section provides a list of examples of embodiments of this invention, which illustrate the likely (from the inventor's perspective) variants of its use in classical processors and similar computer devices.

However, the schemes given below should not in any case be considered an exhaustive list of the possible embodiments of this invention.

To the contrary, the text of this patent application describes much more possible implementations. The possible variants of implementing this invention are so numerous, that graphical illustrations (figures) were made only for some of them.

In this section, while discussing specific embodiments of this invention, the term “logical address” shall mean the value of the source or effective address, or a component (offset) of it, which is selected by a person skilled in the art for her implementation of this invention.

Many of these schemes (figures) demonstrate a computer device that uses this invention to operate simultaneously both directly with physical addresses of memory cells, as well as with linear logical addresses, which are transformed by the MMU into physical addresses using page tables (and TLB caches).

However, these provided schemes (figures) are only illustrations of some embodiments of this invention. As follows directly from the text of the patent application, this invention itself also spans more general embodiments, in which numerous different address translation methods (many different address types) may be used.

Furthermore, the result of translation may be not only the physical address of a memory cell, but any other type of address (if the invention is used at a level other than the lowest in the memory access hierarchy).

Some of the embodiments presented in the figures display some 64-bit processor, but a person skilled in the art could easily alter these schemes (figures) in such a way that they correspond to a device with a different bit length.

A person skilled in the art can generalize the schemes (figures) for a device that uses an address that consists of several components, for example, for a device with segmented memory addressing or for a device that uses explicit address space pointing (for example Address Space Number, Process Identifier), etc.

Unless the description states otherwise, each figure shows the execution of some single operation using the methods that are described in this patent application. In this regard, the figure shows the operation of only those blocks of the computer device that are related to this invention. Sometimes it shows the operation of adjacent blocks, without the details of their device and functionality. The remainder is outside the scope of this patent application.

These figures do not show the handling of exceptions that may arise during the operation of the computer device, because the methods of detecting and handling exceptions are determined by the developers of a specific device and are outside the scope of this patent application.

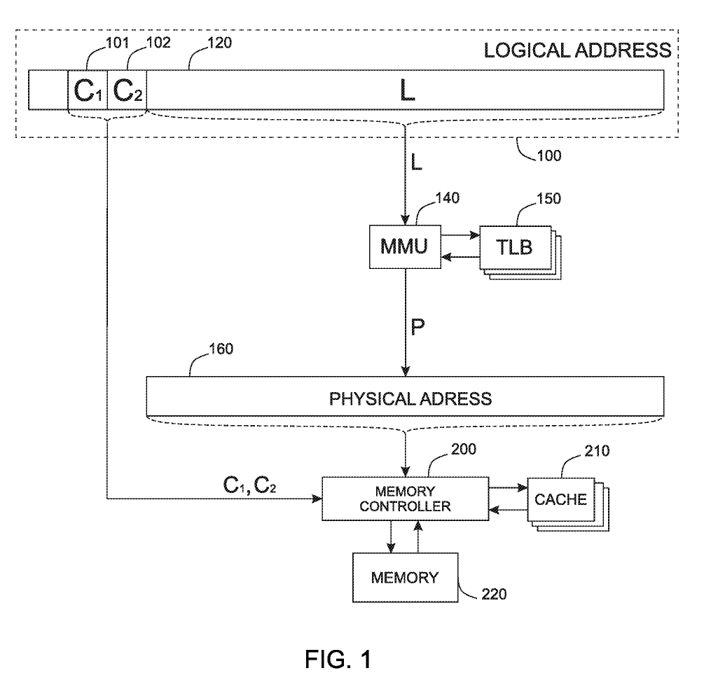

FIG. 1

This figure demonstrates the operation of a device that implements the transmission of additional useful information through a logical address.

In the high-order bits of this device's (designated as 100 in the figure) logical address there are two bits “C₁” and “C₂”, which are designated as 101 and 102 in the figure, respectively. These bits contain some useful information.

In this example, it is assumed that this useful information is designed for memory control. For example, this may be some bits that control caching, prefetching, and/or synchronization. Alternatively, these bits contain some command for memory control, caching control, prefetching, and/or synchronization.

A person skilled in the art can easily rework this figure for a device that transmits similar bits to any other of its subsystems or even to multiple of its subsystems, in which regard the person skilled in the art may increase or decrease the number of bits that carry useful information.

The value of low-order bits of the logical address (which are designated as 120 in the figure) is used as address information—let this value be labeled V.

In this example, the value “C is interpreted by the device as a linear address that requires virtual memory address translation. It serves as the input to the MMU (designated as 140 in the figure).

The MMU translates the linear address into a physical address using page tables, accessing the TLB cache (designated as 150 in the figure) when necessary.

As a result of the operation of the MMU, the value “C is translated into a physical address (designated as 160 in the figure) value, which shall be labeled P.

Then the generated physical address is transmitted to the memory controller (designated as 200 in the figure), which accesses RAM (designated as 220 in the figure) using this address, and interacting with cache memory (designated as 210 in the figure) when necessary.

The details of a device's modules for MMU, TLB, memory controller, cache memory, the specific organization of memory, and the details of the process of accessing memory are all outside the scope of this patent application, and are to be determined by developers of a specific computer device; therefore, they are not shown in the figure.

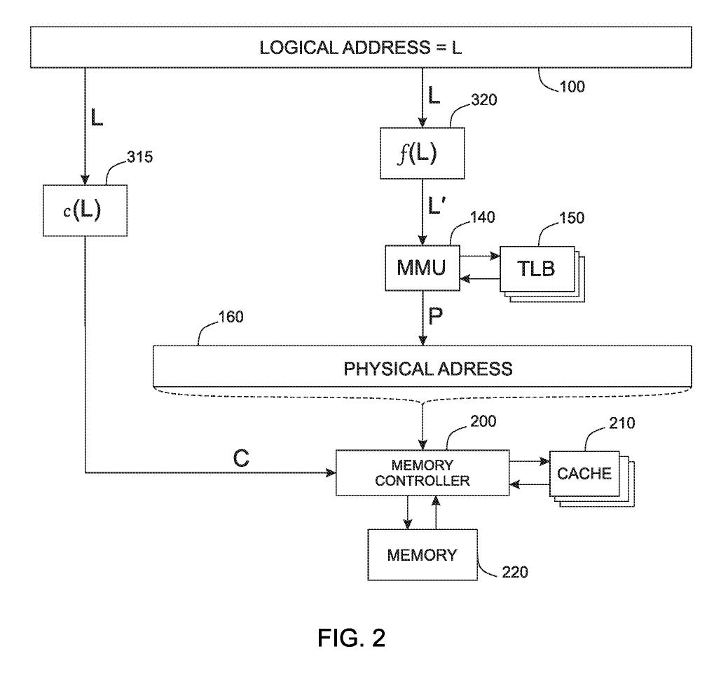

FIG. 2

This figure demonstrates the operation of a device that implements the transmission of additional useful information through a logical address.

Distinct from the device displayed in FIG. 1, this device extracts useful information from a logical address using some function.

The logical address may have a complex, even nonlinear structure. Additional information may also be encoded in a complicated manner, in particular, using a command system, an example of which is described in the section “Transmitting Commands within Additional Information.”

Let the logical address of this device (which is designated as 100 in the figure) be labeled V.

This figure demonstrates the operation of a device that extracts useful information from a logical address using a block implemented by some function “c(L)”. This block is designated as 315 in the figure.

The value of the logical address “C is used as the input to the function “c(L)”, the result of which is bits of useful information. Let this useful information that is extracted from the address as a result of the function “c(L)”, be designated as C.

In this example, it is assumed that this useful information is designed for memory control. For example, this may be some bits that control caching, prefetching, and/or synchronization. Alternatively, these bits contain some command for memory control, caching control, prefetching, and/or synchronization.

A person skilled in the art can easily rework this figure for a device that transmits similar bits to any other of its subsystems or even to multiple of its subsystems, in which regard the person skilled in the art may increase or decrease the number of bits that carry useful information.

The value of the logical address “C is also used as the input to another block, which is designated as 320 in the figure. This block implements some function “f(L)”, which is designed to separate from the logical address basic information that constitutes the linear address of memory.

The objective of this function is to remove additional information from the value of the logical address and to separate only the basic information that is necessary for memory addressing.

The result of the “f(L)” function is the value of a linear address, which is labeled as “L′ “. It serves as the input to the MMU (designated as 140 in the figure).

The MMU translates the linear address into a physical address using page tables, accessing the TLB cache (designated as 150 in the figure) when necessary.

As a result of the operation of the MMU, the value “L′” is translated into a physical address (designated as 160 in the figure) value, which shall be labeled P.

Then the generated physical address is transmitted to the memory controller (designated as 200 in the figure), which accesses RAM (designated as 220 in the figure) using this address, and interacting with cache memory (designated as 210 in the figure) when necessary.

The details of a device's modules for MMU, TLB, memory controller, cache memory, the specific organization of memory, and the details of the process of accessing memory are all outside the scope of this patent application, and are to be determined by developers of a specific computer device; therefore they are not shown in the figure.

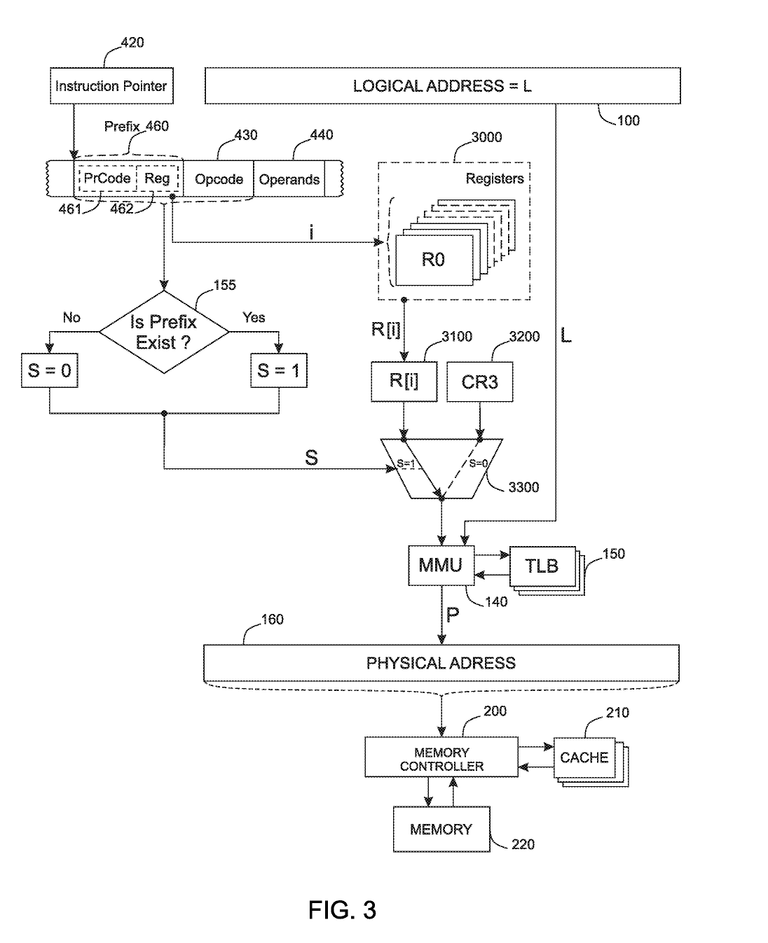

FIG. 3

This diagram demonstrates the operation of a device that implements the transmission of additional useful information through a parameterized prefix of the executable operation and uses this data to access another address space.

This unlocks the possibility of accessing other address spaces without mapping their pages in the current address space, without switching contexts, without changing the values of system registers and with practically no overhead.

This computer device extracts useful information from a general-purpose register that is the operand of an executable operation's prefix. This prefix is designated as 460 in the figure; it precedes the executable operation code, which is designated as 430 in the figure.

The executable operation code is followed by the machine representation of its operands, which is designated as 440 in the figure.

The structure (values) of the operation's and operands' code are not detailed in the figure, since the methods of coding executable operations are determined by the developers of the specific computer device that uses this invention, and are outside the scope of this patent application.

Let the logical address of this device (which is designated as 100 in the figure) be labeled V.

The computer device has in its composition a register for the pointer to the current executable operation, which is designated as 420 in the figure.

During the execution of the program, the computer device reads the machine representation of the operation, starting with the address to which the current operation address register points.

The computer device may detect the prefix of the executable operation by its code, which is designated as 461 in the figure. This prefix also has its own operand, which is designated as 462 in the figure.

If the executable operation's code in machine representation is preceded by the necessary prefix, then in the condition verification block, designated as 155 in the figure, some signal “S” is generated equal to one, but if the necessary prefix is absent, then the signal “S” is equal to zero.

The signal “S” controls the operation of the multiplexor, which is designated as 3300 in the figure.

However, if the prefix is absent, then the signal “S” is equal to zero and this multiplexor transmits as the input to the MMU, which is designated as 140 in the figure, the value of the standard register of the pointer to the root page table (or directory), which is designated as 3200 in the figure. This register is labeled “CR3”, due to its similarity to the corresponding register in popular x86 family processors.

Having received as input the value of the standard control register, the MMU will work normally and access memory in the current address space (the page tables of which are pointed to by the standard control register “CR3”).

If the prefix is present, then the computer device first reads the machine representation of its operand, designated as 462 in the figure. This machine representation contains the number of a general-purpose register.

Let this value of the number of the register (indicated as a prefix operand) be labeled “i”.

Next, the computer device accesses the general-purpose registers file, which is designated as 3000 in the figure, and reads the value of the register numbered “i”. Let this value be labeled “R[i]”. This is designated as 3100 in the figure.

Since the signal “S” is equal to one (the prefix is present), next the multiplexor, designated as 3300 in the figure, transmits as input to the MMU not the value of the standard control register “CR3”, but the value “R[i]”.

As a result, the MMU accesses another address space.

For example, if the MMU uses the figure adopted in the x86 architecture, then it reads the context identifier from low-order bits of the value “R[i]” and uses it as a PCID context identifier, with which it accesses the TLB buffer (designated as 150 in the figure). If the necessary element is not found in the TLB, then the MMU accesses the page tables to which the high-order bits of the value “R[i]” point. Then it will bring a new element to the TLB, supplying it with a PCID identifier taken from “R[i]”.

After replacing the pointer to the page tables, the MMU operates in such a way as if it were using the value of the “CR3” register, but now the data is read not from the current address space, but from another address space, to which “R[i]” points.

In this regard, the logic of the remaining activities of this device is left unchanged.

In this example, the value “L” is interpreted by the device as a linear address that requires virtual memory address translation. It serves as the input to the MMU (designated as 140 in the figure).

The MMU translates the linear address into a physical address using page tables, accessing the TLB cache (designated as 150 in the figure) when necessary.

As a result of the operation of the MMU, the value “L” is translated into a physical address (designated as 160 in the figure) value, which shall be labeled P.

Then the generated physical address is transmitted to the memory controller (designated as 200 in the figure), which accesses RAM (designated as 220 in the figure) using this address, and interacting with cache memory (designated as 210 in the figure) when necessary.

The details of a device's modules for MMU, TLB, memory controller, cache memory, the specific organization of memory, and the details of the process of accessing memory are all outside the scope of this patent application, and are to be determined by developers of a specific computer device; therefore they are not shown in the figure.

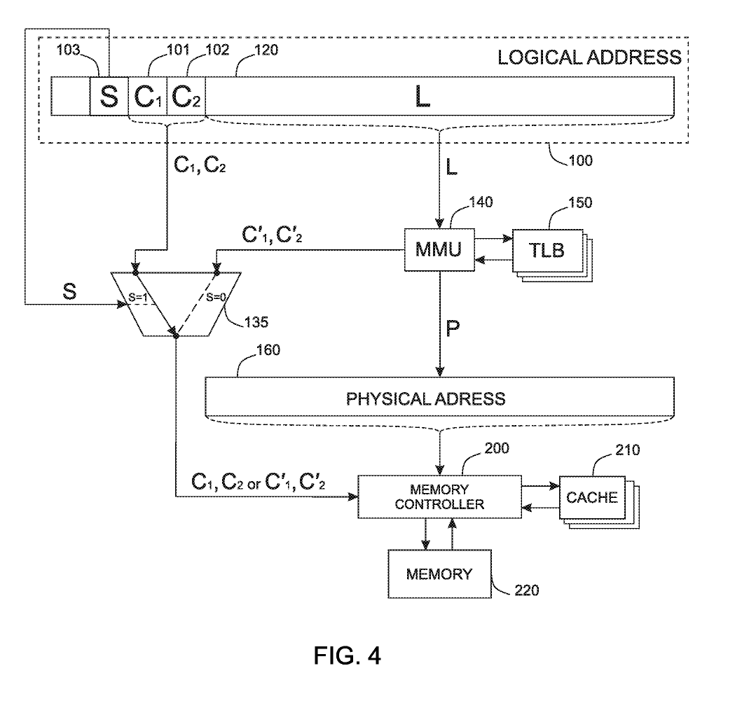

FIG. 4

This figure demonstrates the operation of a device that implements the transmission of additional useful information through a logical address.

Distinct from the device displayed in FIG. 1, this device uses useful information located in the logical address only in the case that one of the bits of this logical address is equal to 1.

In the high-order bits of this device's (designated as 100 in the figure) logical address there are two bits “C₁” and “C₂”, which are designated as 101 and 102 in the figure, respectively. These bits contain some useful information.

In this example, it is assumed that this useful information is designed for memory control. For example, this may be some bits that control caching, prefetching, and/or synchronization. Alternatively, these bits contain some command for memory control, caching control, prefetching, and/or synchronization.

A person skilled in the art can easily rework this figure for a device that transmits similar bits to any other of its subsystems or even to multiple of its subsystems, in which regard the person skilled in the art may increase or decrease the number of bits that carry useful information.

However, distinct from the device displayed in FIG. 1, this device does not always use useful information extracted from the logical address.

In the high-order bits of its logical address, there is a control bit that is designated as 103 in the figure.

Let the value of this bit be labeled S.

The value of the bit “S” controls the operation of the multiplexor, which is designated as 135 in the figure.

If the value of the control bit “S” is equal to one, then the computer device transmits as an input to the memory controller the values of the bits “C₁” and “C₂”, which have been extracted from the logical address.

However, if the value of the control bit “S” is equal to zero, then the computer device switches to its normal mode of operation, in which it extracts similar useful information (the bits of which are designated as “C′₁” and “C′₂”) from the page tables using the MMU, which is designated as 140 in the figure.

The value of low-order bits of the logical address (which are designated as 120 in the figure) is used as address information—let this value be labeled V.

In this example, the value “C is interpreted by the device as a linear address that requires virtual memory address translation. It serves as the input to the MMU (designated as 140 in the figure).

The MMU translates the linear address into a physical address using page tables, accessing the TLB cache (designated as 150 in the figure) when necessary.

As a result of the operation of the MMU, the value “C is translated into a physical address (designated as 160 in the figure) value, which shall be labeled P.

Then the generated physical address is transmitted to the memory controller (designated as 200 in the figure), which accesses RAM (designated as 220 in the figure) using this address, and interacting with cache memory (designated as 210 in the figure) when necessary.

The details of a device's modules for MMU, TLB, memory controller, cache memory, the specific organization of memory, and the details of the process of accessing memory are all outside the scope of this patent application, and are to be determined by developers of a specific computer device; therefore they are not shown in the figure.

FIG. 5

This diagram demonstrates the operation of a device that uses the transmission of additional information in a high-order bit of the logical address to select the method of addressing memory.

This device dynamically selects the address translation method in order to provide the capability to access memory both directly using physical addresses, and using linear addressing by a page mechanism (and TLB cache).

This device selects the method of translating addresses by checking a high-order bit of the logical address.

The logical address of this device (which is designated as 100 in the figure) is divided into two parts: a high-order bit, which is designated as 110 in the figure, and low-order bits of the address, which are designated as 120 in the figure.

The value of the high-order bit (labeled “S”) selects the address translation method that will be used to access memory.

The value of low-order bits is used as address information—let this value be labeled V.

The value “S” controls the operation of the switcher (designated as 130 in the figure), which selects where address information will be sent (the value “L”).

If the value “S” is equal to one, then the value “C is interpreted by the device as the physical address of a memory cell—it enters the low-order bits (designated as 180 in the figure) of the physical address (designated as 160 in the figure).

If the value “S” is equal to zero, then the value “C is interpreted by the device as a linear address that requires virtual memory address translation.

In this case, it serves as the input to the MMU (designated as 140 in the figure).

The MMU translates the linear address into a physical address using page tables, accessing the TLB cache (designated as 150 in the figure) when necessary.

As a result of the operation of the MMU, the value “C is translated into a physical address value, which shall be labeled P.

The value “P” is also passed to the low-order bits (180) of the physical address (160).

In this figure, the high-order bit of the physical address (designated as 170 in the figure) is equal to zero so that the bit length of the logical and physical addresses coincides. A person skilled in the art can easily modify this figure by excluding a null high-order bit from it, if her device does not require logical and physical addresses to have the same bit length.

Then the generated physical address is transmitted to the memory controller (designated as 200 in the figure), which accesses RAM (designated as 220 in the figure) using this address, and interacting with cache memory (designated as 210 in the figure) when necessary.

Details of the device modules MMU, TLB, memory controller, cache memory, the specific organization of memory, and the details of the process of accessing memory are all outside the scope of this patent application, and are to be determined by developers of a specific computer device; therefore, they are not shown in the figure.

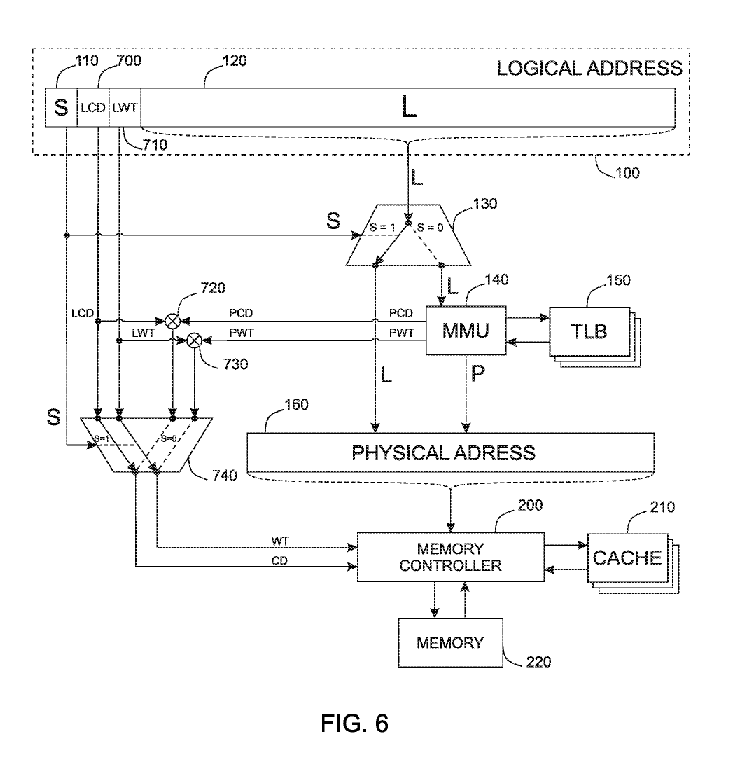

FIG. 6

This figure displays an example of implementing a computer device that supports the transmission of additional information through a logical address. Here this information is used in this device for two different purposes—to select the method of addressing memory (to choose whether the addressing process involves an MMU module for translating a linear address into a physical address using page tables or it directly extracts the physical address from the bits of the logical address) and to transmit additional attributes that control caching.

In addition to selecting a memory addressing method, the additional information transmitted through a logical address is used in this example to control caching. However, a person skilled in the art may organize in a similar manner the transmission of any other useful information that affects the operation of different parts of this computer device, or even external devices.

This computer device uses a high-order bit in the logical address to select the address translation method, similar to the device shown in FIG. 5.

Additionally, this computer device extracts from the logical address two bits, the values of which are labeled “LCD” and “LWT”, respectively. These bits are used to control caching. They are designated as 700 and 710 in the figure.

The logic of the operation of this device is related to the choice of addressing method in exactly the same way as with the device displayed in FIG. 5.

In addition to this logic, the memory controller (which is designated as 200 in the figure) receives as input not only a physical address, but also two attributes, which are conditionally labeled “CD” and “WT”. Assume that the values of these attributes control caching.

Depending on the value of the high-order bit “S”, this computer device decides from where it will take the values of the attributes “CD” and “WT”.

In order to select the method of computing the attributes “CD” and “WT”, an additional switcher, which is designated as 740 in the figure, is added to this device.

If the value of the high-order bit of the address “S” is equal to one, then the device uses the values “LCD” and “LWT” (taken directly from the logical address) as values of the attributes “CD” and “WT”:

CD=LCD

WT=LWT

If the value “S” is equal to zero, then the device combines the values “LCD” and “LWT” taken from the logical address with the values “PCD” and “PWT” that the MMU read from the TLB or from page tables:

CD=LCD⊗PCD

WT=LWT⊗PWT

In this example, the device combines the values taken from the logical address with the values that are obtained from the MMU using the “exclusive or” (XOR) operation on logical elements, designated in the figure as 720 and 730, respectively.

A person skilled in the art may also implement another logic, including on that does not combine the values extracted from the logical address with the values from the page descriptor—for example, if the corresponding bits, in the event that a linear page address has been selected, continue to be used as part of the address information and do not control caching.

Then the values of the attributes “CD” and “WT”, which are either directly extracted from the logical address, or combined with values obtained from the MMU, are transmitted to the memory controller and serve to control caching.

How exactly these values are used to control caching, is not shown in the figure, since the specific implementation of caching is determined by the person skilled in the art and is outside the scope of this patent application.

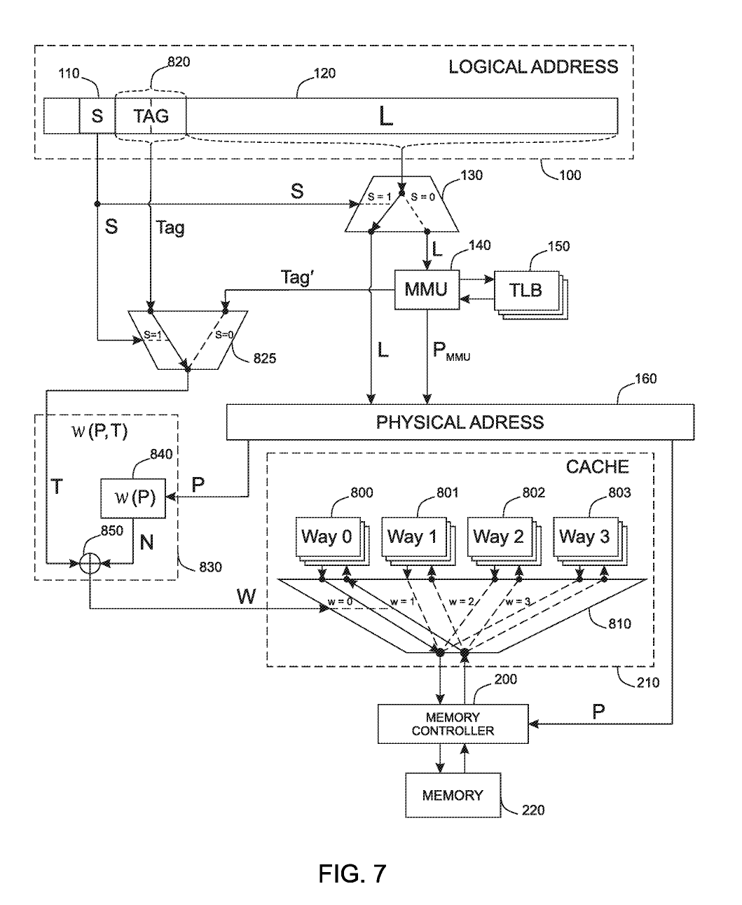

FIG. 7

This diagram demonstrates the operation of a device that uses the transmission of additional information to reduce the number of collisions that occur due to competition for the same sets within associative cache memory (when working with large volumes of data).

The device displayed in this diagram uses two different sources of additional information to improve the performance of the associative set selection algorithm: bits of a tag in a logical address or bits of a tag read from a descriptor of the virtual memory page.

This device supports access to memory both using physical addresses, and using linear addresses that have been translated into physical address by the MMU.

The logical address of this device (which is designated as 100 in the figure) contains a control bit, which is designated as 110 in the figure, tag bits, which are designated as 820 in the figure, and low-order bits of the address, which are designated as 120 in the figure.

The tag that this device uses occupies two bits; let the value of this tag, which is read from the logical address, be labeled “Tag”. A person skilled in the art who implements this invention on her device may increase (or decrease) the bit length of the tag.

The value of the control bit (labeled “S”) selects the address translation method that will be used to access memory.

The value of low-order bits is used as address information—let this value be labeled V.

The value “S” controls the operation of the switcher (designated as 130 in the figure), which selects where address information will be sent (the value “L”).

If the value “S” is equal to one, then the value “C is interpreted by the device as the physical address of a memory cell—it enters the low-order bits (designated as 180 in the figure) of the physical address (designated as 160 in the figure).

If the value “S” is equal to zero, then the value “C is interpreted by the device as a linear address that requires virtual memory address translation.

In this case, it serves as the input to the MMU (designated as 140 in the figure).

The MMU translates the linear address into a physical address using page tables, accessing the TLB cache (designated as 150 in the figure) when necessary.

As a result of the operation of the MMU, the value “C is translated into a physical address value, which shall be labeled “Pₘₘᵤ”.

Let the final value of the physical address be labeled P.

The value “S” also controls the operation of the second switcher, which is designated as 825.

The task of this switcher is to determine which value of the tag to give as input to the associative set selection function, which will be discussed below. The working value of this tag is labeled T.

If the value “S” is equal to one, that is if a physical memory address is used, then the value “Tag” read from the logical address will be used as the value T.

If the value “S” is equal to zero, that is if a linear address and MMU block are used, then the value “Tag” that the MMU block reads from the page descriptor while translating the linear address “C is used as the value T.

The value of tag “T” (either extracted from the logical address, or read by the MMU from the page descriptor) is given as input to the block, which is designated as 830 in the figure. The value of the physical address, which is labeled “P”, is also given as the input to this block.

When there is another organization of caching, the person skilled in the art who implements this invention may alter this figure in such a way that instead of the value “P” the value of the linear address “L”, or any combination of them, would be used.

This block implements some function to select an associative set, which is labeled as “w(P, T)”. The value of this function, which is labeled “W”, is the number of the set of cells within associative cache memory (associative set number), which will be used when working with memory during the execution of the current operation.

The task of the function “w(P, T)” is to “mix” the bits of the physical address “P” so as to obtain from them an associative set number “W” that is as random as possible.

To this end, the bits of the physical address “P” are first given as the input to the “compression” function w(P), the task of which is to translate them into a short (in this example, two-bit) value “N”, which could be used as an associative set number:

N=w(P)

This compression function is implemented in the block designated as 840 in the figure.

However, the function “w(P)” must have a simple implementation and work quickly, for this reason, on many actual devices it reflects addresses that differ from one another by some value, multiplied by a power of two, in the same set number (in the same values “N”).

As a result of this feature, the elements of two different arrays that are read or written “in parallel” with one another will fall into the same sets within cache memory. Therefore, they will push one another out, and there will also be delays due to the impossibility of executing two operations with the same set in parallel.

In order to avoid this defect without increasing the complexity of the “w(P)” function, this invention implements a function “w(P, T)” that “mixes” the value of the tag “T”, which is taken from the logical address or from the page descriptor, into the value N.

In this example, the mixing is done using the “XOR” operation between the values “N” and “T” in the logical adder designated as 850 in the figure. As a result, the final value of the associative set number “W” is obtained:

W=N⊕T

A person skilled in the art can easily modify this figure so that the mixing of “T” is performed using another function, including before, after, and during the compression transformation of the address P.

The problem that is solved by “mixing” the value of the tag “T” is to give the program developer (or compiler) control over the selection of the associative set by somehow linking this selection with the data structure marked with tag “T” in the program. This may either be directly, or while permitting some element of “chance”, by preserving the dependence on the value of the address “P” (as in the example).

The additional information in the form of tag “T” makes the computed value of the associative set number dependent on the specific data structure, the elements of which are marked with tag “T” in the program.

The selection of the specific implementation of the function “w(P, T)” and its parameters (including additional ones) is left to the person skilled in the art who implements this invention on her device.

When the associative set number “W” is calculated in block 830, its value is given as input to the switcher, which is designated as 810 in the figure.

In this figure, this switcher is part of the cache memory subsystem, designated as 210 in the figure. However, it could also be placed in another part of the device, as determined by the person skilled in the art who implements this invention on her device.

The task of this switcher (or other block with similar purpose in the computer device, if the person skilled in the art places this function in another block or implements it in some other way) is to select with precisely which of several sets of cells within associative cache memory this device will work when executing the current operation.

These associative sets of cache memory cells are designated as 800, 801, 802, and 803 in the figure, respectively. Depending on which of these sets is selected, data from memory fall precisely into it and/or will be found precisely in it.

Thus, through the value of the tag “T” the software may affect the selection of a set of cells within associative cache memory by tying this selection to specific data structures (the elements of which share the common value of the tag “T”), and not only to addresses of memory cells.

Then the physical address “P” is transmitted to the memory controller (designated as 200 in the figure), which accesses RAM (designated as 220 in the figure) using this address, and interacting with cache memory (designated as 210 in the figure) when necessary.

As was already described above, when the memory controller wants to read or save data, it uses the associative set number W.

Details of the device function “w(P)”, modules MMU, TLB, memory controller, cache memory, the specific organization of memory, and the details of the process of accessing memory are all outside the scope of this patent application, and are to be determined by developers of a specific computer device; therefore, they are not shown in the figure.

FIG. 8

This diagram demonstrates the operation of a device that uses the transmission of additional information to control speculative execution and prefetching so as to reduce the probability of inaccurately predicting the direction of a conditional jump.

This device uses a simple logic for static branch prediction. However, if the programmer or compiler knows that this simple logic makes an incorrect decision, then they are able to change this decision by transmitting additional information to the device through an offset in the jump command.

This figure displays the process by which the computer device makes a decision regarding from which address to continue prefetching and speculative execution, assuming that during preliminary analysis of the conditional jump instruction the device still does not know whether the jump will occur or not.

The device in the figure analyzes the conditional jump instruction pointed to by the register of the pointer to the current executable operation, which is designated as 420 in the figure. Its value is designated as “IP”.

The machine representation of this conditional jump instruction is designated as 470 in the figure. In this example, it includes the conditional jump instruction prefix, which is designated as 460 in the figure, the conditional jump instruction's code, which is designated as 430 in the figure, and the offset-operand, which is designated as 480 in the figure.

The value of the offset, which is extracted from the machine representation of the conditional jump instruction, is designated as 490 in the figure. Here it is possible to separate the high-order sign bit, which is designated as 491 in the figure, a default logic inversion bit, which is designated as 492 in the figure, and low-order bits of the offset, which are designated as 493 in the figure.

Let the value of the sign bit of the offset be designated as “S”, the value of the default logic's inversion bit as “I”, and the value of the low-order bits of the offset as L.

The default logic's inversion bit “I” allows changing the decision made by the static branch prediction block to the opposite decision.

The value of bit “I” is combined with the value of the sign bit “S” using the “XOR” operation in the logical adder block, which is designated as 495 in the figure.

This is necessary because the offset value may be negative, and then in order to invert the decision of standard branch prediction logic it is necessary to use a value of zero, and not one, for the “I” bit, since there is a one in this bit in normal negative offset values, and compatibility with earlier developed code should be maintained.

The result of combining the bits “S” and “I” is the value designated as “Is”:

ls=I⊕S

Then the sign bit “S” will be copied to the place that was occupied by the “I” bit and combined with the low-order bits of the offset “L”, generating a “clean” offset value, which does not include the control information. This offset value is labeled “R”; it is designated as 980 in the figure.

The computer device must also determine the length of the current operation. In order to do this it analyzes the machine representation of the current operation (using the pointer to the current operation “IP”) in the block that is designated as 970 in the figure, and determines the length of this representation, which is labeled N. In this example, this will be the sum of the prefix length, the operation code length, and the encoded offset length.

Then the computer device, using the address of the current operation “IP”, analyzes the conditional jump instruction in the dynamic branch prediction block, which is designated as 920 in the figure. This block in particular may access the branch prediction buffer (BTB), which is designated as 930 in the figure.

If the dynamic branch prediction believes that it knows the jump direction, then it generates a signal “D” equal to one, but if the jump direction has not been determined, then it generates a signal “D” equal to zero. If the jump direction has been predicted, then this prediction is transmitted onward as some signal, which is labeled “Pd”.

If the value “Pd” is equal to zero, then the jump is unlikely to occur, but if it is equal to one, then the jump is likely to occur.

If the dynamic branch prediction block was not able to determine the direction and returned a signal “D” equal to zero, then the computer device uses the static branch prediction block, designated as 900 in the figure.

The static branch prediction block analyzes the “cleaned” offset value “R” in order to predict whether the jump will occur. In the general case, it can also analyze other data, such as the prefix, operation code, etc., but for the simple device shown in this figure, this data analysis is not necessary.

The details of the device of dynamic and static branch prediction blocks and the algorithms of their operation are determined by the person skilled in the art who implements this invention on her device. They are outside the scope of this patent application.

However, since the logic of static branch prediction does not differ too much between devices, the operation of a classical algorithm has been displayed.

A classical static branch predictor believes that a jump will take place if its target is located above the pointer to the current operation “IP”, that is, if the value “R” is negative. In the opposite case, it believes that the jump will not occur.

The static branch prediction block in this figure checks the sign of “R” and generates a signal “B” equal to one if it believes the jump will occur. Alternatively, the signal “B” may be equal to zero if the jump is likely not to occur.

Then the computer device combines the value of this sign with the value “Is” using the “XOR” operation in the logical adder, which is designated as 910 in the figure. As a result, the final decision of the static branch prediction block is made, which is labeled “Ps”:

Ps=Is⊕B

It is not difficult to see that in this simplified device “B” is equal to “S”, as a result, in fact:

Ps=I

However, if a person skilled in the art modifies the logic of the static branch prediction, then this equality will be destroyed and it will be necessary to return to the previous one.

In fact, at present the value of the default logic's inversion bit “I” either preserves or inverts (changes to the opposite) the decision made by the default logic of the static branch prediction block.

Thus, the programmer and compiler become able to change the logic of the static jump predictor to its opposite.

This allows them to avoid the problem of losing performance during a “cold start”, where a given jump is missing in the branch prediction buffer, but the programmer or compiler knows in advance that the static branch prediction logic will not yield the correct result in this case (since it contradicts the logic of the actual program).

Of course, the sign “D” determines, using a multiplexor that is designated as 940 in the figure, which of the predictions, “Pd” or “Ps” (from the dynamic or the static jump predictor) will be used as the final prediction, which is designated as “Pr”.

Then the computer device is ready to determine the address from which it will continue prefetching and speculative execution of operations. This address is designated as 990 in the figure. Let the value of this address be labeled P.

The prediction “Pr” controls the operation of the multiplexor, which is designated as 950 in the figure.

If the prediction “Pr” is equal to zero, then it is likely that the jump will not occur, and in this case prefetching must continue until the next instruction, the address of which is determined by adding the pointer to the current operation “IP” to the length of operation “N”:

P=IP+N

If the prediction “Pr” is equal to one, then it is likely the jump will occur, and in this case prefetching must continue along the branch that corresponds to triggering the jump:

P=IP+R

Then the prefetching address is generated in the adder, designated as 960 in the figure, and is ready for use. The computer device may proceed to select the next executable operation.

The prefetching process itself, like other details of the operation of this device, is outside the scope of this patent application and is not shown in the figure.

FIG. 9

This diagram demonstrates the operation of a computer device that uses an extended offset algorithm that allows the changing of high-order bits of an effective address using a short offset. In particular, this algorithm can be used to add or change additional useful information if it is located in high-order bits of the effective address.

The main part of this figure or its variations may be used (both directly, and with minor modifications) to encode other immediate values (with or without a sign) in any executable operations wherein it would be desirable to obtain access to high-order bits of the numbers at the price of a moderate decrease in the acceptable range of immediate values.

Alternatively, it could be used in order to transmit an additional (especially optional) immediate value as an additional operand.

This figure displays the final stage of calculating the effective address, when the computer device has already calculated the basic effective address according to its standard rules and now it must add an offset to it, the value of such offset having already been read from the machine representation of the executable operation.

The original value of the offset, which is read from the machine representation of the executable operation, is designated as 1000 in the figure. Here it is possible to separate the high-order (sign) bit, which is designated as 1001 in the figure. Then, after the sign bit, several bits should follow, which are labeled “verification” bits and are designated as 1002 in the figure. The verification bits are followed by low-order offset bits that are designated as 1003 in the figure.

The sign bit of the offset is labeled “S”, the verification bits are labeled “C”, and the low-order offset bits are labeled D.

The base value of the effective address to which it is necessary to add the offset is designated as 1700 in the figure. This value is labeled “B” in the text of this application.

At the beginning of the performance of this algorithm, the computer device must determine whether it is working with a standard offset, encoded as a normal integer, or a so-called extended offset, discussed in detail in the section “Extended Offsets”.

To this end, this device sequentially compares all the verification bits “C” with the sign bit S. If even one verification bit is equal to the sign bit “S”, then the computer device believes that it is working with a normal offset.

The “C” bits are checked in the computer block designated as 1100 in the figure. If even one verification bit is equal to the sign bit, then this block generates some signal “E” equal to zero, but if all the verification bits are unequal to the sign bit, then it generates a signal “E” equal to one.

In other words, suppose that a given computer device uses 7 verification bits, then any number beginning with the sequence “01111111” or “10000000” in the high-order bits will be considered to be an extended offset and receive a signal “E” equal to one, and all other numbers will be considered to be normal and receive a signal “E” equal to zero.

The signal “E” controls the operation of the switcher, which is designated as 1300 in the figure.

If the signal “E” is equal to zero, then the switcher transmits the original low-order bits of the offset “D” to the extended sign bit block, designated as 1400 in the figure. The task of this block is to extend the sign of the number in order to bring its bit length up to the bit length of the effective address.

To this end, the value of the sign bit “S” is copied into all additional bits of the working register.

Then the effective offset value, obtained after the sign extension, is added to the base effective address value “B” in the block designated as 1500 in the figure.

The final value of the effective address obtained after adding the offset is designated as 1800 in the figure.

However, if the signal “E” is equal to one, then the offset is an extended offset. In this case, the switcher transmits the original value of the low-order offset bits “D” to the working register, which is designated as 1200 in the figure.

Here the low-order offset bits “D” are separated into two parts—the higher part of the extended offset bits, which is labeled “H”, and the lower part of the extended offset bits, which is labeled L.

The higher part of the extended offset bits is designated as 1201 in the figure, and the lower part as 1202.

The bits of the lower part “L” are given as the input to the sign extension block, which is designated as 1450 in the figure. Distinct from the other sign extension block (which is designated as 1400 in the figure), in this case the sign goes to those bits that in the original value would match the verification bits and to the bits that would match the higher part H.

Then the effective offset value, obtained after the sign extension, is added to the base effective address value “B” in the block designated as 1500 in the FIG. 1550.

However, distinct from the plan of action for normal offsets (when the sign “E” is equal to zero), one more step is added—the bits of the higher part of the extended offset “H” are padded with zeros in a shift register, which is designated as 1600, and then they are added to the high-order bits of the effective address in the adder, designated as 1650 in the figure.

Thus, now the value of the effective address (designated as 1800 in the figure) is also calculated for the extended offset, in which regard additional information (that labeled “H”) that has been extracted from the extended offset is transferred into the high-order bits of this address.

A person skilled in the art may modify this circuit (scheme) for her computer device, for example, by changing the order of adding the effective address components, or by imposing the value “H” onto the high-order bits of the address by using some operations other than arithmetical addition.

Breaking down the original offset into parts, padding with zeros, and sign extensions may be hypothetical operations; on an actual device, they may be performed without transporting data to new registers, etc.

The details of the remaining steps of computing the address, as well as other stages of executing the operation in which this calculated address is used, are not shown in this figure because they will be determined by the person skilled in the art who implements this invention on her device, and they are outside the scope of this patent application.

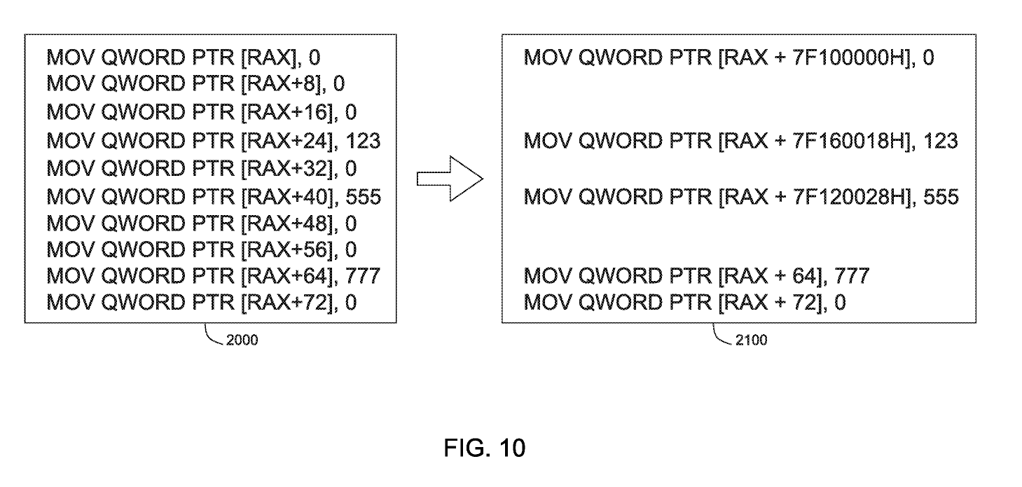

FIG. 10

This figure demonstrates an example of an improvement on a program that initializes some data structure consisting of 10 machine words, which allows the eliminations of 5 commands that write zeros to memory by transmitting additional information through a logical address.

This improvement uses the command to clear the tail of a cache line, which is described in detail in the section “Reducing the Number of Zero Entry Operations”, which is transmitted to the computer device through bits of additional information in the extended offset described in the section “Extended

Offsets”.

This figure displays the original program to initialize a data structure with a length of 10 machine words, which is generated by the compiler of some object-oriented programming language such as C++. This program is designated as 2000 in the figure.

The supposed machine command:

MOV QWORD PTR [RAX+offset], value

from the set of which this program consists, writes the immediate value “value” to the address obtained by adding the base register “RAX” and the offset “offset”.

Assume that this computer device is 64-bit, and a line of its cache memory has a length of 64 bytes and consists of eight machine words. A person skilled in the art can easily change this example for any other device that implements the proposed technical improvement.

Thus, the original program consists of 10 instructions to write to memory, which instantiate the fields of some object. In object-oriented programming, the elementary objects of which more complex data structures consist are very often instantiated with zeros. Therefore 7 of the 10 instructions to write to memory in this example are to write zeros.

This improvement is inapplicable to write operations for the very first cell of a series (it must be saved and flagged as a line tail cleaner, even if it writes a zero) and to write operations for the last portion of data. If the length of the last portion is less than the length of a cache line, then these last operations must also be saved.

Therefore, this preserves the very first write operation and the two last write operations. Furthermore, two more operations in this hypothetical example write non-zero values—they must also be preserved.

Next it is shown how, by transferring additional information, it is possible to eliminate 5 superfluous zero entry commands. With luck, one reading of the cache line from memory will also be eliminated during the execution of the new program.

This device supports transmitting a command to clear the tail of the current cache line through high-order bits of the logical address, and it parameterizes this command by the quantity of previous zeros.

Suppose that in order to use this command it is necessary to place a one in the 60th bit of the logical address (starting the numeration from zero), but the quantity of previous zeros must be placed within the 57th to 59th bits of the logical address.

If the 32-bit extended offsets have 7 verification bits and 7 higher part bits, then their binary representation will have the following format (for this example):

“0111 1111 HHHH HHHL LLLL LLLL LLLL LLLL”

where “H” signifies a bit of the higher part of the extended offset, and “L” signifies a bit of the lower part.

Since the fourth bit “H” must contain a signal to clear the tail of a cache line, and the next three bits must encode the quantity of preceding zeros (they are labeled “Z”), then the final offsets take on the following binary format:

“0111 1111 0001 ZZZL LLLL LLLL LLLL LLLL”

The very first write command cannot be eliminated, and it must contain the signal to clear the tail of the line with the zero parameter Z. Its offset is equal to zero; therefore, its extended offset will appear as follows:

“0111 1111 0001 0000 0000 0000 0000 0000” or 7F100000₁₆

For the first write command, which writes a non-zero value, the parameter “Z” is equal to 3 (“011” in binary), since 3 null words must be written in front of it, but its offset is equal to 24 (or “0001 1000” in binary). Therefore, its extended offset will appear as follows:

“0111 1111 0001 0110 0000 0000 0001 1000” or 7F160018₁₆

For the second write command, which writes a non-zero value, the parameter “Z” is equal to 1 (“001” in binary), since one null word must be written in front of it, but its offset is equal to 40 (or “0010 1000” in binary). Therefore, its extended offset will appear as follows:

“0111 1111 0001 0010 0000 0000 0010 1000” or 7F120028₁₆

The hypothetical assembler uses the suffix “h′ to write hexadecimal numbers, and the final program is designated as 2100 in the figure.

The first write operation has been transformed into a command to write and clear the tail of the cache line. Here two operations that write non-zero values are also preserved, and also supplemented with the option to clear the tail of the line while skipping several preceding zeros. Furthermore, left unchanged are the last two operations to write a partial data portion.

However, using additional information and acting according to the rules described in the section “Reducing the Number of Zero Entry Operations”, the computer device always writes the values into memory in the correct form—also, as when executing the original program, it does not depend on how the address value located in the register “RAX” is aligned relative to the start of the cache memory line (naturally, if the alignment does not destroy the boundaries of machine words).

In this regard, it is important to note that if this data structure covers one of the cache lines, then that line will not be read from memory, but will be erased (if it is not in the cache). This helps to save one RAM access.

FIG. 11

This design demonstrates the structure of a logical address of a supposed 64-bit device that is similar to an x86 family processor that has been upgraded for immediately addressing all address spaces simultaneously without switching contexts, it supports direct addressing of physical memory (accesses memory with no latency, bypassing MMU and TLB blocks), and also simultaneously uses 5-level and 4-level translation of addresses without switching operating modes (for different address spaces).

In this regard, this device has not lost the capability to transmit additional information through a logical address and can still implement other improvements from this patent application.

This figure shows four different logical address structures that are supported by this device—in order to obtain different advantages during its operation:
1) A linear (virtual) address that points to a memory cell in the current address space;
2) A linear (virtual) address that points to a memory cell in one of eight very large 57-bit address spaces;
3) A linear (virtual) address that points to a memory cell in one of 28,608 regular 48-bit address spaces;
4) A 48-bit physical address to access memory with zero latency, bypassing the MMU and TLB blocks.

In this regard, the linear address in the current address space (1) and the physical address (4) contain 6 free bits, which may be used to carry additional information described in this patent application.

Let us examine these four addresses in detail:

The first logical address is used in the main part of the code of application programs for this device and as a whole are fully compatible with the logical address of normal x86 family processors.

This address differs from all the other addresses in the zero value of the high-order bit, designated as 4000 in the figure. If the computer device sees that the address contains a zero in the high-order bit, then next it interprets the address structure just as described in this part of the figure.

The high-order bit is reserved in current implementations of x86 family processors, and now it is also equal to zero. This does not create any sort of incompatibility.

The low order 57 bits of the logical address are designated as 4400 in the figure, and they make up a normal linear (virtual) address of a memory cell within the current address space. This linear address is labeled “L₅₇” to emphasize its maximum possible bit length.

If the current address space uses 5-level virtual memory address translation, then all these bits will carry useful information. If the current space uses 4-level virtual memory address translation, then the 9 high-order bits of this address will simply be equal to zero.

In order to improve this device, its logical address has been supplemented with bits of additional information, which are labeled “EXT”. These bits are designated as 4300 in the figure. They may be used to carry any additional information described in this patent application.

For normal x86 family processors, there bits are reserved, and now they contain zeros. They may also be left as zeros for all applications that do not use special solutions from this patent application.

The second logical address points not simply to an object in the current address space, but to an object in any of the 8 very large 57-bit address spaces that used 5-level virtual memory address translation.

The high-order bit of this address, which is designated as 400 in the figure, must be equal to one in order to distinguish it from an address in the current address space.

However, it is also necessary to distinguish this address from other types of address, therefore there follow three more characteristic bits of a signature, which are designated as 4100 in the figure.

If they are zeros, then this address points to one of the 57-bit spaces. In other words, such addresses (taking into account the high-order bit) begin with the sequence “1000” in the high-order bits.

In this case, the next three bits, which are designated as 4200 in the figure, contain the identifier of the specific 57-bit space. This identifier is labeled “ASID_{VL}” (“Address Space Identifier for Very Large spaces”).

Next follows the linear (virtual) address within this space, which is labeled “L₅₇”. This is a 57-bit value and is designated as 4400 in the figure.

Using this address, the system software is able to access any memory cell from the eight very large address spaces.

The third logical address points to an object in one of 28,608 48-bit address spaces, which use fast 4-level virtual memory address translation.

The vast majority of programs do not need very large 57-bit spaces, which are relevant only for ultra-large databases and supercomputer applications. Therefore, the linear (virtual) address in this space occupies 48 bits, which allows use of the faster 4-level virtual memory address translation.

This linear address is labeled “L₄₈”, it is designated as 4500 in the figure.

The high-order bit of this address, which is designated as 400 in the figure, must be equal to one in order to distinguish it from an address in the current space.

In this case, the address space identifier is a 15-bit value, which is labeled “ASID” and designated as 4201 in the figure.

However, it is necessary to distinguish this address from an address in the 57-bit space somehow. To this end, the value “ASID” is separated into two parts, which are labeled “ASID_{H}” and “AS/D_{L}”. The three high-order bits, which are designated as 4100 in the figure, are in the same place as the signature of the address in the 57-bit space. These three bits contain “ASID_{H}”, and they do not need to be equal to zero (so that they do not match the signature of the address in the 57-bit space).

The low-order bits “AS/D_{L}” occupy 12 bits and are designated as 4101 in the figure.

In such an organization, the values of ASID for 48-bit spaces are always located within the range from 4096 to 32,703 inclusive (why not to 32,767—see below).

Finally, the fourth logical address is an address in physical memory.

Of course, it is intended for use only within system software, since it unlocks unlimited access to all physical memory cells, ignoring the boundaries of applications.

It may be used by the operating system to momentarily access RAM, bypassing the MMU and TLB blocks, without competing for access to them, without verifying the presence of elements in the TLB, without checking access rights, etc.

Of course, normally this will not be access to physical memory directly, but access to it through a caching subsystem, to improve speed. This is without all the application costs of virtual memory address translations.

The physical address of a memory cell itself is 48-bit and its content bits are labeled as “P₄₈” and designated as 4600 in the figure.

In order to distinguish it from all other addresses, its highest order bit, designated as 4000 in the figure, is equal to one, and the next three bits, which contain “000” for address in 57-bit spaces or “ASID_{H}” for addresses in 48-bit spaces, should also be equal to ones (“111”). They are designated as 4100 in the usual way in the figure.

However, in order to distinguish the physical address from an address in a 48-bit space, there are 6 bits that follow it, which are designated as 4102 in the figure, and these bits also contain ones.

Since they are located in the same place as the “ASID_{L}” of a 48-bit address, this limits the threshold value of “ASID” to 32,703 instead of 32,767. Sixty-four values were loss, but this made it possible to directly address physical memory.

As a result, such an address begins with ten ones—its high-order bits are equal to “1111111111”. Alternatively, it is possible to consider that here are the values of “ASID” that fall within the range from 32,704 to 32,767.

In order to be able to use different extensions from this patent application with physical memory addresses, bits of additional information have been provided, which are labeled “EXT_{P}” and designated as 4700 in the figure.

These bits do not need to have the same structure as the “EXT” bits of logical addresses in the current address space (although they may be compatible with one another, at the discretion of a person skilled in the art).

Bits “EXT_{P}” may also be used to restrict access, for example, they may contain a bit that prohibits writing and/or a bit that prohibits execution.

A person skilled in the art who implements this invention on her device may change these proposed figures, exclude some of them, or come up with different types of addresses, other methods of encoding “ASID” identifiers, etc. This figure is merely used to illustrate a number of possibilities that this invention unlocks.

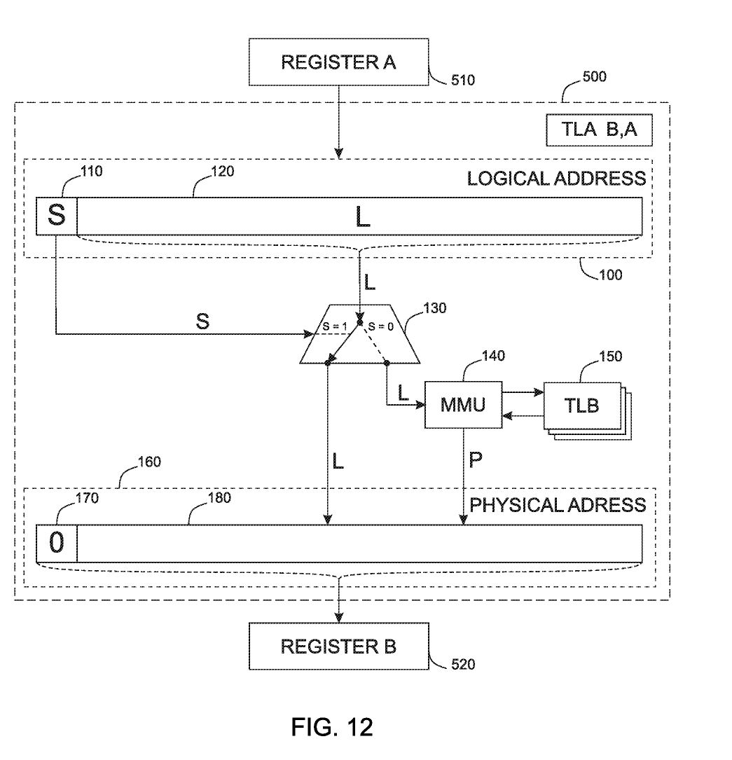

FIG. 12

This figure demonstrates an example of implementing an address translation executable operation for a computer device with registers.

In this figure the hypothetical command “TLA B, A” (which is designated as 500 in the figure) is designed to translate the logical address contained in the register “A” into a physical address, the value of which will be written into register B.

The register with the original logical address is designated as 510 in the figure, the register with the result of the execution of the instruction, which will contain the physical address, is designated as 520.

The address translation process itself, shown in this figure, precisely matches the process shown in FIG. 5, which is described in the corresponding section of this patent application.

However, the physical address obtained as a result of the translation is not used to access memory (as in FIG. 5), but is written into register “13” (which is designated as 520 in this figure) and returned to the program.

The processing of exceptions during the execution of this command is determined by a person skilled in the art and is not shown in the figure, since the details of its implementation are outside the scope of this patent application.

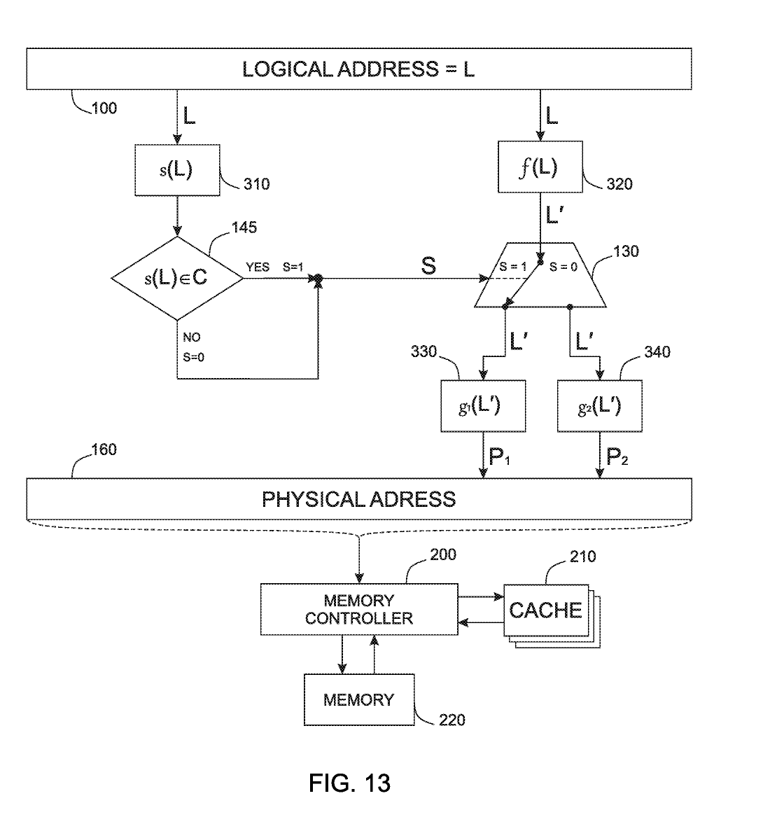

FIG. 13

This scheme demonstrates the operation of a computer device that dynamically switches between two different address translation methods during the execution of an executable operation.

Let the logical address of this device (which is designated as 100 in the figure) be labeled V.

This device submits a logical address (value “L”) as an input to some function “s(L)”, designated as 310 in the figure.

In parallel with this, the value “L” is submitted as an input to another function “f (L)”, designated as 320 in the FIG. 320, the result of the operation of which is labelled as “L′”:

L′=ƒ(L)

The function “ƒ(L)” may, for example, delete from a logical address additional information that is necessary only for the operation of the function “s (L)” . In the limiting case, the function “ƒ(L)” simply returns the value “L” as “L′” unchanged.

Then the result of the function “s(L)” is checked for whether it belongs to some set of values, which we designated as “C”.

If the result “s(L)” belongs to the set “C”, then in the condition verification block, designated as 145 in the figure, some value “S” is generated equal to one, but if the result does not belong—then the value “S” is equal to zero.

The value “S” controls the operation of the switcher (which is designated as 130 in the figure) that determines to which block the value “L′” will be passed.

If the value “S” is equal to one (that is, if s(L) E C), then “L′” is submitted as the input to the function “g₁(L′)”, which is designated as 330 in the figure, but if the value “S” is equal to zero (that is, if s(L) ∉ C)—then the input is to another function “g₂ (L′)”, which is designated as 340 in the figure.

The functions “g₁(L′)” and “g₂(L′)” constitute implementations of two different address translation methods that translate the value “L′” into the physical address of a memory cell. These addresses are labelled “P₁” and “P₂” respectively.

Then a physical address is generated (which is designated as 160 in the figure), that constitutes the value “P₁” or “P₂”, to the memory controller (designated as 200 in the figure), which accesses RAM (designated as 220 in the figure) using this address, and interacting with cache memory (designated as 210 in the figure) when necessary.

The details of the device of functions “s(L)”, “ƒ(L)”, “g₁(L′)”, “g ₂(L′)”, as well as the modules memory controller, cache memory, the specific organization of memory, and the details of the process of accessing memory are all outside the scope of this patent application, and are to be determined by developers of a specific computer device; therefore, they are not shown in the figure.

Of course, as stated in the preamble of the patent application, in a real device all these functions can be implemented using some kind of circuits, schemes, or in some other way.

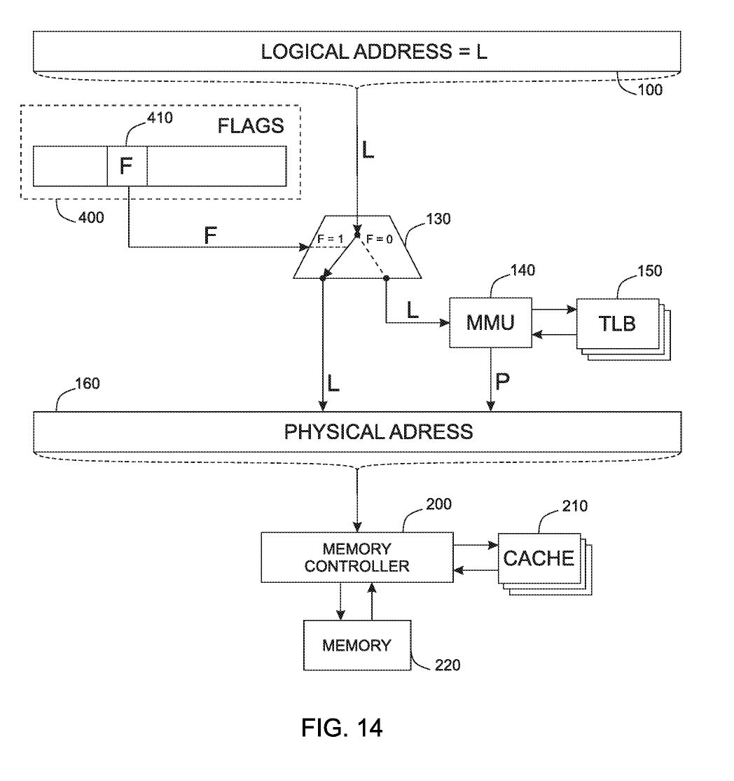

FIG. 14

This scheme demonstrates the operation of a device that dynamically selects the address translation method in order to provide the capability to access memory both directly using physical addresses, and using linear addressing by a page mechanism (and TLB cache).

This device selects an address translation method by checking some flag or status field value, if such a value occurs only in a specific context that can be established and closed using specific executable operation(s) that create or close such a local context, and that do not lead to switching the device's mode of operation, and also do not cause a reset of the internal data structures of this device.

We emphasize that this is a flag (or status field) whose value may be effectively changed using special or general-purpose operations that establish or close a specific local context and which do not lead to a global switch in the mode of operation of this device (or one of its cores, or the virtual devices emulated by this device). And if we are talking about the state field, then this state is not just a reflection of the current (global) mode of address translation.

Let the logical address of this device (which is designated as 100 in the figure) be labeled V.

The value of the flag designated as 410 in the figure is taken from the register of flags (which is designated as 400 in the figure) of the computer device. This value is labelled “F”.

The value “F” controls the operation of the switcher (designated as 130 in the figure), which determines where the logical address (value “L”) will be passed.

If the value “F” is equal to one, then the value “L” is interpreted by the device as the physical address of a memory cell.

If the value “F” is equal to zero, then the value “L” is interpreted by the device as the linear address needed by a page translation.

In this case, it is submitted as an input to the memory management unit (MMU, which is designated as 140 in the figure).

The MMU translates a linear address into a physical address using page tables, accessing the TLB cache (which is designated as 150 in the figure) when necessary.

As a result of the operation of the MMU, the value “L” is translated into the value of a physical address, which is designated as “P”.

Then the generated physical address (which is designated as 160 in the figure), which constitutes the value “L” or the value “P”, to the memory controller (designated as 200 in the figure), which accesses RAM (designated as 220 in the figure) using this address, and interacting with cache memory (designated as 210 in the figure) when necessary.

The details of the device of modules MMU, TLB cache, memory controller, cache memory, the specific organization of memory, and the details of the process of accessing memory are all outside the scope of this patent application, and are to be determined by developers of a specific computer device; therefore, they are not shown in the figure.

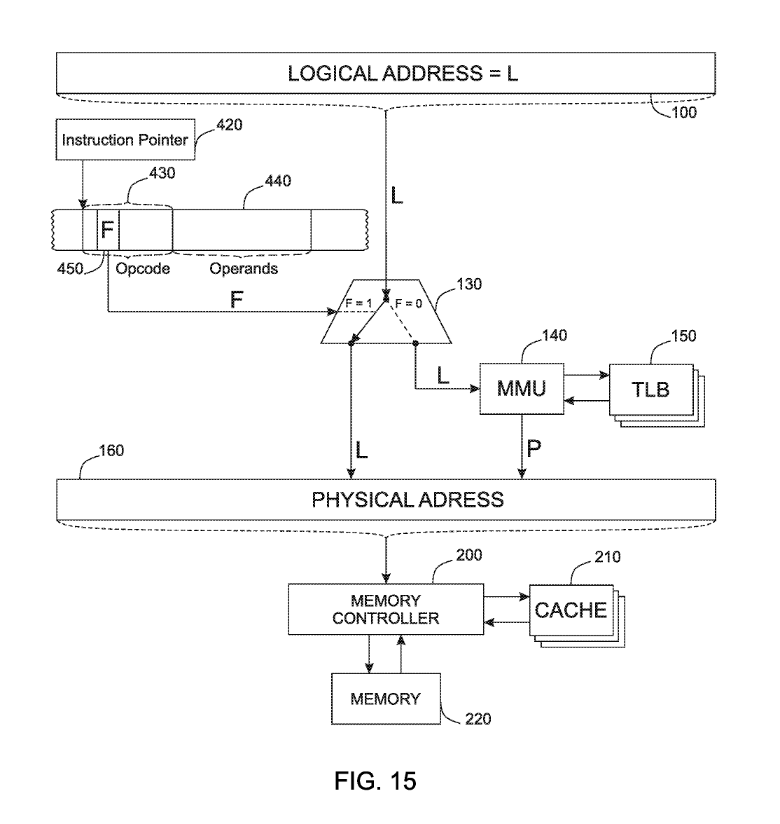

FIG. 15

This scheme demonstrates the operation of a device that dynamically selects the address translation method in order to provide the capability to access memory both directly using physical addresses, and using linear addressing by a page mechanism (and TLB cache).

This device selects an address translation method by checking some bit in the machine representation of an executable operation.

In this example, such bit is represented by a flag (which is designated as 450 in the figure) that is included in the code of the executable operation (which is designated as 430 in the figure). The value of this flag is labelled “F”.

The executable operation code is followed by the machine representation of its operands, which is designated as 440 in the figure.

The structure (values, coding) of the operation's and operands' code are not detailed in the figure, since the methods of coding executable operations are determined by the developers of the specific computer device that uses this invention, and are outside the scope of this patent application.

Let the logical address of this device (which is designated as 100 in the figure) be labeled V.

The computer device has in its composition a register for the pointer to the current executable operation, which is designated as 420 in the figure.

During the execution of the program, the computer device reads the machine representation of the operation, starting with the address to which the current operation address register points, and then extracts from the operation's code the value of the flag “F”.

The value “F” controls the operation of the switcher (designated as 130 in the figure), which determines where the logical address (value “L”) will be passed.

If the value “F” is equal to one, then the value “L” is interpreted by the device as the physical address of a memory cell.

If the value “F” is equal to zero, then the value “L” is interpreted by the device as the linear address needed by a page translation.

In this case, it is submitted as an input to the memory management unit (MMU, which is designated as 140 in the figure).

The MMU translates a linear address into a physical address using page tables, accessing the TLB cache (which is designated as 150 in the figure) when necessary.

As a result of the operation of the MMU, the value “L” is translated into the value of a physical address, which is designated as “P”.

Then the generated physical address (which is designated as 160 in the figure), which constitutes the value “L” or the value “P”, to the memory controller (designated as 200 in the figure), which accesses RAM (designated as 220 in the figure) using this address, and interacting with cache memory (designated as 210 in the figure) when necessary.

The details of the device of modules MMU, TLB cache, memory controller, cache memory, the specific organization of memory, and the details of the process of accessing memory are all outside the scope of this patent application, and are to be determined by developers of a specific computer device; therefore, they are not shown in the figure.

Note that in order to read the machine representation of the executable operation to which the register of the current operation's address points, the computer device may also use one of the techniques described in this patent application.

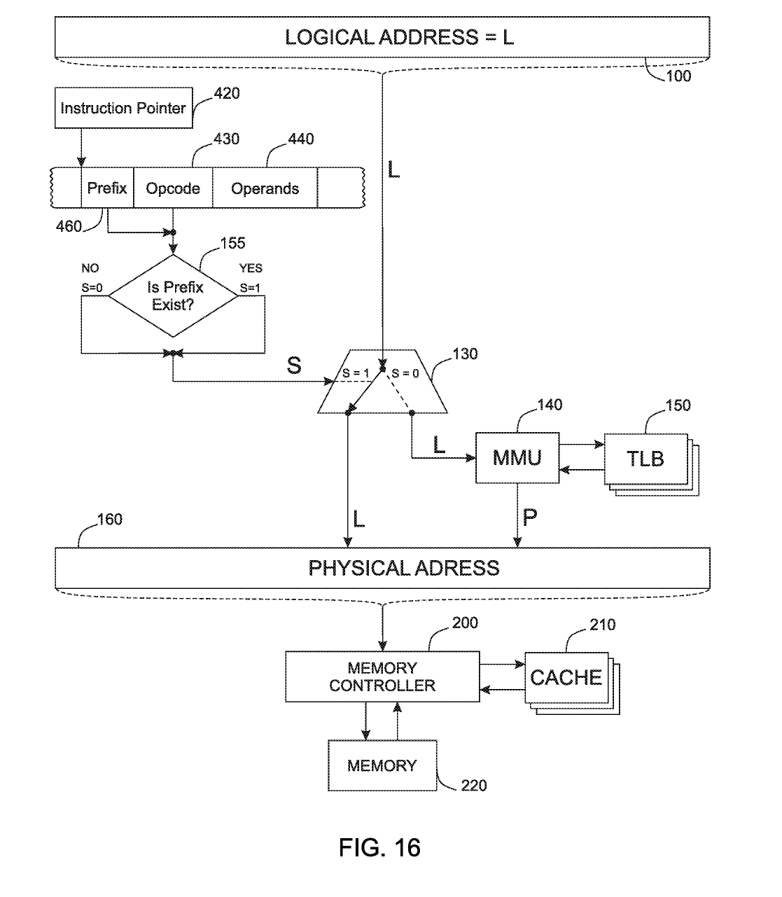

FIG. 16

This scheme demonstrates the operation of a device that dynamically selects the address translation method in order to provide the capability to access memory both directly using physical addresses, and using linear addressing by a page mechanism (and TLB cache).

This device selects an address translation method by checking for the presence of a specific prefix preceding an executable operation's code.

In this example, the computer device checks for the presence of a certain prefix (which is designated as 460 in the figure) that precedes the code of the executable operation (which is designated as 430 in the figure).

The executable operation code is followed by the machine representation of its operands, which is designated as 440 in the figure.

The structure (values, coding) of the prefix, operation's and operands' code are not detailed in the figure, since the methods of coding executable operations are determined by the developers of the specific computer device that uses this invention, and are outside the scope of this patent application.

Let the logical address of this device (which is designated as 100 in the figure) be labeled V.

The computer device has in its composition a register for the pointer to the current executable operation, which is designated as 420 in the figure.

During the execution of the program, the computer device reads the machine representation of the operation, starting with the address to which the current operation address register points.

If the executable operation's code in machine representation is preceded by the necessary prefix, then in the condition verification block, designated as 155 in the figure, some signal “S” is generated equal to one, but if the necessary prefix is absent, then the signal “S” is equal to zero.

The signal “S” controls the operation of the switcher (designated as 130 in the figure), which determines where the logical address (value “L”) will be passed.

If the signal “S” is equal to one, then the value “L” is interpreted by the device as the physical address of a memory cell.

If the signal “5” is equal to zero, then the value “L” is interpreted by the device as the linear address needed by a page translation.

In this case, it is submitted as an input to the memory management unit (MMU, which is designated as 140 in the figure).

The MMU translates a linear address into a physical address using page tables, accessing the TLB cache (which is designated as 150 in the figure) when necessary.

As a result of the operation of the MMU, the value “L” is translated into the value of a physical address, which is designated as “P”.

Then the generated physical address (which is designated as 160 in the figure), which constitutes the value “L” or the value “P”, to the memory controller (designated as 200 in the figure), which accesses RAM (designated as 220 in the figure) using this address, and interacting with cache memory (designated as 210 in the figure) when necessary.

The details of the device of modules MMU, TLB cache, memory controller, cache memory, the specific organization of memory, and the details of the process of accessing memory are all outside the scope of this patent application, and are to be determined by developers of a specific computer device; therefore, they are not shown in the figure.

Note that in order to read the machine representation of the executable operation to which the register of the current operation's address points, the computer device may also use one of the techniques described in this patent application.

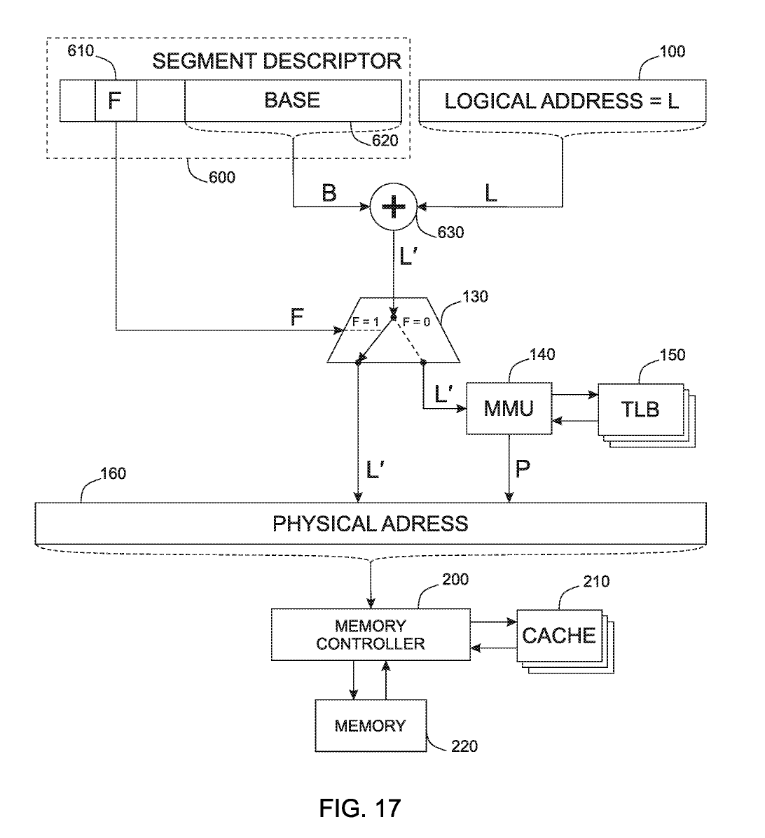

FIG. 17

This scheme demonstrates the operation of a device that dynamically selects the address translation method in order to provide the capability to access memory both directly using physical addresses, and using linear addressing by a page mechanism (and TLB cache).

This device selects an address translation method by checking some bit in the segment descriptor of a computer device that supports segment addressing (or similar technology).

In this example, such bit is represented by a flag (which is designated as 610 in the figure) that is present in the segment descriptor (which is designated as 600 in the figure). The value of this flag is labelled “F”.

The segment descriptor also contains the base address (which is designated as 620 in the figure). The value of this base address is labelled “B”.

Let the logical address of this device (which is designated as 100 in the figure) be labeled V.

In accordance with segment addressing logic, this computer device adds the value of the base address “B” to the value of the logical address “L” using an adder, which is designated as 630 in the figure. The result of this addition is an effective logical address, which is labelled “L′”:

L′=B+L

The value “F” controls the operation of the switcher (designated as 130 in the figure), which determines where the effective logical address (value “L′”) will be passed.

If the value “F” is equal to one, then the value “L′” is interpreted by the device as the physical address of a memory cell.

If the value “F” is equal to zero, then the value “L′” is interpreted by the device as the linear address needed by a page translation.

In this case, it is submitted as an input to the memory management unit (MMU, which is designated as 140 in the figure).

The MMU translates a linear address into a physical address using page tables, accessing the TLB cache (which is designated as 150 in the figure) when necessary.

As a result of the operation of the MMU, the value “L′” is translated into the value of a physical address, which is designated as “P”.

Then the generated physical address (which is designated as 160 in the figure), which constitutes the value “L′” or the value “P”, to the memory controller (designated as 200 in the figure), which accesses RAM (designated as 220 in the figure) using this address, and interacting with cache memory (designated as 210 in the figure) when necessary.

A person skilled in the art can easily generalize this scheme to another device, which instead of segment descriptors uses descriptors of some other objects associated with the address to be converted in the manner described in this patent application.

The details of the device of modules MMU, TLB cache, memory controller, cache memory, the specific organization of memory, and the details of the process of accessing memory are all outside the scope of this patent application, and are to be determined by developers of a specific computer device; therefore, they are not shown in the figure.

Rapid Implementation of this Invention

This section discusses several techniques for the rapid implementation of this invention, if it is implemented by including additional information in logical addresses.

An additional channel to transmit useful information to a computer device may be organized through not only logical addresses, but also using prefixes or suffixes of executable operations. Furthermore, information transmitted in it may be supplemented or modified by analyzing the context within which these operations were encountered or are executed.

However, this section discusses only the most complex technology of this invention's implementation, which is based on using logical addresses, since incorrectly implementing this could potentially lead to incompatibility with existing software.

Marked Pointers

If a pointer, which is the address of data or an executable operation, is supplemented with additional information, then such pointer or address will be called “marked”.

If a solution from this invention is implemented using the transfer of additional useful information through a logical address, then the relevant attributes may be included once in the pointer for which the program accesses data, and then they will be sent to the computer device during every access to memory using this pointer as a base address.

The use of logical addresses to transmit additional information, proposed herein, helps to avoid multiple inclusions in the program of the same additional instructions for controlling caching, prefetching, or synchronization associated with the same object because the address of such an object, containing control attributes or commands, can be calculated once, but then used many times in different operations to access memory or transfer control.

In particular, if the logical address includes information that controls caching or prefetching, then it is not necessary to include special instructions for controlling caching multiple times in the program, nor is it necessary to change the parameters of the entire memory page on which a few hundred lines are located, each of which may require their own individual attributes of caching or prefetching.

However, if the computer device supports adding additional offsets to the base address, then it is possible to change the manner of caching or prefetching in each individual access to memory even without modifying the base address—by adding necessary information to the offset.

Information that affects speculative execution may be transmitted in a similar way. For example, even if it is difficult to change the processor command system so that conditional control transmission commands include an additional bit indicating a higher probability of a branch, then the missing information can be transmitted through high-order bits of the logical address for which the transmission is performed. Or through high-order bits of the offset in the control transmission command.

In this regard, the inclusion of additional information in the logical address may be done by the compiler itself (if it has enough information) hidden from the programmer, or it may be done explicitly by specifying additional attributes when declaring pointers or when translating pointer types.

Furthermore, new memory control functions may be added to the standard library. For example, the memory allocation function, which will return “marked” pointers for the newly allocated memory. In this regard, in the future, the programmer can use these pointers normally in normal memory access operations, but each time they are used additional information will be transmitted to the computer device, which uses it to control caching, prefetching, etc.

Marked pointers that contain additional information (for example, in high-order bits) may be created not only by special memory allocation functions, but also by using trivial logical and/or arithmetical operations.

To simplify the following discussion, assume that pointers address bytes in memory, and they may be handled as integers.

Then if, for example, the 62nd bit of a pointer signals that it is necessary to disable caching, then the marked pointer “x_{cd}” may be obtained from a normal pointer “x” using the following calculations:

x_{cd}=x+(1<<62)

or:

x_{cd}=x∨(1<<62)

where the operator “<<” signifies a logical left shift, and the operator “∨” signifies a logical “or”.

In the general case, if the additional information “y” must be placed in high order bits of a normal pointer “x” that begins with bit number “n” (if the bit numbering starts at zero), then the marked pointer “x_{marked}” may be obtained from a normal pointer “x” in the following form:

x_{marked}=x∨(y<<n)

If it is necessary to translate a marked pointer back into a normal one, then the additional information may be erased using elementary logical and/or arithmetical operations, for example, in the following format:

x=x_{marked}∧((1<<n)−1)

where the operator “∧” signifies a logical “and”. In a similar way, the information may be replaced with new information, thereby obtaining a new pointer “x_{new}”:

x_{new}=(x_{marked}∧((1<<n)−1))∨(y<<n)

A high level language compiler may also provide special attributes to mark pointers, and while using them it independently adds the necessary actions to the program (for example, when casting pointer types).

For example, in the popular compiler “gcc” it is possible to add the following attribute (and other similar attributes):

int*_attribute_((disable_caching)) array =malloc( . . . );

Having witnessed a point type change and the appearance of a new attribute, the compiler adds the necessary actions to machine code, for example, it sets the 62nd bit of the pointer to one (if it disables caching).

The linker and/or loader of the operating system may also be improved in this way, in order to modify some pointers to enter additional useful information in them during the assembly and loading of program code. However, support for this invention at the linker or loader level is not necessary in the majority of systems.

It is important to emphasize that for the majority of programs marked pointers are completely indistinguishable from normal pointers. In the vast majority of cases, existing code requires neither modification, nor recompilation in order to use the new pointers.

It is sufficient to include the relevant information once in the logical address and then each access using this address as the base address will be accompanied by transmitting this additional useful information to the computer device.

Changes to the main part of programs' code are necessary only in order to initially obtain pointers with additional information: it is necessary to call new memory allocation functions or to change and recompile the declarations of the variables themselves in which the pointer values are stored (so the compiler can add trivial logical or arithmetical operations to mark them, or instructions for the linker or loader).

However, small amendments and changes to the memory control functions in the standard library may be required.

In particular, an adapted memory deallocation function may clear high-order bits of the pointer before using it.

Security risks are created by only one extreme possibility (affecting the associative set selection), and only in the system code. For application programs, there is an elegant solution that reduces these risks (it is described in the section “Controlling Associative Sets for Application Programs”).

There are only two known potential incompatibilities that may arise from the use of marked pointers in an application program:
1) When using some cache control technologies, a marked pointer may not be directly passed to a normal (not adapted to account for this invention) memory deallocation function.
   In the majority of cases, it is sufficient to clear the high-order bits of the pointer to the released memory block using an elementary logical or arithmetical operation, in order to subsequently work with them in a normal manner.
   However, if the caching attributes affect the selection of an associative set, then it may be necessary to clear the corresponding lines of cache memory (see details in the next section).
2) There may exist programs that store certain additional data in the high-order reserved bits of pointers. Such programs may suffer during any innovation in a processor's addressing circuits; therefore, they may require modifications to be used with this invention.

The use of reserved pointer bits in application software is usually prohibited in the processor's documentation and is considered to be bad practice among programmers; however, such programs are potentially possible, and they necessitate changes.

Eliminating Competition between Large Data Structures for Associative Sets

The section “Background of Invention” describes in detail how conflicts for the same associative sets within cache memory may reduce a computer device's speed.

To eliminate this problem when using this invention, memory allocation functions may be added to the standard library that return these pointers, use of which does not cause collisions due to sharing the same associative sets within cache memory between different arrays or other data structures in a program that works with large volumes of information.

These pointers will contain additional information that affects the selection of the associative set within cache memory, which will be used to work with the array or data structure addressed by it.

Knowing precisely which arrays or data structures are read or written “in parallel” with one another and can therefore compete for the same associative sets, the programmer can assign them different tags, the numerical values of which will be included in the logical address and affect the selection of associative sets, which eliminates competition.

In a number of cases, this analysis may be performed by a high-level language compiler without human participation.

Below is a description of the rules for using tags that control associative set selection in system software that bypasses the page mechanism. For user programs and data in virtual memory there is a more elegant solution, which is described in the following section “Controlling Associative Sets for Application Programs.”

When implementing associative set selection using a tag in a logical address, one should bear in mind that this technology may lead to problems if both a normal pointer and a pointer marked with a tag are used to address the same cache memory line.

The fact is that in this case, the same data may fall into two different associative sets within cache memory—into one where it would fall when using a standard caching algorithm, and into another where it would fall when using additional information included in a pointer with a tag.

If one line of cache memory contains two blocks, one of which is addressed by a normal pointer, and the other by a marked one, then this leads to a conflict and destroys the data's integrity. Similarly, there will be problems if a line is part of a page that is copied entirely by a normal pointer to it. A problem will also arise if the address of such a page will be transmitted to an external device.

In order to prevent such conflicts in system software created by qualified developers, it is sufficient to adhere to three rules:
1) A memory block that is addressed by a pointer with a tag absolutely must begin with an address whose value is a multiple of the cache line length and the length of such a block must also be a multiple of the cache line length.
   Normally observing this rule is not a problem, since pointers with tags are necessary only to work with very large volumes of data, which are distributed to addresses whose values are multiples of the cache line length (or even the page length).
   Alternatively (as a variant) adjacent memory blocks must use the same tags. If, for example, a separate memory pool is used for each tag value, then the blocks within this pool may not be aligned with the line boundaries.
2) Before releasing the memory block to which the marked pointer pointed, it is necessary to release the lines of cache memory that correspond to it.
   Normally this rule is also easy to follow—although a cycle over memory block to release its corresponding lines does take time, but, firstly, this is done once (upon the completion of work with such memory block), and secondly, the positive effect of releasing space in the cache generally makes up the costs of the cycle through lines.
3) The first rule must be strengthened at the page level (instead of cache lines). In the opposite case, a page with such data must not be copied and used in the normal manner in input-output operations. If alignment of tagged pointers is not strengthened to page level, then impossible to copy pages entirely, and either they must be resident and not participate in input-output operations, or special instructions must be added to the device's command system, for example, to write back and invalidate a cache line, looking at all associative sets at once.

Developers of system libraries with memory control functions must take these rules into account (or think up alternative rules that guarantee the absence of conflicts) if they implement the tagged pointer's technology described in this patent application to speed up operation by eliminating competition for associative sets.

Controlling Associative Sets for Application Programs

When implementing the control of associative set selection for application programs through logical addresses, there arise conflicts, even if the rules for using such addresses are described. This is because the user can ignore the rules and destroy data integrity.

Therefore, a transparent, elegant, and safe solution is proposed for such programs.

A computer device is described that is characterized by the fact that, as the source of additional data for the associative set selection algorithm it uses a tag, the value of which is read from a page table (or directory) element (or from special cache memory, such as TLB, where data read from page tables is saved).

When an application or system program orders memory under the control of the page mechanism for a large data structure, for which it would want to use a tag that affects associative set selection (as described in this patent application), it transfers the value of this tag to the operating system.

The operating system places this tag into page table (or directory) elements that are responsible for the memory allocated for this structure.

Then this tag value will be read by the MMU during address translation and used as additional information that affects associative set selection in such a way as described in the section “Reducing the Probability of Collisions when Working with Associative Cache Memory.”

Every access of this page that passes through the MMU will automatically use the same tag value, and no conflicts will arise.

Before releasing the page frame belonging to the page with such a tag, the operating system erases all cache lines that are occupied with obsolete data, and also avoids conflicts.

This solution is safe, since application programs do not have direct access to page tables and cannot themselves create another pointer for this page (with a different tag), bypassing the operating system. If the system itself wants to create another address for the same data, then it copies the source value of the tag.

If the system wants to access this data through a physical memory address, then it either translates the tag into a logical address (as described in this patent application), or it writes back to memory and/or changes the cache lines that correspond to this page (for example, before an input-output operation).

In any case, every access of data on a page with a tag from any part of the system either will be performed with the same tag value (read from the page table element), or will be controlled by the operating system, which knows that associative set number for the entire page.

Thus, in this section described a computer device that a uses a specific field(s) in the page table (directory) element (in the page descriptor or other similar structure) to store information in it that helps this device reduce the likelihood of collisions when working with associative memory (such as cache memory).

Operation to Add Useful Information

This section describes a computer device that is characterized by the fact that it provides for an executable operation (in particular command, instruction, order, operator, or function, both imperative ones, and ones that control data processing) that supplements the indicated logical address or its component(s) (for example, a logical, linear, virtual, or other address at which an executable operation (in particular command, instruction, order, operator, or function, both imperative ones, and ones that control data processing) or data processing operation operates, the component(s) of such address, or offset relative to some base address (including relative to an Instruction Pointer), regardless of whether such an address, or an address component or offset, is used directly, or as part of information to calculate another (effective) logical address, or they themselves constitute an effective address or were extracted from a calculated effective address) with additional information, possibly transforming the source information and/or resulting address using some function (function, scheme, circuit, or algorithm, including those implemented in microcode, in hardware, and/or in software, including using additional information and/or data structures).

The person skilled in the art determines whether such executable operation will modify the entire logical address or only certain component(s) of such address (including the offset).

Subsequent discussions in this section will mean by logical address the address or the part of address information that the person skilled in the art selected to implement this invention on her device.

If an additional channel to exchange useful information is implemented using logical addresses, then it is desirable to be able to rapidly translate any normal address into a new address, corresponding to it, that carries useful information.

The simplest and most appropriate for the majority of devices implementation of an additional channel provides for the placement of additional information in high-order bits of a logical address.

As discussed above in the section “Marked Pointers”, in this case it is possible to use elementary arithmetical and/or logical functions to add or change additional information.

However, such manipulations of additional information require the use of long constants. For example, 64-bit constants are necessary for 64-bit pointers.

A processor may not have commands to load a long 64-bit constant into a general-purpose register (without using an additional variable in memory), and then several machine commands to load such constant are necessary. In any case, the command to load a 64-bit constant itself takes up many bytes in machine code.

In order to avoid working with long 64-bit constants, it is possible to use short constants that are more effectively supported by a given processor, and to use a shift command in order to relocate the short constant into the high-order bits of an address.

This approach is good, but it requires an additional shift command. Furthermore, normally one more arithmetical or logical operation is required to combine the shift result with the original address value.

Several processors have instructions to work with high-order bits of registers, but if the processor lacks such instructions, if they are ineffective, or if additional information is combined with the value of a logical address in a non-trivial manner, then the additional executable operation described in this section will be useful.

In particular, it is possible to avoid loading the constant, shift operation, and subsequent arithmetical or logical operation, if an elementary executable operation that replaces the address's high-order bits with a new value will be added to the command system.

This operation may have two input operands—the first operand is the additional information value (constant immediate value, register (for register processors), or top of the stack (for stack processors)), and the second operand is the value of the address to which it is necessary to add this additional information (a register or other construct that corresponds to the addressing modes that this computer device supports, or that precedes the top cell of the stack for stack processors).

The result of this operation may be returned in a separate register, on the top of the stack, or it may be written into one of the output registers—as decided by the person skilled in the art who implements this invention on her device.

The result of executing this operation is an address that carries additional information. If the additional information is placed in logical addresses that begin with bit number “n” (assume numeration beginning at zero), and if the original address value is labeled “x”, the new additional information “y”, and the resulting value of the address as “x_{marked}”, then this operation may be implemented in the following manner:

x_{marked}=(x∧((1<<n)−1))∨(y<<n)

where the operator “<<” signifies a logical left shift, “∧” is the logical “and” operation, and “∨” is the logical “or” operation.

Another executable operation may be implemented that does not erase the old value of additional information, but combines the possessed additional information with the new information using the “XOR” operation, designated by the symbol “⊕”:

x_{marked}=x⊕(y<<n)

Alternatively, a universal operation may be implemented that can clear, set, and invert any bits of additional information specified by two short masks “y” and “z”, for example, in the following form:

x_{marked}=(x⊕((z<<n)∨((1<<n)−1))⊕(y<<n)

In this case, if the corresponding bit of mask “z” is equal to zero, then a one in mask “y” in this place ensures the bit will be set, and a zero in mask “y” ensures it will be cleared. If the corresponding bit of mask “z” is equal to one, then a one in mask “y” in this place ensures an inversion, and a zero ensures the old value of the bit of additional information will be saved.

If the logical address has a complex structure, or if the additional information is incorporated into the value of the logical address using a complex transformation, then the person skilled in the art may implement the discussed operation using an arbitrary function that returns a new address value that includes additional information.

One of the operands of this function will be a logical address, and the other will be additional information. Exactly which operands this function will have (or need), and how the function itself is implemented, are determined by the person skilled in the art who implements this invention on her device.

The reverse executable operation may also be implemented, which extracts additional information “y” from logical address “x”. If the additional information is saved in high-order bits of an address that starts at bit number “n”, then the implementation of this operation is trivial:

y=x>>n

where the operator “>>” signifies a logical right shift.

Prefix or Suffix for Modifying Additional Information

In the previous section, an executable operation is described that serves to add useful information to a logical address.

However, a person skilled in the art who implements this invention on her device may implement in it a prefix or suffix with a similar purpose, designed to be used jointly with other executable operations.

Distinct from a separate operation that would change the address transmitted to it as an operand, the prefix or suffix will act only on the effective address of the base operation to which it relates.

In this regard, at a low level such a prefix or suffix may be implemented using a separate micro-operation that modifies the effective address that is calculated for the base operation. In this case, the base operation instead of the original value of the effective address receives a modified value, calculated by such micro-operation (in this case, it is not necessary to write this intermediate result in registers visible to the user). Or, conversely, this micro-operation may collect the intermediate result of the basic operation for additional processing, or to complete something begun by the basic operation.

If the base operation has several operands that address memory, then its prefix or suffix may act only on one operand (explicitly assigned or determined by the position of this prefix or suffix), or for such cases there may be provided a special prefix or suffix with several parameters (that contain additional information).

A person skilled in the art may make the prefixes or suffixes described in this section universal, so that they act on arbitrary operands of executable operation (and not only on addresses)—for example, to make changes to high-order bits of any values, including before using them in arithmetical and logical operations.

Rapid Implementation of this Invention for Memory Addressing Using Physical Addresses

This section discusses solutions that allow the rapid implementation of this invention in existing systems in order to achieve performance advantages and reduce energy consumption due to accessing memory using physical addresses.

Addressing Operating System Code

The kernel code of widely used operating systems such as Microsoft Windows or Linux is completely or almost completely located in resident memory.

As a rule, system software (operating system and other programs that operate on kernel privileges of the operating system or are closely integrated with it, for example, a network stack, in particular a TCP/IP stack, firewall software, device drivers, RAID software, cloud storage system components, parts of a multimedia stack) is completely located in resident memory.

Therefore, physical memory addresses may be used to address them.

Addressing the code using physical addresses immediately avoids competition for the TLB and eliminates all page table accesses, including writing useless access and modification flags back to page tables (these flags are useless for resident memory).

For example, if this invention is implemented by selecting physical memory addressing through setting the highest order bit in a logical address, then for some systems, it will be sufficient to recompile components of system software with the set high-order bit in the base address.

In other cases, minimal changes to the loader code are necessary, so that after loading the new module it itself uses the address of loaded code with the set high-order bit and returns that to other programs.

For example, if system software is loaded dynamically and uses position independent code, then after loading the next module into memory, it is sufficient to save its base address with the set high-order bit in all variables and data structures through which this loaded code is accessed.

In this regard, the execution of resident code (after transferring control to the address with the set high-order bit) will take place after accessing the TLB and page tables.

Thus, in order to obtain all the advantages, it is not necessary to implement changes in the remaining code of system software (except the loader's code and/or the code of some memory control procedures).

Addressing System Data Structures and Variables in Resident Memory

Many system data structures are also stored in resident memory. Input/output device buffers, network protocol stack buffers (for example, TCP/IP stack), software RAID buffers, and many other data system structures are also frequently located in resident memory.

Using this invention to address all data structures and variables located in resident memory immediately avoids competition for the TLB and eliminates all page table accesses, including writing useless access and modification flags back to page tables (these flags are useless for resident memory).

For example, if this invention is implemented by selecting physical memory addressing through setting the highest order bit in a logical address, then it is sufficient to set this bit in all work pointers by which system software addresses its variables and data structures.

If the functions that distribute memory for the operating system will immediately return corresponding addresses with the set high-order bit, then practically no remaining code will require any changes, but practically all the advantages of using this invention will have been achieved.

Minimal changes are necessary only in memory allocation functions.

In this regard, in order to simplify the operating system, all code used to generate dummy page tables may be removed from it.

Addressing the Operating System Stack

The stack that the operating system core uses absolutely must be available when handling input/output interrupts, etc. Therefore, it is located in resident memory.

Therefore, using this invention can avoid competition for the TLB and avoid all page table accesses when working with the operating system stack. To this end, a solution designed for addressing other resident data may be used.

Addressing Input/Output Buffers

System input/output buffers, for example, used by device drivers and for internal network stack needs, are typically located in resident memory. Accordingly, a solution designed for addressing other resident data may be used for them.

Addressing Page Tables

If the computer device does not support the direct use of physical addresses, then the operating system must insert dummy elements into page tables, which thereby ensures the mapping of page tables itself into the logical address space.

However, such elements compete with user elements for the TLB cache (or other similar caches), which is limited in size, and need to be read from memory themselves (which is a slow operation), generating them takes time and complicates the development of operating systems.

This invention makes this obsolete technology, which creates substantial overhead, unnecessary.

This not only increases speed, but also simplifies the relevant subsystems in the operating system core (for example, it simplifies the virtual memory manager).

To this end, a solution designed for addressing other resident data may be used.

Addressing User Data during the Operation of System Software

Very often, when working with user data such as buffers that are passed to input/output functions, the operating system and system software switch from page-based virtual memory addressing to physical addressing, since it is necessary to pass the addresses of such buffers to external devices and to controllers that directly access memory (using DMA and other similar technologies).

In this case, the operating system must translate user logical addresses (virtual memory addresses) into physical addresses and fix the relevant pages in physical memory (to keep them from the displacement, if the system uses virtual memory paging). Then the operating system creates scatter-gather lists to address the obtained list of memory fragments.

This patent application has described a new executable operation (machine command) that dramatically speeds up the procedure to translate a high-level logical address into a physical address.

Thus, the creation of scatter-gather lists and interaction with external devices that directly access memory are made more effective.

1. A device, able to execute operations and/or process data (in particular a real, virtual, emulated, or modeled processor (Central Processing Unit, Graphics Processing Unit, Floating Point Processing Unit, Digital Signal Processor, special processor or coprocessor, logically separated part of a more complex processor, such as a processor core), controller or microcontroller, computer, on which there operates a virtual or abstract machine program, a real, virtual, emulated, or modeled specialized ASIC microcircuit or programmable logical array (FPGA)), that is characterized by the fact that it can:
(a) use the value of a specific bit or bits of a high level address or its component(s) (in particular a logical, linear, virtual, or other address at which an executable operation (in particular command, instruction, order, operator, or function, both imperative ones, and ones that control data processing) or data processing operation operates, the component(s) of such address, or offset relative to some base address (including relative to an Instruction Pointer), regardless of whether such an address, or an address component or offset, is used directly, or as part of information to calculate another (effective) logical address, or they themselves constitute an effective address or were extracted from a calculated effective address) as additional information;
(b) and/or extract additional information from the value of a high level address (logical address) or from its component(s) (as defined in the previous clause “a”) using some function (function, scheme, circuit, or algorithm, including those implemented in microcode, in hardware, and/or in software, including using additional information and/or data structures);
(c) and/or obtain additional information from an external source (in particular from another device) as part of or in the composition of address information;
(d) and/or use a prefix or suffix preceding or following an executable operation (in particular command, instruction, order, operator, or function, both imperative ones, and ones that control data processing) (or its code) to obtain such additional information that during the executable operation replaces, supplements, or modifies the information that otherwise (without such prefix or suffix) would have been read from control registers, descriptors, segments, page tables, or other control data structures;
(e) and/or use a prefix or suffix preceding or following an executable operation (or its code) to obtain such additional information that affects address translation (in particular affects translating high level addresses into lower level addresses, including into physical memory addresses), that identifies the address space, context, virtual machine, or another object, that controls data caching during the execution of the current operation, that represents memory protection keys, that instructs this device to read or write other additional information and/or that will be included in a transaction with another device as additional data;
(f) and/or use a prefix or suffix preceding or following an executable operation (or its code) in order to supplement or modify the information obtained in such a way as described in clauses (a . . . e) above;
(g) and/or to supplement or modify the information obtained in such a way as described in clauses (a . . . e) above using additional information extracted from the context in which the executable operation is encountered, or from the context that led to its execution or analysis;
and then uses this additional information unchanged or transformed in an arbitrary manner (including by combining it with other information) for any purposes or in any capacity, in particular:
(a) in order to control caching (in particular to prohibit caching or delayed writing, or as other information that controls caching);
(b) and/or as information about the access pattern for memory that is intended to improve caching or prefetching, in particular as information about the advisability of reading the next cache line (to organize prefetching) or about the necessity of clearing the tail of a cache memory line after writing in that line (in order to avoid reading from memory a line whose content will be replaced with new data);
(c) and/or as additional data that helps reduce the probability of collisions when working with associative cache memory (in particular due to this data's effect on the circuit or algorithm to select the data set that will be used to search or save information in an n-way associative cache);
(d) and/or to control speculative execution and command prefetching, in particular, information on the probability of triggering a conditional jump in the branch or cycle commands);
(e) and/or to instruct this device to use specific rules for translating high level addresses (logical addresses) into lower level addresses (for example, into physical addresses of memory cells), and/or to use specific address transformation, and/or to instruct this device to use specific parameters of such address translation or transformation (for example, those specifying the size of the page, quantity of levels in page tables, or the type of page tables used, but not only those);
(f) and/or for synchronization in a multi-processor or multi-core system;
(g) and/or to replace, supplement, and/or modify such information, which otherwise would have been read from control registers, descriptors, segments, page tables, or other control data structures;
(h) and/or as an identifier of an address space, context, virtual machine, or other object (in particular to access other address spaces or memory of other virtual machines without switching context), in which regard such identifier may be encoded using variable-length codes or (an)other method(s);
(i) and/or as memory protection keys;
(j) and/or to transmit this information to another device for any purpose (in particular, to transmit it to an external memory controller, a direct memory access controller, or another device, either within the address information, or by other means);
(k) and/or to transmit this information to a program or to a data transformation process (in particular to transmit to a program data that will subsequently help improve its performance);
(I) and/or to read or write other additional information (including using the address that the current executable operation accesses);
if such use of additional information does not contradict its purpose, explicitly indicated in the description of the method to obtain it.

2. A device that is the implementation of the device described in claim 1, that is characterized by the fact that a specific result of:
(a) analysis of a logical address that an executable operation received as an operand or effective logical address that was calculated during its execution or preliminary analysis;
(b) and/or analysis of the constituent components of such logical address, in particular analysis of the additional offset relative to the base address, which is specified in an executable or analyzable operation;
(c) and/or analysis of information (in particular specific bits, flags, options, fields, or additional operands) contained in the description or in the machine representation of an executable operation;
(d) and/or analysis of the code of an executable operation, prefix, or suffix that precedes or follows it (the operation itself or the operation's code);
(e) and/or analysis of information obtained from the context in which the executable operation is encountered, or from the context that lead to its execution or analysis;
(f) and/or analysis of the field(s) or flag(s) of the control structures of this device, or the field(s) or flag(s) reflecting its state (if applied to address translation, such state of a flag(s) or fields(s) of a given device must occurs only in a specific context that can be established and closed using specific executable operation(s) that create or close such a local context, and that do not lead to switching the device's mode of operation);
(g) and/or analysis of a specific field or fields in the page table (or directory) element on such a level in the page table hierarchy that the size of the region corresponding to it in the logical address (high level address) space is greater than or equal to the size of the lower level address space (in particular physical addresses space) that are supported by this computer device in its current mode of operation;
(h) and/or analysis of a specific field or fields in the segment descriptor, if this computer device supports the segment addressing model;
(i) and/or analysis of a specific field or fields in the descriptor of the address space, context, virtual machine, or in the descriptor of another object supported by this device;
instructs this device to act in accordance with claim 1.

3. A device, able to execute operations and/or process data (in particular a real, virtual, emulated, or modeled processor (Central Processing Unit, Graphics Processing Unit, Floating Point Processing Unit, Digital Signal Processor, special processor or coprocessor, logically separated part of a more complex processor, such as a processor core), controller or microcontroller, computer, on which there operates a virtual or abstract machine program, a real, virtual, emulated, or modeled specialized ASIC microcircuit or programmable logical array (FPGA)), that is characterized by the fact that during preliminary analysis of the executable operation (in particular command, instruction, order, operator, or function, both imperative ones, and ones that control data processing), during or after its execution, it may independently (acting according to its algorithm, rules, and/or internal program) change the memory space that contains the machine representation of this operation (in particular, change its prefix, operation code, suffix, operands, including immediate values, address, or offsets, register numbers, or any other parts of the operation's machine representation), in order to improve the program or data processing (in particular to improve the repeat execution of this fragment of the program in the future).

4. A device that is the implementation of the device described in claim 1, that is characterized by the fact that it uses logical addresses that contain address space (or context) identifiers, and therefore point not only to specific memory cells located within some address space (supported by this device in its current mode of operation), but also to these spaces themselves, where the bit length of these logical addresses is not greater than the bit length of a general purpose register on this device (or the nominal bit length of the device itself, if it does not use the register metaphor or an analog thereof); in this regard this computer device may:
(a) automatically extract an address space (or context) identifier from such logical address;
(b) and/or use such logical address in order to access data located at another address space (distinct from the current address space) or transfer control to a program code located in another address space, while not permitting, in this regard, unauthorized access to the data or code located in other address spaces by application programs.

5. A device that is the implementation of the device described in claim 1, that is characterized by the fact that it uses logical addresses, the composition of which includes address space (or context) identifiers in such a way that these identifiers are encoded using any variable-length codes that have been approved by the developers of this device, which allows the use of different bit lengths for different address space identifiers in the current mode of operation of such device (without regularly switching modes of operation or reprogramming control registers to use different length identifiers).

6. A device, able to execute operations and/or process data (in particular a real, virtual, emulated, or modeled processor (Central Processing Unit, Graphics Processing Unit, Floating Point Processing Unit, Digital Signal Processor, special processor or coprocessor, logically separated part of a more complex processor, such as a processor core), controller or microcontroller, computer, on which there operates a virtual or abstract machine program, a real, virtual, emulated, or modeled specialized ASIC microcircuit or programmable logical array (FPGA)), that is characterized by the fact that it can simultaneously use different algorithms and parameters to translate addresses (in particular, a different length of the basic address information, for example, of a linear address, or a different maximum number of levels in the hierarchy of page tables and/or different methods for organizing page tables or similar data structures) for different address spaces in the current mode of operation of a given device (without regularly switching modes of operation or reprogramming control registers by using different algorithms or parameters to translate addresses for different spaces).

7. A device that is the implementation of the device described in claim 1, that is characterized by the fact that it implements the transfer of control to code located in another address space using a logical address, the bit length of which is not greater than the bit length of a general purpose register on this device (or the nominal bit length of the device itself, if it does not use the register metaphor or an analog thereof); this includes the possibility of returning back, implemented due to the presence of the caller's address space (or context) identifier in the logical address of a return point.

8. A device that is the implementation of the device described in claim 1, that is characterized by the fact that:
(a) specific values of some bit(s) in a high level address (in particular in a logical, linear, virtual, or other address at which an executable operation (in particular command, instruction, order, operator, or function, both imperative ones, and ones that control data processing) or data processing operation operates, the component(s) of such address, or offset relative to some base address (including relative to an Instruction Pointer), regardless of whether such an address, or an address component or offset, is used directly, or as part of information to calculate another (effective) logical address, or they themselves constitute an effective address or were extracted from a calculated effective address), or the result of checking whether a high level address (logical address) belongs to one of the address (or offset) classes for which there is some function (function, scheme, circuit, or algorithm, including those implemented in microcode, in hardware, and/or in software, including using additional information and/or data structures) capable of determining whether a checked valued belongs to that class;
(b) and/or such analysis (as defined in the previous clause “a”) of the constituent components of such logical address, in particular analysis of the additional offset relative to the base address, which is specified in an executable or analyzable operation;
(c) and/or specific values of bits, flags, options, fields, or additional operands in the description of an executable operation or in its machine representation;
(d) and/or usage of special code of an executable operation, presence of specific prefixes or suffixes that precede or follow it (the operation itself or the operation's code), or specific values of the parameters (including operands, fields) of a prefix or suffix;
(e) and/or the presence of a specific static context (in particular a specific nesting of operations within one another) or a dynamic context (in particular a specific prehistory of executing operations or transferring control between them), or specific values of parameters (or state) of such a context;
(f) and/or specific value(s) of the field(s) or flag(s) of the control structures of this device, or specific values of the field(s) or flag(s) reflecting its state (if applied to address translation, such state of a flag(s) or fields(s) of a given device must occurs only in a specific context that can be established and closed using specific executable operation(s) that create or close such a local context, and that do not lead to switching the device's mode of operation);
(g) and/or specific values of the field or fields in the page table (or directory) element on such a level in the page table hierarchy that the size of the region corresponding to it in the logical address (high level address) space is greater than or equal to the size of the lower level address space (in particular physical addresses space) that are supported by this computer device in its current mode of operation;
(h) and/or specific values of the field or fields in the segment descriptor, if this computer device supports the segment addressing model;
(i) and/or specific values of the field or fields in the descriptor of the address space, context, virtual machine, or in the descriptor of another object supported by this device;
instruct this device to treat:
(a) the source or resultant (effective) address of a high level (logical) address or its component(s), including the offset(s), or part of the bits in such address, component, or offset;
(b) and/or the distance between such an address or its component (offset) and some base address;
(c) and/or the result of some transformation or some function (possibly using additional information and/or data structures) applied to the value of the source or resultant (effective) address, to its component(s), or offset(s), to certain bits of these values, or to the distance between such value and some base value;
as:
(a) the address or component of a lower-level address (in particular, as a physical address);
(b) or as an offset relative to some lower-level base address (in particular, as an offset relative to some physical address);
(c) either as an address, a component of an address, or a lower level offset, which requires additional transformation using a certain function;
(d) or as a new address, address component, or offset belonging to a certain class of high-level addresses (to be further converted to lower-level addresses using a certain function, if necessary).

9. A device that is the implementation of the device described in claim 1, that analyzes additional useful information it has extracted using one of the methods described in claim 1 in order to change this device's interpretation of a logical address (or the basic address information that remains after extracting additional useful information from the logical address), and/or uses this additional useful information during the translation or transformation of such logical address (or basic address information), in particular to determine the type of such address (in particular, but not only, in order to choose another method to translate the logical address or basic address information into a lower level address, including, but not limited to, into a physical address).

10. A device, able to execute operations and/or process data (in particular a real, virtual, emulated, or modeled processor (Central Processing Unit, Graphics Processing Unit, Floating Point Processing Unit, Digital Signal Processor, special processor or coprocessor, logically separated part of a more complex processor, such as a processor core), controller or microcontroller, computer, on which there operates a virtual or abstract machine program, a real, virtual, emulated, or modeled specialized ASIC microcircuit or programmable logical array (FPGA)), in which an executable operation (in particular command, instruction, order, operator, or function, both imperative ones, and ones that control data processing) is provided that for an assigned high level address or its component(s) (in particular for a logical, linear, virtual, or other address at which an executable operation or data processing operation operates, the component(s) of such address, or offset relative to some base address (including relative to an Instruction Pointer), regardless of whether such an address, or an address component or offset, is used directly, or as part of information to calculate another (effective) logical address, or they themselves constitute an effective address or were extracted from a calculated effective address) or for an assigned range of such addresses returns either a lower level address (in particular a physical address of a memory cell), or its component(s), that directly matches the this high level address, or returns the low level address of some memory space that contains the cell addressed by the this high level address (in particular the physical address of a memory page that contains the cell addressed by this high level address), or returns a set of lower level addresses that correspond to the assigned range of high level addresses.

11. A device that is the implementation of the device described in claim 1, that is characterized by the fact that, using a prefix or suffix that precedes an executable operation (in particular command, instruction, order, operator, or function, both imperative ones, and ones that control data processing) or follows it (or its code), or using a similar special operation, it can return the results of intermediate calculations (including the value of an effective address) to the program; or can return to the program values read from control or internal registers and data structures; or can return to the program (or to the data processing process) any other intermediate and/or auxiliary results of executing operations or results of the address translation process (including the physical address of a memory cell)—if returning these values to the program is not provided in the command system of such device for such executable operation; in this regard such return values may be combined with any other information and/or transformed using some function before they are returned to the program.

12. A device that is the implementation of the device described in claim 1, that reserves part of the possible values of an offset field or part of the possible values of an operand (including, but not limited to, part of the possible value of an immediate operand) of the executable operation (in particular command, instruction, order, operator, or function, both imperative ones, and ones that control data processing) in order to transmit additional useful information to such computer device using these reserved values.

13. A device, able to execute operations and/or process data (in particular a real, virtual, emulated, or modeled processor (Central Processing Unit, Graphics Processing Unit, Floating Point Processing Unit, Digital Signal Processor, special processor or coprocessor, logically separated part of a more complex processor, such as a processor core), controller or microcontroller, computer, on which there operates a virtual or abstract machine program, a real, virtual, emulated, or modeled specialized ASIC microcircuit or programmable logical array (FPGA)), that a uses a specific field(s) in the page table (directory) element (in the page descriptor or other similar structure) to store information in it that helps this device reduce the likelihood of collisions when working with associative memory (such as cache memory).

14. A device that is the implementation of the device described in claim 1, that a uses parameterized prefixes or suffixes, or special executable operations replacing them, to transfer additional useful information to the later stages of execution or analysis of executable operations (in particular command, instruction, order, operator, or function, both imperative ones, and ones that control data processing), that is, to the stage following the calculation of the effective address.

15. A device that is the implementation of the device described in claim 1, that uses some executable operations (in particular command, instruction, order, operator, or function, both imperative ones, and ones that control data processing) as prefixes or suffixes for other executable operations, linking them using automatic register allocation (or automatic allocation of other temporary variables) for intermediate results, in order to eliminate the need for the user to explicitly specify registers (or some other variables) that store intermediate results of calculations.
